(19) United States
(12) Patent Application Publication
(10) Pub. No.: US 2015/0118959 A1
(43) Pub. Date: Apr. 30, 2015

(54) PLATFORM FRAMEWORK FOR WIRELESS MEDIA DEVICE SIMULATION AND DESIGN

(71) Applicants: Nicolas Jean Petit, Mountain View, CA (US); Narsimham Venkat Gangishetti, San Francisco, CA (US)

(72) Inventors: Nicolas Jean Petit, Mountain View, CA (US); Narsimham Venkat Gangishetti, San Francisco, CA (US)

(21) Appl. No.: 14/065,393

(22) Filed: Oct. 28, 2013

(51) Int. Cl. H04W 24/06; H04W 4/00

(52) U.S. Cl. CPC H04W 24/06; H04W 4/008
USPC 455/41.1

(57) ABSTRACT

Embodiments of the invention relate generally to electrical and electronic hardware, computer aided simulation and design, high-level language numerical computation, analysis, programming, and visualization of designs, target hardware compilers, assembly code, computer software, wired and wireless network communications, wearable, hand held, and portable computing devices for facilitating communication of information. More specifically, disclosed is a framework for computer aided simulation and design of wireless media devices for one or more target hardware platforms.

### FIELD

Embodiments of the invention relate generally to electrical and electronic hardware, computer aided simulation and design, high-level language numerical computation, analysis, programming, and visualization of designs, target hardware compilers, assembly code, computer software, wired and wireless network communications, wearable, hand held, and portable computing devices for facilitating communication of information. More specifically, disclosed is a framework for computer aided simulation and design of wireless media devices for one or more target hardware platforms.

### BACKGROUND

Conventional paradigms for creating a new design to be executed on a target hardware platform typically involve tweaking and re-tweaking assembly code and then re-compiling the code until after several iterations (e.g., over several months) the compiled code runs on the target hardware platform with results that successfully realize the design goals. An example of a target hardware platform is a digital signal processer (DSP) and/or a highly integrated system on chip (SoC) processor that may include DSP as well as other hardware blocks (e.g., one or more radios, such as Bluetooth and WiFi) for implementing a single chip solution for a wireless media device, such as a wireless headset (e.g., Bluetooth headset), a wireless speaker, or the like. In that many of the functions of the wireless media device will be implemented by executable code fixed in a non-transitory computer readable medium that is accessed by the target hardware (e.g., from Flash memory), the simulation of the desired functionality of wireless media device must be verified by writing code, compiling the code, and running an executable version of the compiled code on the target hardware. The various blocks in a DSP or highly integrated SoC may not be externally accessed for probing or other means for examining signals as they are processed by the target hardware while running the compiled code. For example, the only electrical access to the DSP or SoC may be through its pins. Therefore, the effects of input signals applied to input pins of the target hardware may only be analyzed by examining signals that are outputted on its respective output pins. A more granular examination of input and output is not possible. Essentially, there are aspects of how the code executes on the target hardware that are not easily observable and there may be a loose coupling between a simulation model of the target hardware (e.g., what the math is doing) and the actual compiled code running on the target hardware.

If the simulation and target hardware verification do not match (e.g., actual performance doesn't match simulated performance), then the software models for the simulation and/or assembly language code for the target hardware platform must be edited and the process repeated until the hardware design meets design goals. However, the re-writing and re-compiling the assembly code (e.g., hand coding assembly language at the machine level) for the target hardware platform (e.g., a specific DSP or SoC chip from a specific manufacturer) may be time consuming and prone to error. Moreover, from a block diagram perspective of the wireless media device, less than all of the blocks may need tweaking, revisions, etc., while other blocks may be performing as required. Nevertheless, the entire body of assembly language code may be impacted by the editing and re-compiling process, even though a small portion of the code is actually in need of tweaking. Additionally, the ability to reuse the assembly code from one target hardware platform to another target hardware platform is extremely difficult if not impossible because each hardware platform typically has no its own unique code that is not compatible with and is not portable to other hardware platforms.

Thus, what is needed are methodologies, software, tools and systems that allow for a more granular approach to simulation and verification of designs for wireless media devices.

### BRIEF DESCRIPTION OF THE DRAWINGS

Various embodiments or examples (“examples”) of the invention are disclosed in the following detailed description and the accompanying drawings. The drawings are not necessarily to scale:

FIG. 1 illustrates an example of a wearable communication device, according to some embodiments;

FIG. 2 depicts an example of an audio processor, according to some examples;

FIG. 3 is a diagram illustrating an example of a vibration detector in accordance with some examples;

FIGS. 4A and 4B depict different views of an earbud having a wearable device engagement member, according to some embodiments;

FIG. 5A depicts a system of earbuds according to some embodiments;

FIG. 5B depicts an earbud engaged with a wearable communication device, according to some embodiments;

FIG. 6 depicts in orientation of a wearable communication device, according to some examples;

FIG. 7 illustrates an exemplary computing platform disposed in a wearable communication device, media device, mobile device, or any computing device, according to various embodiments;

FIGS. 8A to 8H depict examples of a wearable communication device in a rear view, a left view, a right view, a front view, a top view, a bottom view, a first perspective view, and a second perspective view, respectively;

FIGS. 9A to 9H depict examples of an earbud in a front view, a rear view, a top view, a bottom view, a right view, a left view, the first perspective view, and a second perspective view, respectively;

FIGS. 10A to 10E depict examples of an earbud in a front view, a rear view, a top view, a left view, and a right view, respectively;

FIGS. 11A to 11I depict examples of a wearable communication device coupled to an earbud in a front view, a rear view, a left view, a right view, a bottom view, a top view, a first perspective view, a second perspective view, and a third perspective view, respectively;

FIGS. 12A to 12G depict examples of a wearable communication device coupled to an earbud in a front view, a rear view, a side view, a bottom view, a top view, a first perspective view, and a second perspective view, respectively;

FIGS. 13A to 13G depict examples of a wearable communication device coupled to an earbud in a front view, a rear view, a side view, a bottom view, a top view, a first perspective view, and a second perspective view, respectively;

FIGS. 14A to 14G depict examples of a wearable communication device coupled to an earbud in a front view, a rear view, a side view, a bottom view, a top view, a first perspective view, and a second perspective view, respectively;

FIG. 15 depicts an example of a wearable charger, according to some embodiments;

FIGS. 16A and 16B depict a wearable charger in different states, according to some embodiments;

FIG. 16C is a top view depicting a wearable charger in an open state, according to some examples;

FIGS. 17A and 17B depict a wearable charger in different states, according to some embodiments;

FIGS. 18A and 18B depict an example of an application of force to provide access to a wearable communication device from a nesting state, according to some embodiments;

FIG. 19 depicts a wearable charger and examples of its components, according to some embodiments;

FIG. 20 is an example of a flow for a wearable charger, according to some embodiments;

FIGS. 21A to 21H depict examples of a wearable charger in an closed state in a front view, a rear view, a first side view, a second side view, a top view, a bottom view, a first perspective view, and a second perspective view, respectively;

FIGS. 22A to 22G depict examples of a wearable charger in an open state in a rear view, a first side view, a second side view, a top view, a bottom view, a first perspective view, and a second perspective view, respectively;

FIGS. 23A to 23G depict examples of a wearable charger in a nested state in a rear view, a first side view, a second side view, a top view, a bottom view, a first perspective view, and a second perspective view, respectively;

FIGS. 24A to 24G depict examples of a wearable charger in an extended state in a rear view, a first side view, a second side view, a top view, a bottom view, a first perspective view, and a second perspective view, respectively;

FIGS. 25A to 25G depict examples of a wearable charger in a nested state with an earbud in a rear view, a first side view, a second side view, a top view, a bottom view, a first perspective view, and a second perspective view, respectively;

FIGS. 26A to 26G depict examples of a wearable charger in an extended state with an earbud in a front view, a rear view, a first side view, a second side view, a bottom view, a first perspective view, and a second perspective view, respectively;

FIGS. 27A to 27G depict examples of a wearable charger in a closed state in a front view, a rear view, a side view, a bottom view, a top view, a first perspective view, and a second perspective view, respectively;

FIG. 28 depicts an example of an attachment member configured to attach a wearable charger to a user, according to some examples;

FIG. 29 depicts one example of a wireless media device having inputs and outputs according to an embodiment of the present application;

FIG. 30 depicts an exemplary computer system according to an embodiment of the present application;

FIG. 31 depicts one example of a block diagram for capturing signals from a plurality of wireless devices into a data collection system for high level language modeling and simulation in a platform framework according to an embodiment of the present application;

FIG. 32 depicts one example of a more detailed block diagram for capturing signals from a wireless device into a data collection system for high level language modeling and simulation in a platform framework according to an embodiment of the present application;

FIG. 33 depicts one example of a flow diagram for a platform framework according to an embodiment of the present application;

FIG. 34 depicts one example of different levels of design abstraction that may be used as basis for high level language modeling and simulation in a platform framework according to an embodiment of the present application; and

FIG. 35 depicts another example of an audio processor framework according to an embodiment of the present application.

### DETAILED DESCRIPTION

Various embodiments or examples may be implemented in numerous ways, including as a system, a process, an apparatus, a user interface, or a series of program instructions on a non-transitory computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

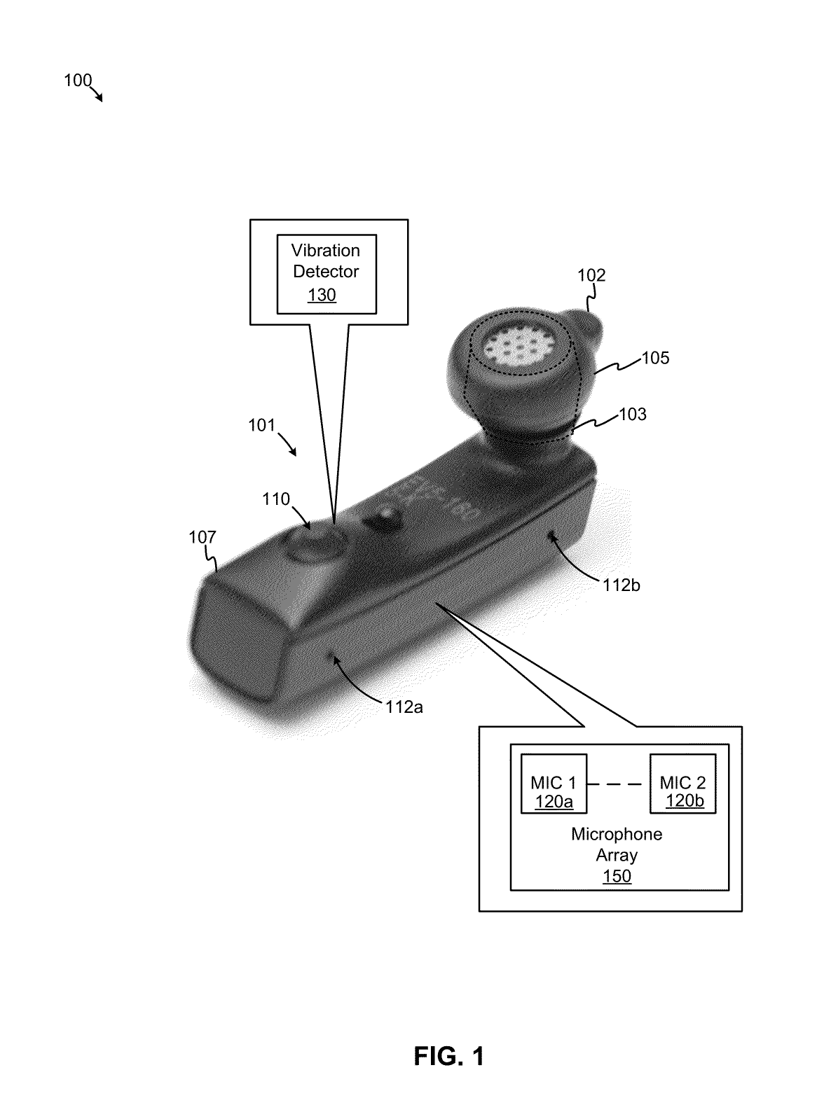

FIG. 1 illustrates an example of a wearable communication device, according to some embodiments. Diagram 100 depicts a wearable communication device 101 that includes a vibration detector 130 and a microphone array 150, which includes at least two microphones. As shown, microphone array 150 includes at least a first microphone (“MIC 1”) 120a and a second microphone (“MIC 2”) 120b, and in some implementations, microphone array 150 can include more or fewer microphones. Ports 112a and 112b acoustic ports for facilitating reception of speech and noise audio by microphone array 150. In some embodiments, microphone array 150 includes a dual omnidirectional microphones array (“DOMA”). That is, microphone array 150 can include two omnidirectional microphones, according to some examples. A housing 107 is configured to encapsulate and enclose the components disposed in the interior of wearable communication device 101.

Diagram 100 also shows a speaker channel housing 103 configured to channel, guide, convey, or otherwise direct audio from wearable communication device 101 to a receiving point, such as an ear canal. Speaker channel housing 103 includes an optional acoustic cowling 105 on which an ear engagement member 102 may be formed. Ear engagement number 102, or equivalent, is a structure configured to lock or otherwise maintain an orientation relative to an earbud, which, in turn, is coupled, substantially firmly/rigidly, to an ear of a user. In some examples, earbud engagement member 102 including one or more members configured to engage an earbud to lock the orientation of the earbud relative to wearable communication device 101. As such, wearable communication device 101 may maintain an orientation relative to an earbud (not shown) that is affixed or substantially affixed to an ear of a user.

Vibration detector 130 includes an interface portion 110 that is configured to contact or otherwise receive acoustic or vibratory energy from a surface, such as tissue or other user-related structures (e.g., like a cheek). Various examples, vibration detector 130 is, or is a constituent of, a voice activity detector (“VAD”), which operates to determine whether a user is speaking relative to ambient noises in the environment, etc. Wearable computing device 101 implements vibration detector 130 to determine, for example, when a speaker is engaged in speech or otherwise is, for example, consuming audio. Note that according to a non-limiting example, wearable communication device 101 can have at dimension at or less than 46.6 mm×13 mm×21.2 mm.

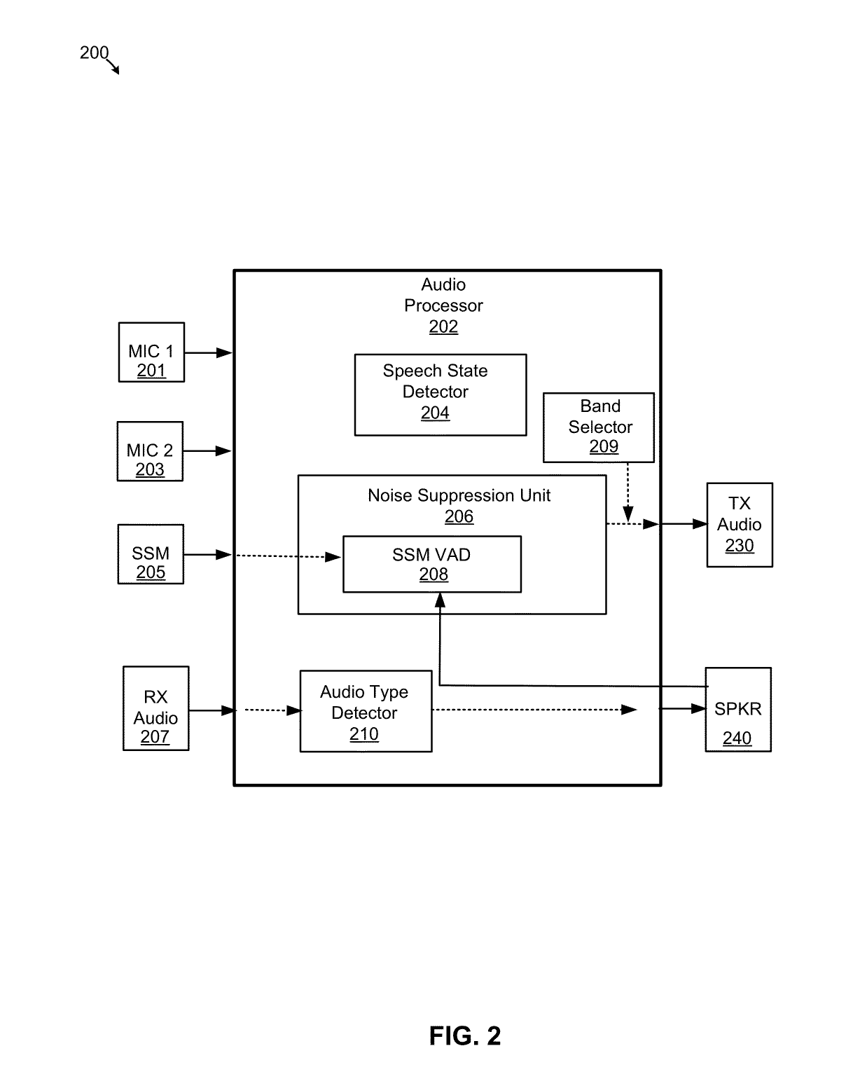

FIG. 2 depicts an example of an audio processor, according to some examples. Diagram 200 depicts an audio processor 202 configured to receive various inputs and to generate various outputs. For example, audio processor 202 is configured to receive audio signals from an array of microphones including microphone (“MIC 1”) 201 and microphone (“MIC 2”) 203, as well as being configured to receive acoustic-related information from a skin surface microphone (“SSM”) 205, which can be implemented to behave as a vibration detector device. Also, audio processor 202 is configured to receivers audio (“RX”) 207, for example, that is received from a remote audio source or user. Audio processor 202 is also configured to drive a speaker 240 and to transmit audio (“TX audio”) 230 using, for example, a radio frequency (“RF”)-based facility. In some examples, speaker 240 can include a driver being configured to improve a low frequency output (e.g., enhancing bass by, for example, at least 6 dB) for a specific size, for example, of a driver of 10 mm×4.5 mm.

According to some examples, microphones 201 and 203 can be implemented using MEMS (“Micro-Electrical-Mechanical System”) microphones that include a semiconductor substrate and a diaphragm coupled to the semiconductor substrate. As such microphones are manufactured in groups (e.g., fabrication lots) having substantially the same process parameters, the frequency responses of the MEMS microphone can be substantially similar (e.g., in the range of 10 Hz to 20,000 Hz the frequency responses can be less than 1.5 dB, such as less than 1.0 dB). Further, as microphones 201 and 203 can be disposed in a dual digital omnidirectional configuration frequency and gain matching can be substantially achieved to effect minimal drift in gain and/or frequency.

Audio processor 202 is configured to provide digital signal processing functionalities and can be implemented in hardware and/or software. Audio processor 202 can also provide communication facilities (not shown) to facilitate Bluetooth® communication, such as set forth in Bluetooth low energy (“BTLE”) protocols etc., as well as Wi-Fi communication protocols, and other wireless communication protocols and/or networks (e.g., cellular networks) and the like.

Diagram 200 depicts audio processor 202 including a speech state detector 204, a band selector 209, a noise suppression unit 206 that includes an SSM voice activity detector (“VAD”) 208, and an audio type detector 210. Noise suppression unit 206 is configured to enhance voice audio and to suppress, reduce, or otherwise reject ambient background noise originating in the environment in which audio processor 202 is disposed. Further, noise suppression unit 206 is shown to include SSM VAD 208, which is coupled to noise suppression unit 206. SSM VAD 208 is configured to detect or otherwise compensate for speaker acoustic energy from speaker 240 or other sources of non-speech-related energy. As such, SSM VAD 208 can operate to filter the speaker acoustic energy from speaker 240 (or from other sources) to reduce or eliminate instances when a non-speech-related vibration might otherwise trigger a false detection of a vibration captured by SSM 205. Non-speech-related vibrations may arise as the size of a wearable computing device is reduced and the internal components are disposed closer to each other. SSM VAD 208, therefore, is configured to compensate for vibratory energy generated by, for example, low frequencies of an improved base response of speaker 240.

Speech state detector 204 is configured to maintain conversational states based on speech. For example speech state detector 204 can be configured to identify a speech state as one of the following exemplary states: a first state in which no speech is detected, a second state in which speech from two or more audio sources are detected, a third state in which speech is originating at the wearable communication device, and a fourth state in which speech originates remotely relative to the wearable communication device. In some examples, speech state detector 204 is configured to receive signals, such as analog and/or digital signals, associated with near and far sources of speech, among other types of signals. Speech state detector 204 then can provide the state of speech or conversation to noise suppression unit 206, which, in turn, is configured to modify parameters and hence the degree of noise suppression to provide a more or enhance natural sounding conversation. As a first example, consider that when no speech is detected from either end, background noises may be less suppressed so as to convey to each user that the line and/or communications path between them is still present (e.g., a cell or mobile phone call has not dropped). As a second example, consider that when speech from both speakers (e.g., at the near-end and far-end) is detected, then that speaker's voice may be attenuated at the speaker's wearable communication device so as to maintain the integrity of the incoming speech audio signal.

Band selector 209 is configured to select one of a number of frequency bands with which to transmit audio. For example, band selector 209 can be configured to transmit audio in multiple modes, such as a narrow-band mode (e.g., frequencies of range of 300 Hz to 3,500 Hz) band a wide-band mode. Transmission of wide-band audio (e.g., frequencies of range of 30 Hz to 8,000 Hz) may be referred to as High Definition voice or HD voice, in some cases. According to some examples, band selector 209 can be configured to switch transmit modes as a function of the type of audio (e.g., music) and amount of audio, among other things, identified for transmission. Noise suppression unit 206 can be configured to operate differently for suppressing noise for wide-band modes and narrow-band modes.

Audio type detector 210 is an optional component is configured to detect a type of audio being received from our RX audio 207. For example, audio type detector 210 can detect music as a type of audio based on an incoming stereo audio stream via Bluetooth A2DP that provides for the protocols that deliver stereo audio via wireless communications. In some examples, audio type detector 210 can detect whether incoming audio is speech or other desired audio, such as music. Therefore, audio type detector 210 can transmit a signal identifying whether incoming audio is speech or music, for example, to noise suppression unit 206. In response, noise suppression unit 206 can modify its operation to adjust for speech and music, which requires additional information and/or bandwidth. Optionally, audio type detector 210 can generate a control signal for controlling (i.e., activating) speaker 242 to provide low-frequency-based signals among other audio signals.

Further, wearable computing device under wearable communication device 101 also can include a digital signal processor (“DSP”) implemented in hardware and/or software to provide for an audio processor configured to suppress noise, among other things. An example of a voice activity detector (“VAD”) or a voice activity detection device, or portions thereof (e.g., including the functionality of the SSM), is described in U.S. Pat. No. 8,340,309, among other such devices developed by the Assignee of said patent. Also, U.S. Pat. No. 8,340,309 and related applications and/or devices manufactured by the Assignee also describe noise suppression techniques that are suitable for use in wearable communication devices 101. In some examples, audio processor 202 can be implemented in hardware or software, or a combination thereof in one example, a suitable digital signal processing (“DSP”) platform is provided by Cambridge Silicon Radio, Ltd. (“CSR”), among other suitable DSP platforms.

In some embodiments, a wearable communication device, such as a headset or equivalent, a mobile device (e.g., a mobile phone) or any networked computing device (not shown) in communication with one or more of the above-mentioned devices, can provide at least some of the structures and/or functions of any of the features described herein. As depicted in FIG. 2 and (or any other figure), the structures and/or functions of any of the above-described features can be implemented in software, hardware, firmware, circuitry, or any combination thereof. Note that the structures and constituent elements above, as well as their functionality, may be aggregated or combined with one or more other structures or elements. Alternatively, the elements and their functionality may be subdivided into constituent sub-elements, if any. As software, at least some of the above-described techniques may be implemented using various types of programming or formatting languages, frameworks, syntax, applications, protocols, objects, or techniques. For example, at least one of the elements depicted in FIG. 2 (or any figure) can represent one or more algorithms. Or, at least one of the elements can represent a portion of logic including a portion of hardware configured to provide constituent structures and/or functionalities.

For example, audio processor 202 and/or any of its one or more components, such as speech state detector 204, band selector 209, noise suppression unit 206, and audio type detector 210 can be implemented in one or more communication devices or devices that can provide communication facilities, such as desktop audio system (e.g., a Jambox® or a variant thereof), a mobile computing device, such as a wearable device or mobile phone (whether worn or carried), that include one or more processors configured to execute one or more algorithms in memory. Thus, at least some of the elements in FIG. 2 (or any other figure) can represent one or more algorithms. These can be varied and are not limited to the examples or descriptions provided.

As hardware and/or firmware, the above-described structures and techniques can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit. For example, audio processor 202 and/or any of its one or more components, such as speech state detector 204, band selector 209, noise suppression unit 206, and audio type detector 210 of FIG. 2 (or other figures) can be implemented in one or more computing devices that include one or more circuits. Thus, at least one of the elements in FIG. 2 (or any other figure) can represent one or more components of hardware. Or, at least one of the elements can represent a portion of logic including a portion of circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

Note that while the various examples provided herein relate to wearable communication devices, such as headsets, the various embodiments are not intended to be limited to headsets. For example, the various implementations can be implemented in any communications device, such as mobile phones and the like.

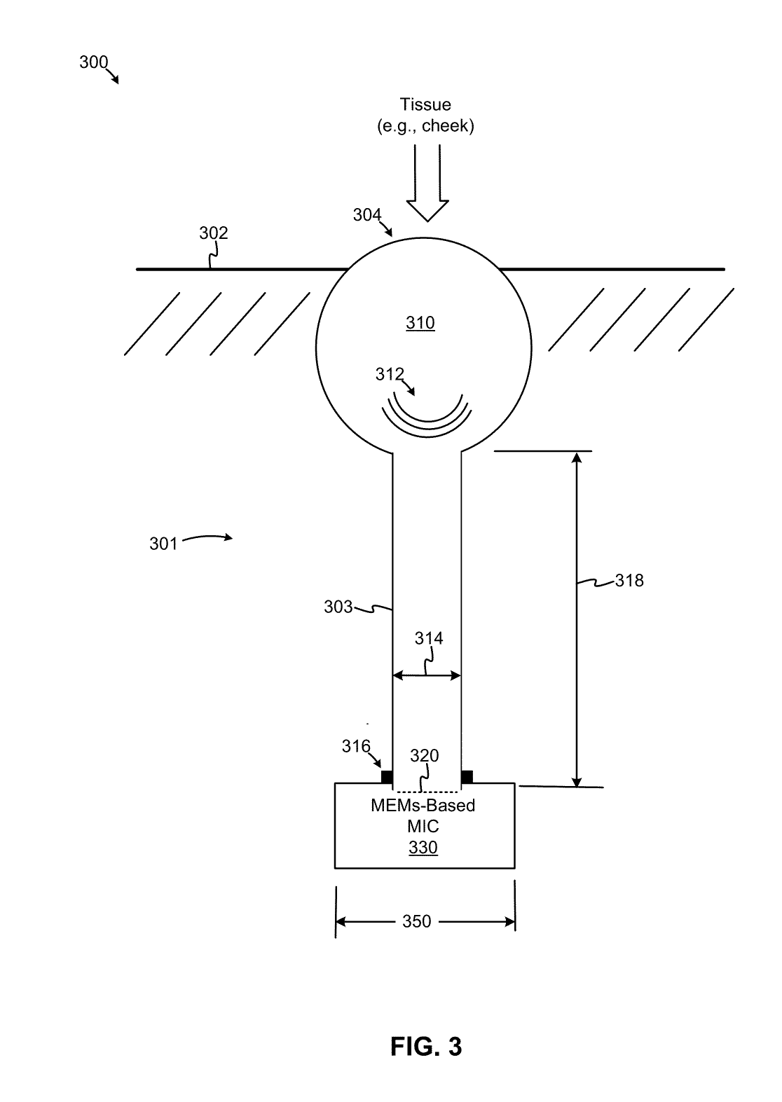

FIG. 3 is a diagram illustrating an example of a vibration detector in accordance with some examples. Diagram 300 depicts a vibration detector 301 having an interface portion 304 extending or protruding from a surface 302 of a wearable communication device (e.g., surface 302 can be positioned adjacent the nearest surface of a user). Interface portion 304 is configured to contact a surface, such as tissue (e.g., a cheek), and the like, that includes vibratory energy associated or originating with the generation of speech. Vibration detector 301 is configured to receive mechanical-based energy, such as vibrations, and convert that energy into acoustic energy. In some embodiments, vibration detector 301 can be referred to as an SSM. In various examples, vibration detector 301 includes a pressure wave converter configured to encode characteristics of the vibratory energy (e.g., frequencies, magnitudes, etc.) into pressure waves. The pressure waves can be transferred via a transfer conduit configured to convey the pressure waves to an acoustic energy receiver. In some cases, an acoustic energy receiver is a microphone.

As shown, vibration detector 301 includes a cavity 310 coupled to a transfer conduit 303, which terminates at a diaphragm 320 (or equivalent) of the acoustic energy receiver. An example shown, acoustic energy receiver is a MEMS-based microphone 330. In some examples, cavity 310 and transfer conduit 303 includes a fluid, such as a gas (e.g., air, nitrogen, etc.) or a liquid, as a medium for transferring pressure waves via transfer conduit 303 to MEMS-based microphone 330. In some examples, transfer conduit 303 is coupled to diaphragm 320 and microphone 330 using a seal 316, which is configured to reduce or eliminate leakage of pressure waves in a gaseous medium (e.g., air) or a liquid medium.

In operation, mechanical energy (e.g., due to vibrations) is imparted unto interface portion 304 typically during speech when a user's jawbone is in motion. Such vibratory energy is received into cavity 310 and converted into pressure waves 312, which traverse through transfer conduit 303 to microphone 330. In some examples, the cross-sectional area 314 and/or length 318 of transfer conduit 303 can be optimized for the particular medium so as to provide a reduction in size of vibration detector 301 with minimal to no degradation in the speech-characteristics embedded in this pressure waves 312. Likewise, a particular medium can be selected based on a given cross-sectional area 314 and length 318. In some examples, MEMS-based microphone 330 can be disposed external to transfer conduit 303, and thus, can have smaller cross-sectional 314 then a cross-section 350 of a surface of MEMS-based microphone 330. Note while transfer conduit 303 is depicted as being linear, implementation of transfer conduit 303 is not so limited. For example, transfer conduit 303 can be curved or have any linear deviation so as to efficiently transfer pressure waves 312 generated in cavity 310 to MEMS-based microphone 330.

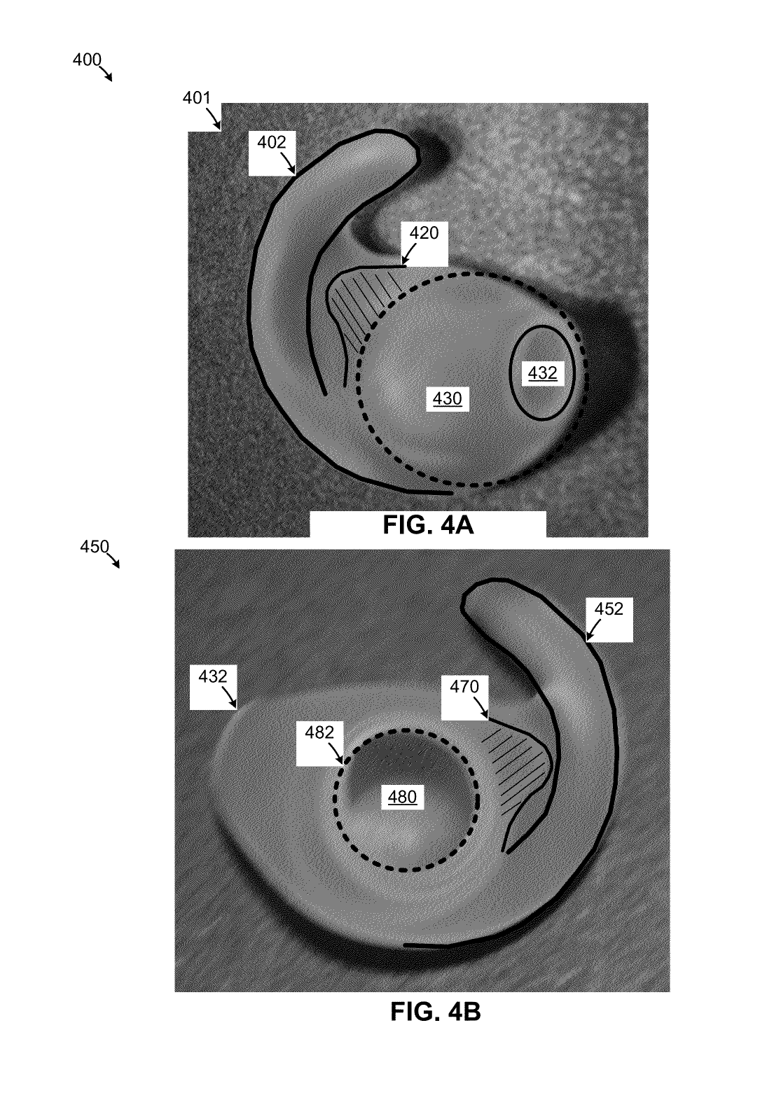

FIGS. 4A and 4B depict different views of an earbud having a wearable device engagement member, according to some embodiments. Diagram 400 depicts an earbud 401 including an ear engagement member 402 configured to couple the wearable communication device to an ear (not shown), a wearable device engagement member 420, and an acoustic chamber 430 having an output port 432. Wearable device engagement member 420 can be configured as a recess into which an earbud engagement member can be disposed to form a substantially rigid coupling between earbud 403 and to wearable communication device. Such a coupling enables wearable communication device to remain in particular orientation relative to the user's ear (e.g., toward a speaker's mouth). Wearable device engagement member 420 can be composed of one or more members arranged in either a concave formation (e.g., one or more walls to form a recess) or a convex formation (not shown) to engage an earbud engagement member disposed in a wearable communication device. Note that while one wearable device engagement and 420 is depicted, other types and quantities are also within the scope of the various examples. In at least one case, output port 432 has a diameter that is sufficiently large to permit efficient transfer of audio to a user's ear canal from acoustic chamber 430.

FIG. 4B depicts another view of earbud 401, according to some examples. In diagram 450, the earbud is presented in a rearview. As shown, the earbud includes an input port 482 into which audio enters acoustic chamber volume 480. Also shown, is another side of an ear engagement member 452 and a wearable device engagement member 470. Also shown, is a rear view of output port 432.

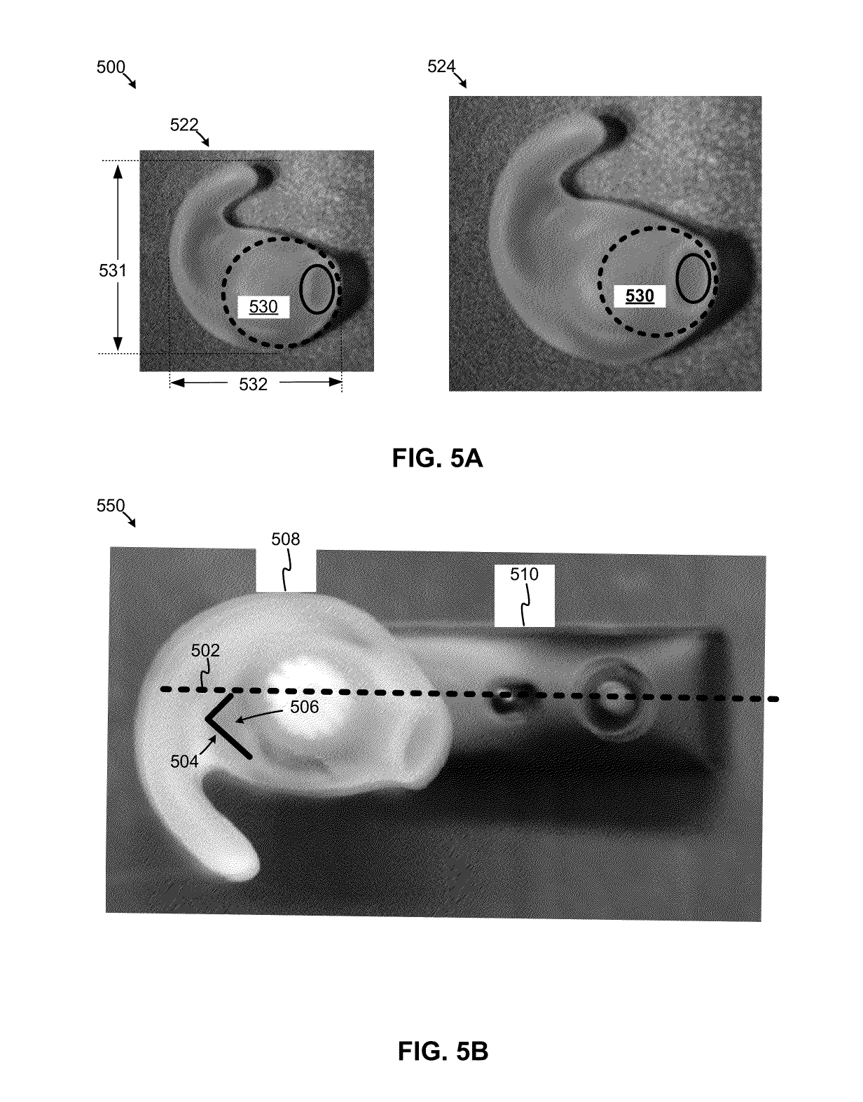

FIG. 5A depicts a system of earbuds according to some embodiments. Diagram 500 depicts a first earbud 522 and a second earbud 524 having different external dimensions 531 and 532, but having substantially similar acoustic chamber volumes for chambers 530. Therefore, independent of the ear size of a user, a user's listening experience remain substantially similar as the acoustic chambers 530 are consistently-sized. That is, the volume of acoustic chambers 530 remains substantially the same regardless of external dimensions 531 and 532 of earbuds 522 and 524.

FIG. 5B depicts an earbud engaged with a wearable communication device, according to some embodiments. Diagram 550 depicts an earbud 508 engaged in a rigid or substantially rigid orientation with wearable communication device 510. In particular, one or more earbud engagement members 506 are physically engaged with one or more wearable device engagement members 504 to lock or substantially lock the orientation of earbud 508 and wearable communication device 510 along a line 502, which can be directed toward a user's mouth.

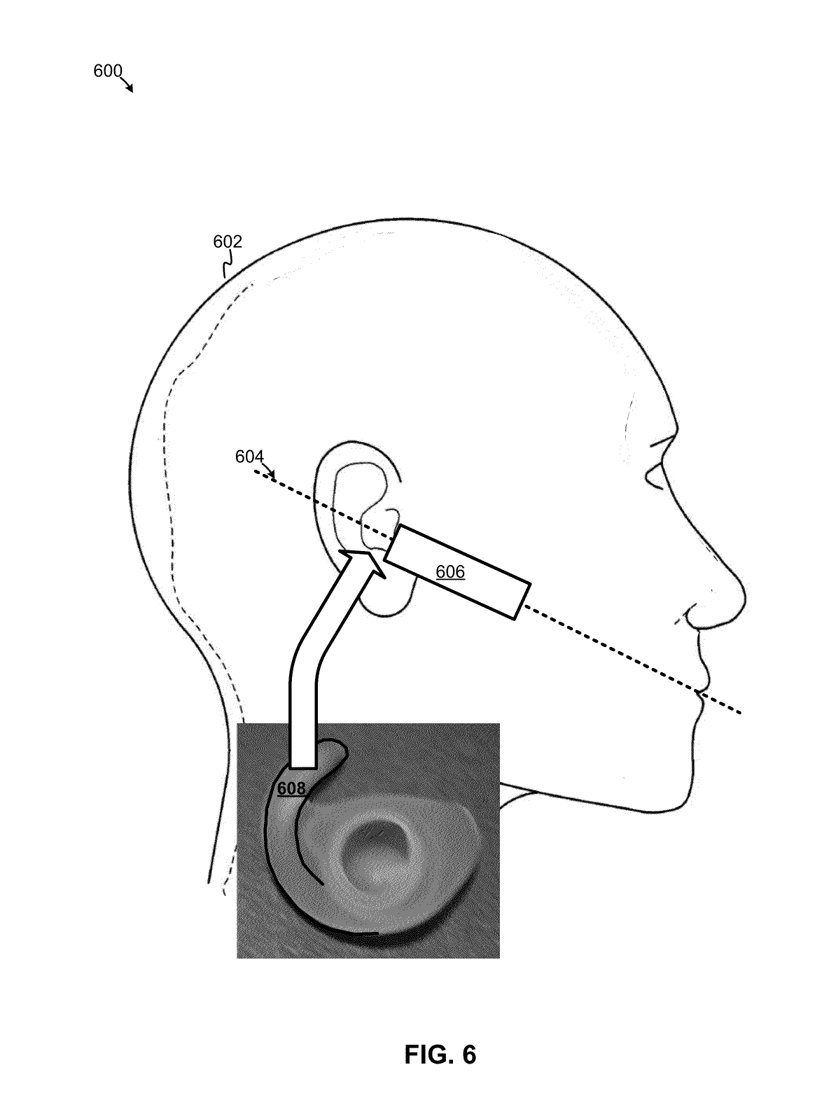

FIG. 6 depicts in orientation of a wearable communication device, according to some examples. Diagram 600 depicts a user 602 having an earbud engagement member 608 configured to engage one or more portions of a user's ear. Examples of such portions of the user's ear include a tragus portion, an anti-helix portion, and/or a concha portion. With the earbud coupled to wearable communication device 606, both of the earbud and wearable communication device 606 can maintain an orientation along line 604 (e.g., within plus or minus 30°).

FIG. 7 illustrates an exemplary computing platform disposed in a wearable communication device, media device, mobile device, or any computing device, for implementing the various above-described implementations, according to various embodiments. In some examples, computing platform 700 may be used to implement computer programs, applications, methods, processes, algorithms, or other software to perform the above-described techniques. Computing platform 700 includes a bus 702 or other communication mechanism for communicating information, which interconnects subsystems and devices, such as processor 704, system memory 706 (e.g., RAM, etc.), storage device 708 (e.g., ROM, etc.), a communication interface 713 (e.g., an Ethernet or wireless controller, a Bluetooth controller, such as a Bluetooth low energy (BTLE) controller, etc.) to facilitate communications via a port on communication link 721 to communicate, for example, with a computing device, including mobile computing and/or communication devices with processors. Processor 704 can be implemented with one or more central processing units (“CPUs”), such as those manufactured by Intel® Corporation, or one or more virtual processors, as well as any combination of CPUs and virtual processors. Computing platform 700 exchanges data representing inputs and outputs via input-and-output devices 701, including, but not limited to, keyboards, mice, audio inputs (e.g., speech-to-text devices), user interfaces, displays, monitors, cursors, touch-sensitive displays, LCD or LED displays, accelerometer or motion-controlled related interfaces, and other I/O-related devices. In some examples, input/output device 701 can include a microphone in a race, such as arrayed dual omnidirectional MEMS-based microphones and a MEMS-based SSM.

According to some examples, computing platform 700 performs specific operations by processor 704 executing one or more sequences of one or more instructions stored in system memory 706, and computing platform 700 can be implemented in a client-server arrangement, peer-to-peer arrangement, or as any mobile computing device, including smart phones and the like. Such instructions or data may be read into system memory 706 from another computer readable medium, such as storage device 708. In some examples, hard-wired circuitry may be used in place of or in combination with software instructions for implementation. Instructions may be embedded in software or firmware. The term “computer readable medium” refers to any tangible medium that participates in providing instructions to processor 704 for execution. Such a medium may take many forms, including but not limited to, non-volatile media and volatile media. Non-volatile media includes, for example, optical or magnetic disks and the like. Volatile media includes dynamic memory, such as system memory 706.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 702 for transmitting a computer data signal.

In some examples, execution of the sequences of instructions may be performed by computing platform 700. According to some examples, computing platform 700 can be coupled by communication link 721 (e.g., a wired network, such as LAN, PSTN, or any wireless network, such as GSM, LTE, cellular, NFC, Bluetooth, etc.) to any other processor to perform the sequence of instructions in coordination with (or asynchronous to) one another. Computing platform 700 may transmit and receive messages, data, and instructions, including program code (e.g., application code) through communication link 721 and communication interface 713. Received program code may be executed by processor 704 as it is received, and/or stored in memory 706 or other non-volatile storage for later execution.

In the example shown, system memory 706 can include various modules that include executable instructions to implement functionalities described herein. In the example shown, system memory 706 (e.g., in a wearable communication device/mobile computing device or at database, or both) can include an audio processor module 760 and/or any of its one or more components, such as a speech state detector module 762, an noise suppression unit module 764, an audio type detector module 765, and a band selector 766.

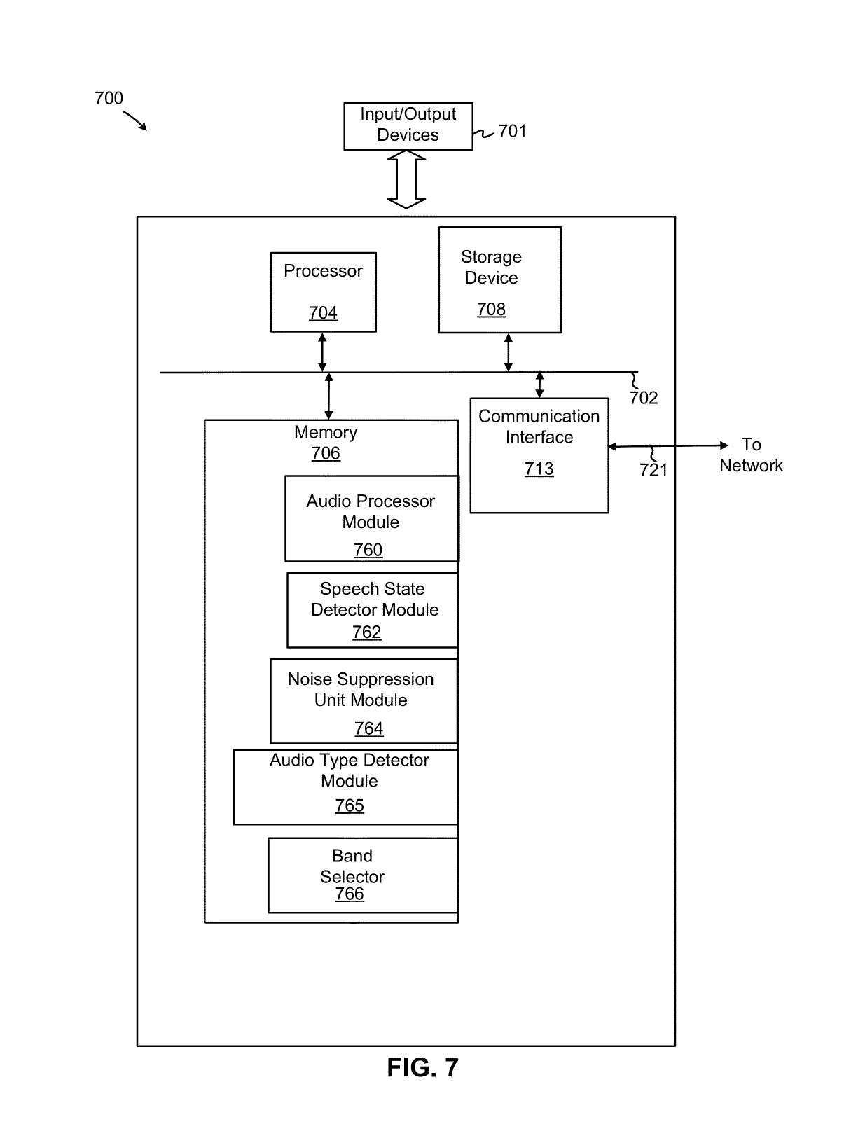

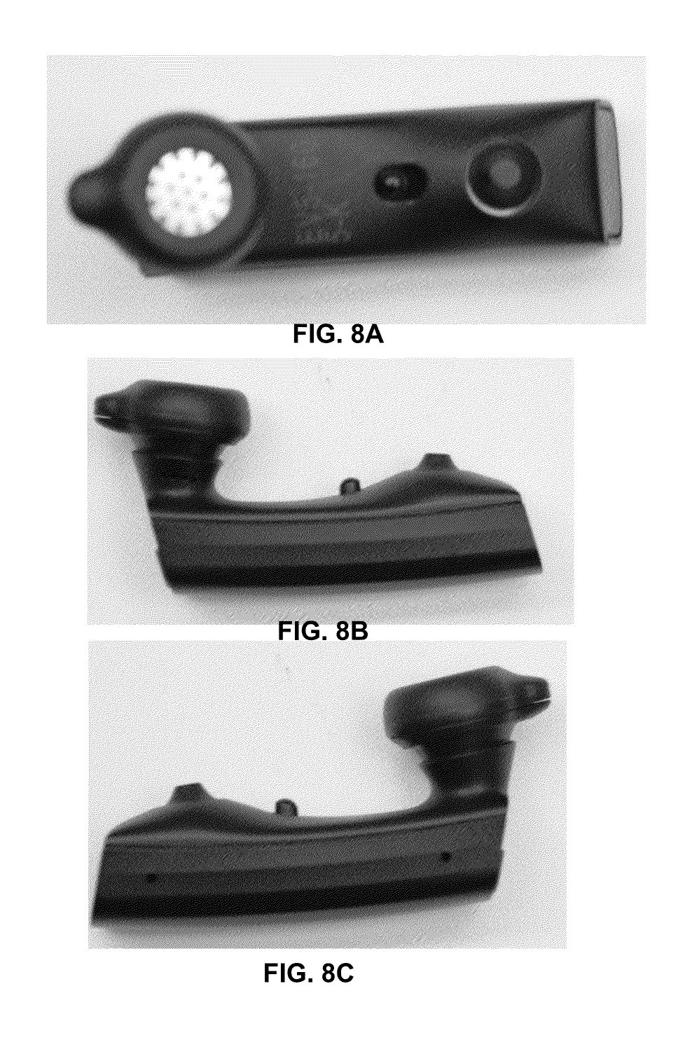

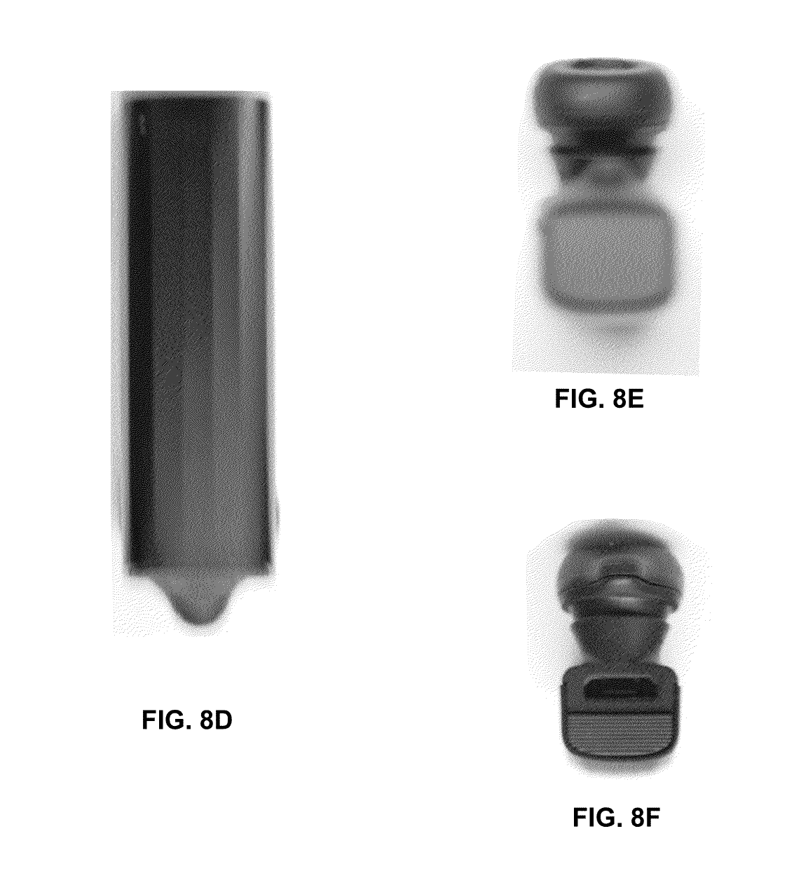

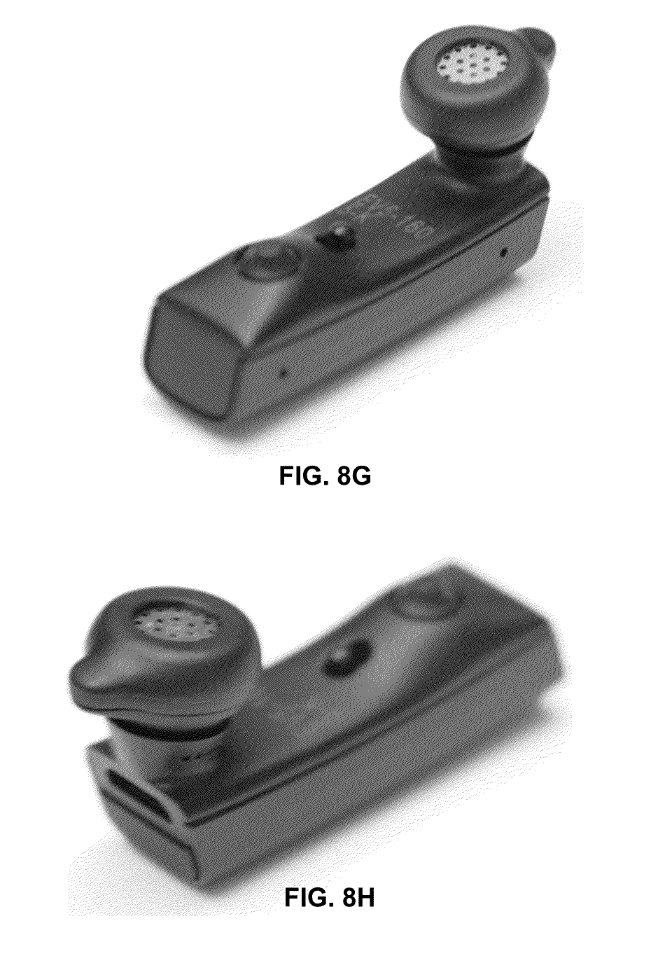

FIGS. 8A to 8H depict examples of a wearable communication device in a rear view, a left view, a right view, a front view, a top view, a bottom view, a first perspective view, and a second perspective view, respectively.

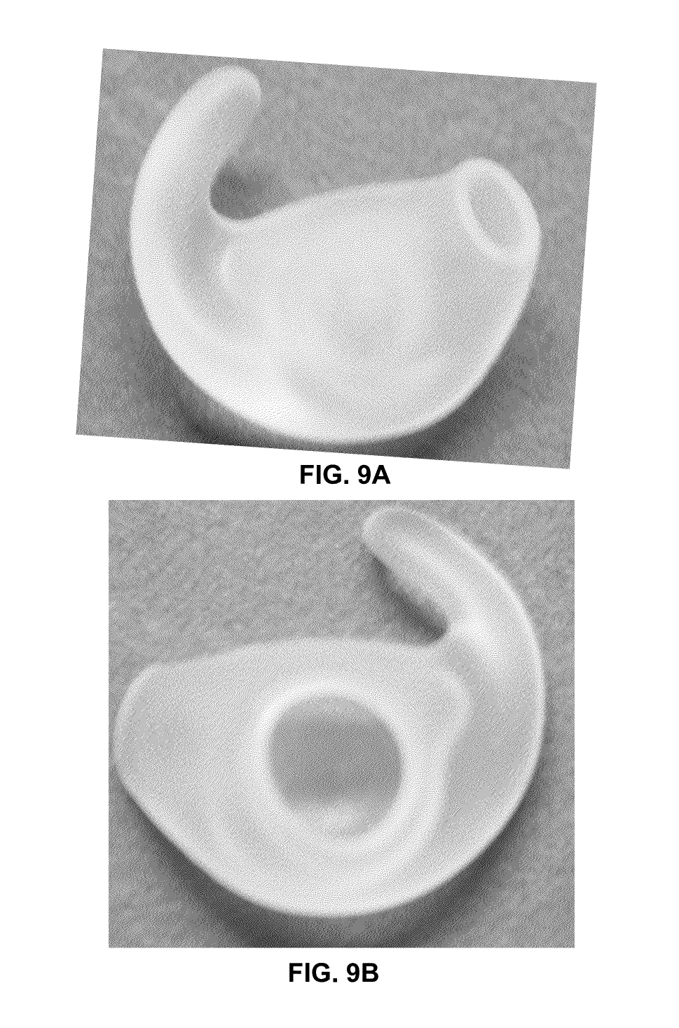

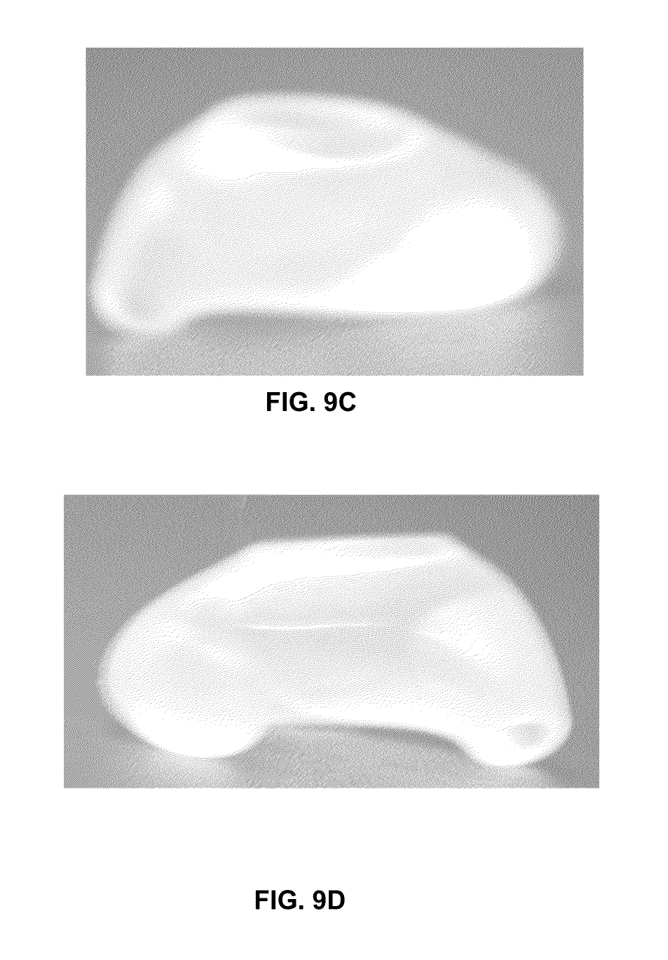

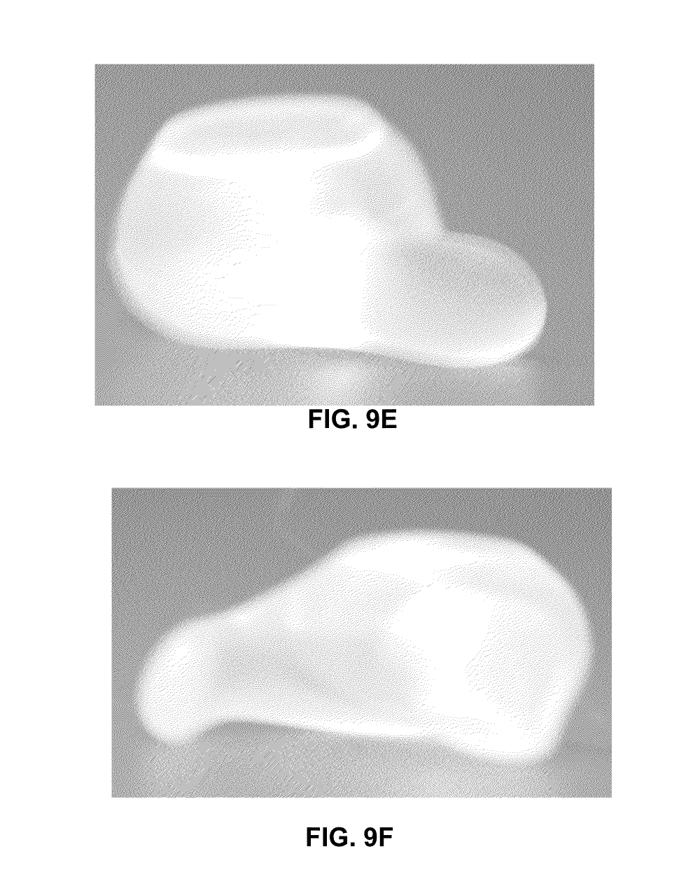

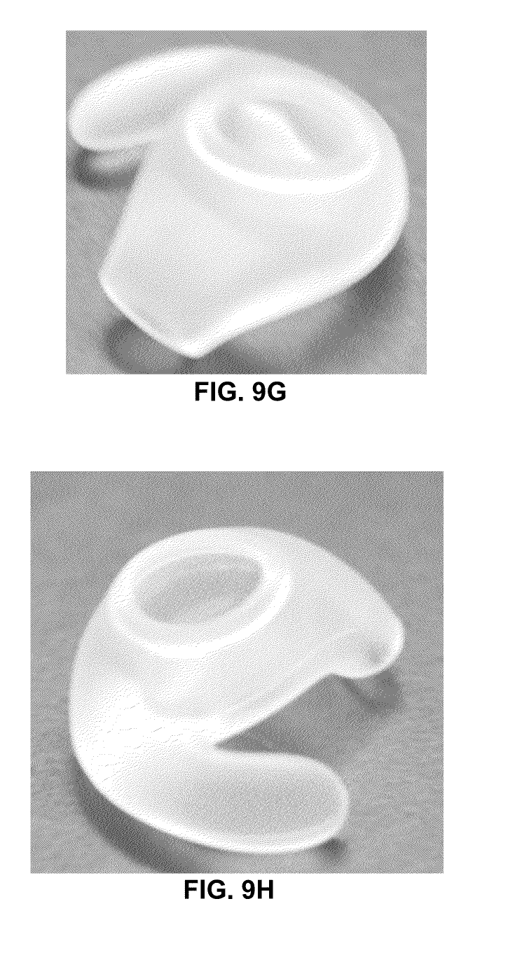

FIGS. 9A to 9H depict examples of an earbud in a front view, a rear view, a top view, a bottom view, a right view, a left view, the first perspective view, and a second perspective view, respectively.

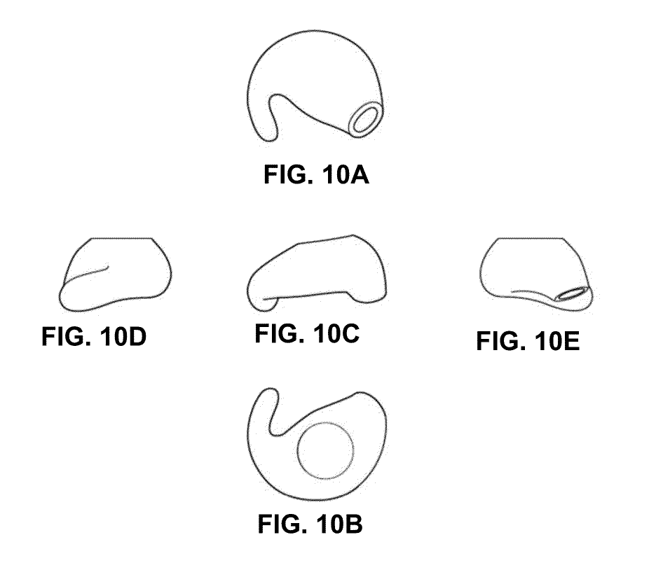

FIGS. 10A to 10E depict examples of an earbud in a front view, a rear view, a top view, a left view, and a right view, respectively.

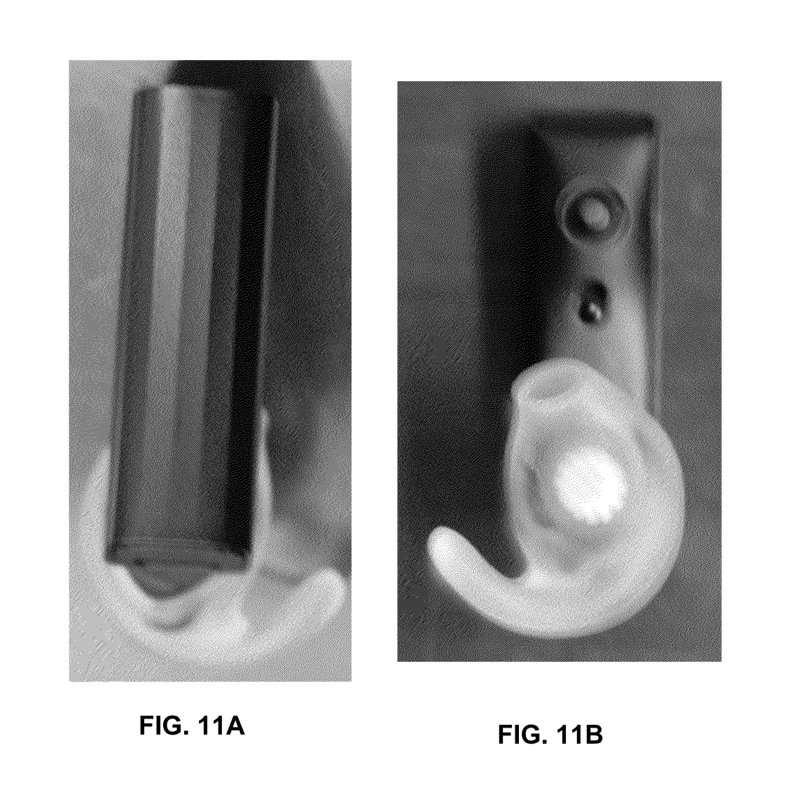

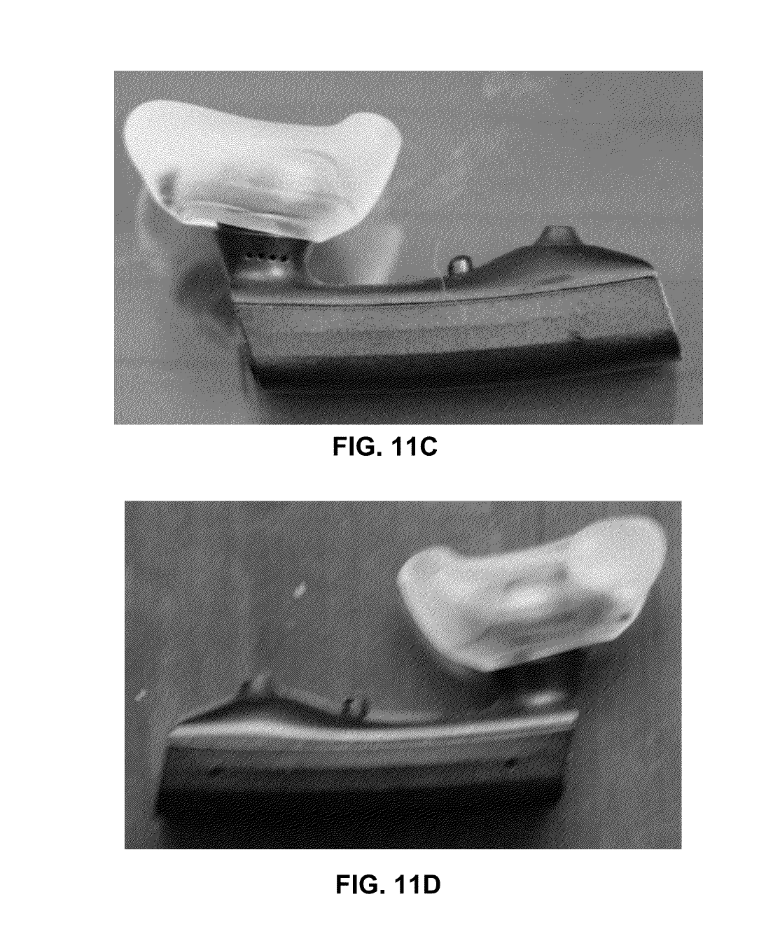

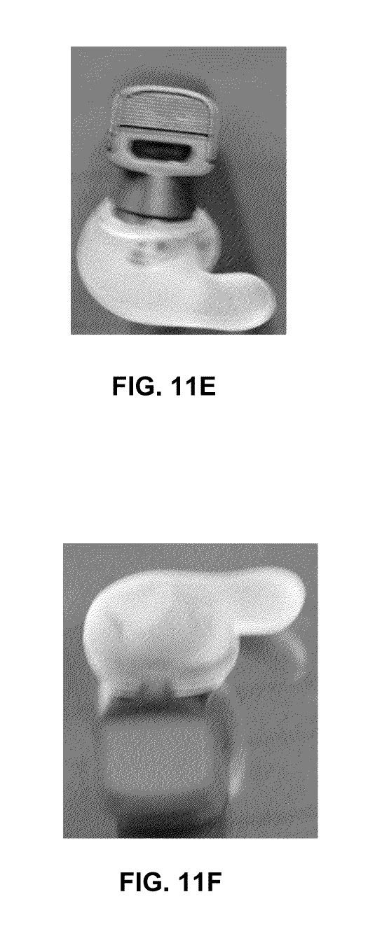

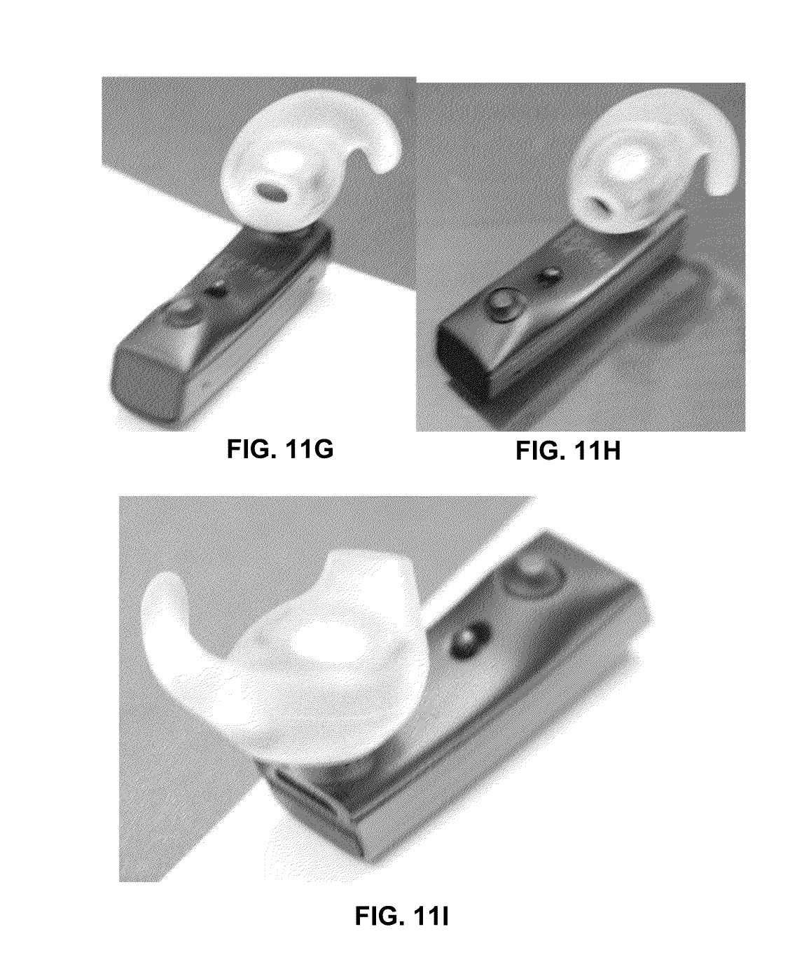

FIGS. 11A to 11I depict examples of a wearable communication device coupled to an earbud in a front view, a rear view, a left view, a right view, a bottom view, a top view, a first perspective view, a second perspective view, and a third perspective view, respectively.

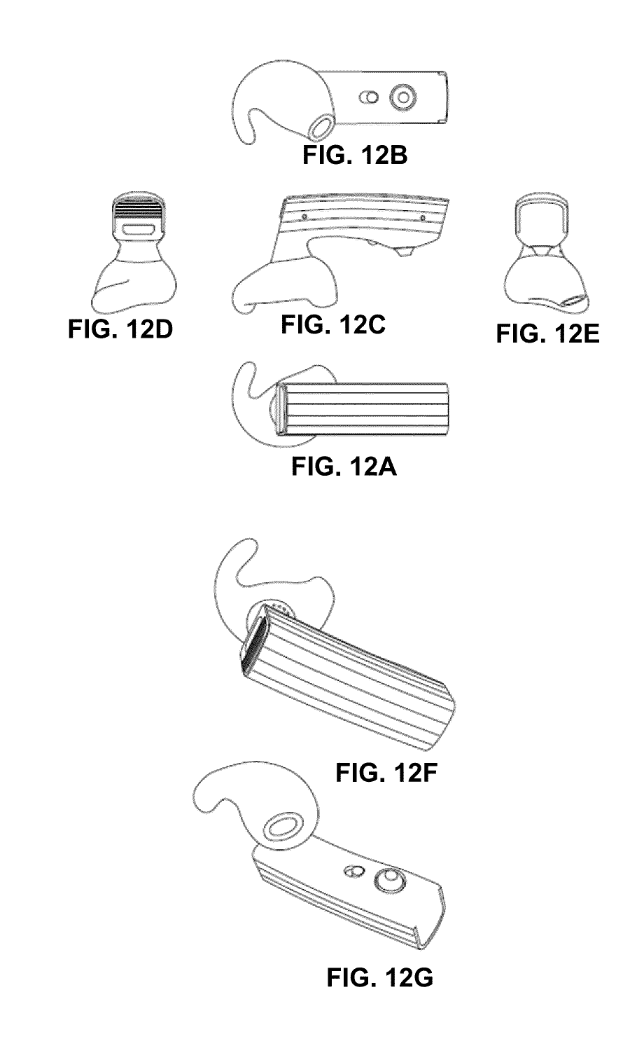

FIGS. 12A to 12G depict examples of a wearable communication device coupled to an earbud in a front view, a rear view, a side view, a bottom view, a top view, a first perspective view, and a second perspective view, respectively.

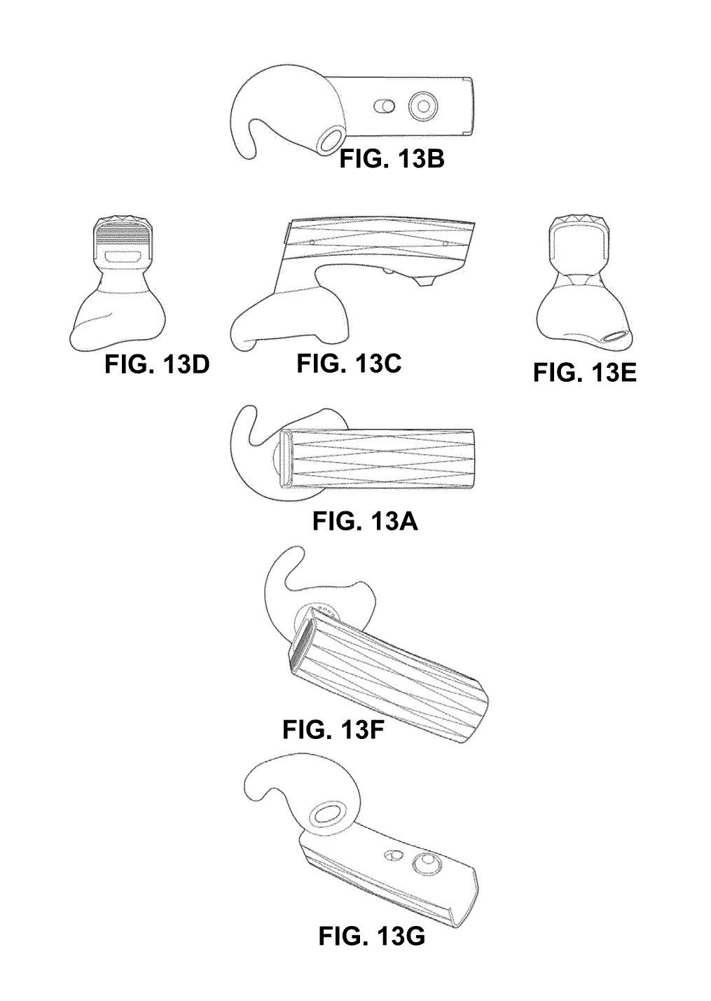

FIGS. 13A to 13G depict examples of a wearable communication device coupled to an earbud in a front view, a rear view, a side view, a bottom view, a top view, a first perspective view, and a second perspective view, respectively.

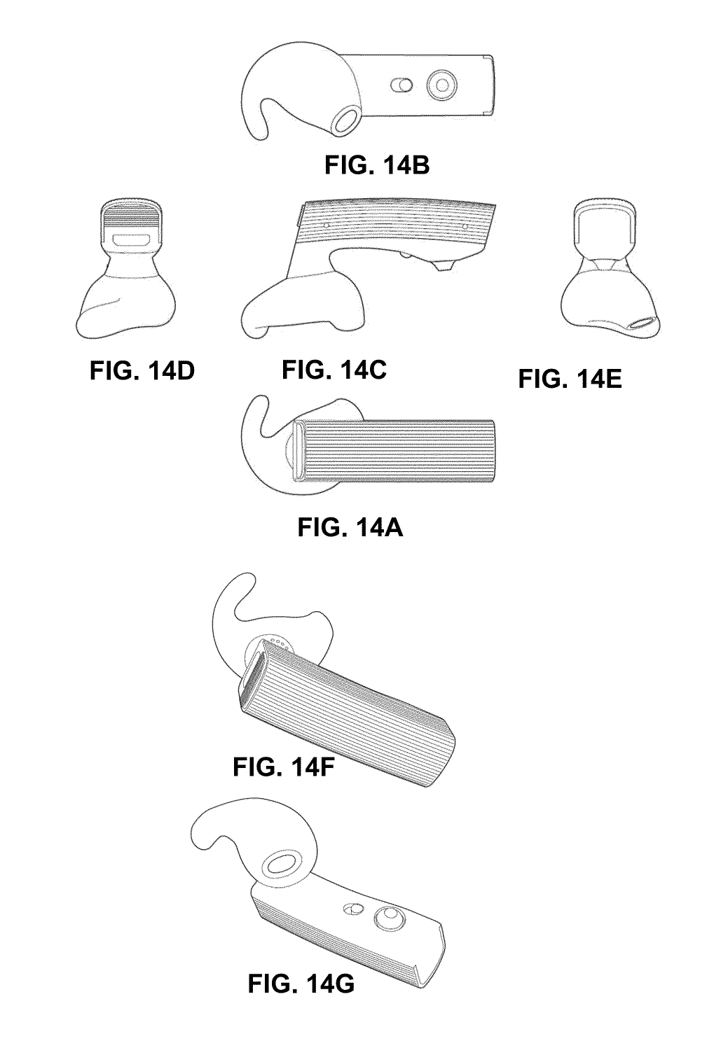

FIGS. 14A to 14G depict examples of a wearable communication device coupled to an earbud in a front view, a rear view, a side view, a bottom view, a top view, a first perspective view, and a second perspective view, respectively.

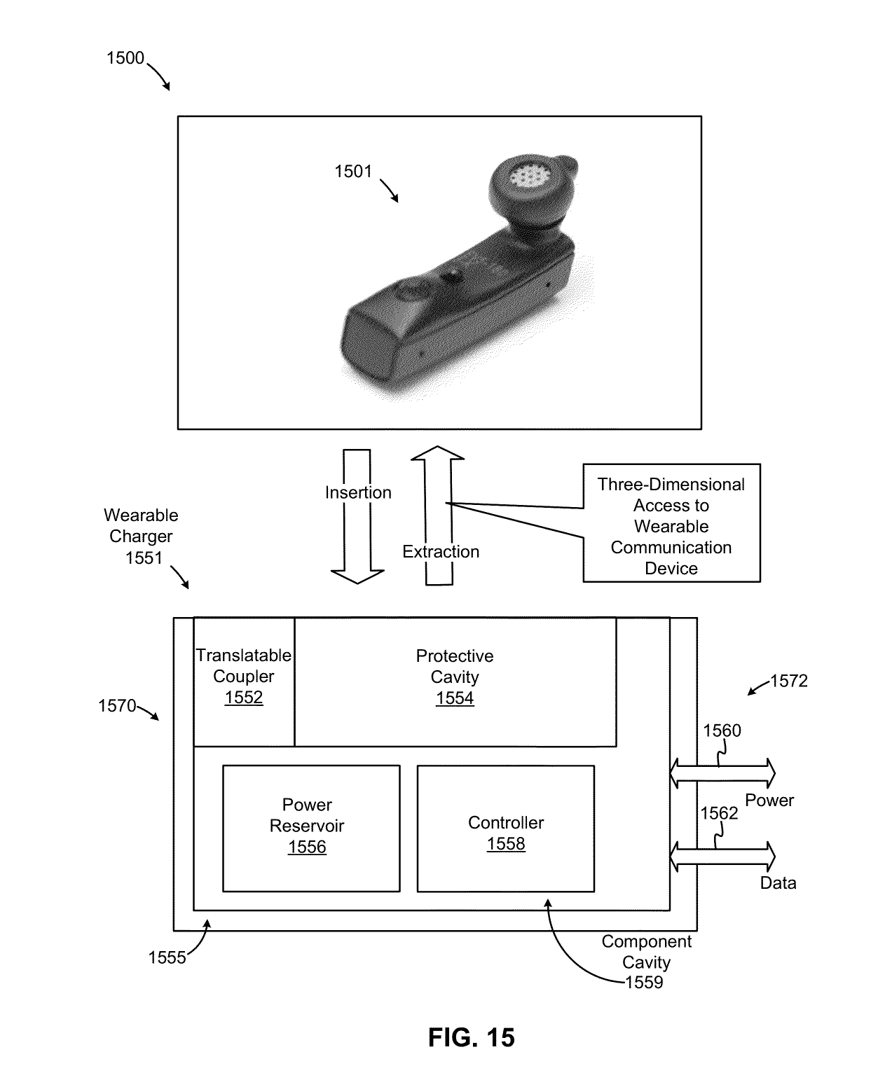

FIG. 15 depicts an example of a wearable charger, according to some embodiments. Diagram 1500 depicts a wearable communication device 1501 that is configured to be inserted into, and extracted from, a wearable charger 1551. In particular, diagram 1500 includes a functional diagram of wearable charger 1551 and its equivalent structures and/or functions. As shown, wearable charger 1551 includes a translatable coupler 1552, a protective cavity 1554, a power reservoir 1556, and a controller 1558. Wearable charger 1551 is also shown to include a shell 1555 encapsulating or substantially encapsulating the afore-mentioned components, the wearable charger 1551 having a first end 1570 and the second end 1572. Wearable charger 1551 can also include a component cavity 1559 in which one or more components may be disposed, such as power reservoir 1556 and/or controller 1558, among other components. Wearable charger 1551 can include one or more ports configured to communicate power signals 1560 (e.g., voltage or current) with an external power source, and to communicate data 1562 (data and/or instructions) with an external data source.

Protective cavity 1554 is configured to protect wearable communication device 1501 from encroachment of objects that might otherwise contact the wearable communication device 1501 and its electrical coupling to translatable coupler 1552. Protective cavity 1554 provides protection during, for example, charging states or firmware update states, when disruptions in conductivity are not desired, as well as when wearable communication device 1501 is stored between uses. Power reservoir 1556 can be configured to store charge for the transfer to wearable communication device 1501. Power reservoir 1556 can be further configured to transfer electric charge in a charging state. In some examples, power reservoir 1556 is a battery, such as a rechargeable lithium ion battery. Controller 1558 is configured to control the charging processes as well as other functionalities of wearable charger 1551. Translatable coupler 1552 can be disposed adjacent to first end 1570, second end 1572, or elsewhere in wearable charger 1551. Translatable coupler 1552 can include a connector (not shown) that is configured to removably couple to wearable communication device 1501. In particular, translatable coupler 1552 is configured to translate the connector and wearable communication device 1501 coupled thereto from protective cavity 1554 to a region external to protective cavity 1554, responsive to, for example, an applied force. In view of the foregoing, wearable charger 1551 is configured to provide three dimensional access to wearable communication device 1501 when extended. For example, a user has access to at least five of the six surfaces of wearable communication device 1501. A user may have access to a top surface, two side surfaces, a front surface, and a rear surface for purposes of gripping wearable medications device 1501 for removal from wearable charger 1551. As such, a user need not focus their attention on how to extract wearable communication device 1501 from wearable charger 1551 when they are doing other activities, such as driving or walking. For example, a user need not have to reset their grip on the charger for purposes of extraction (e.g., a user may use one hand while wearable charger 1551 is carried by their person).

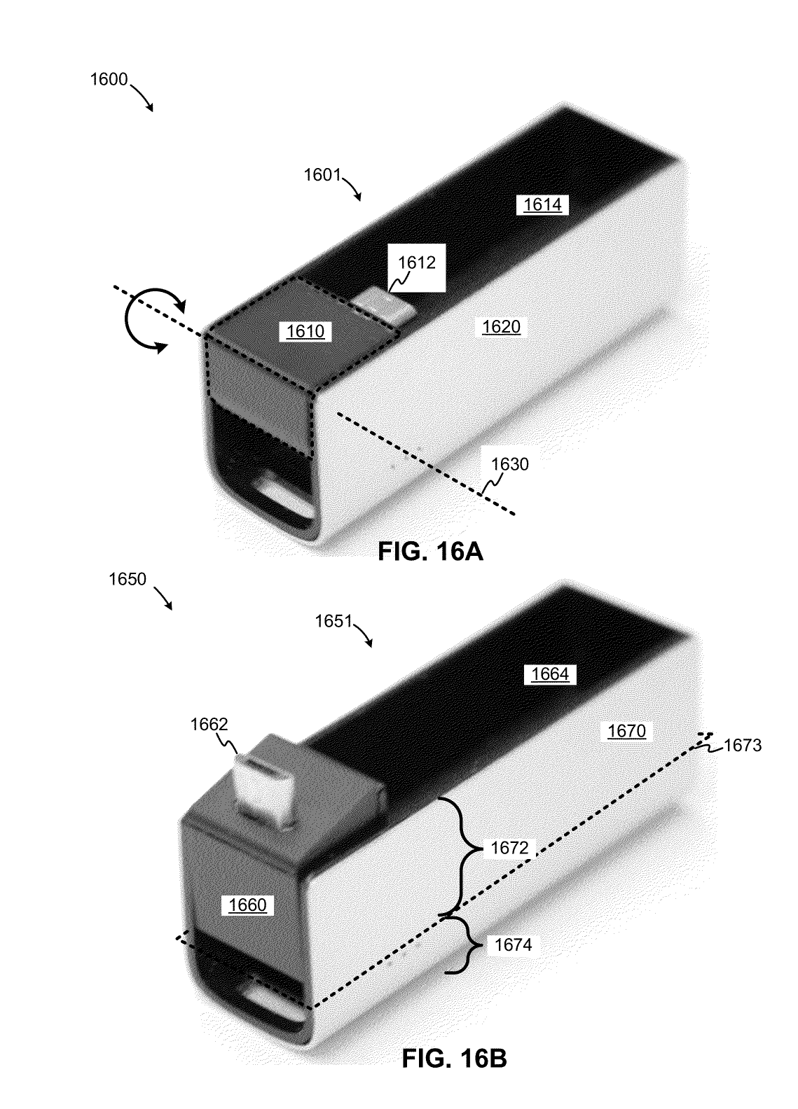

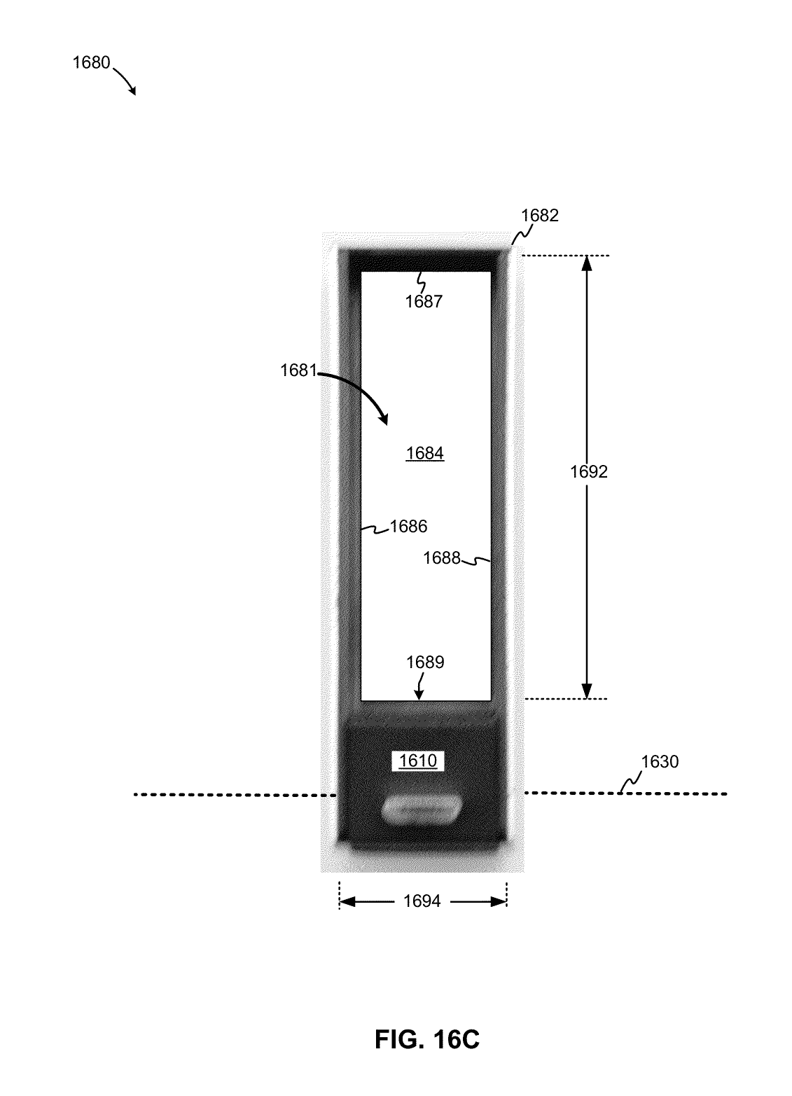

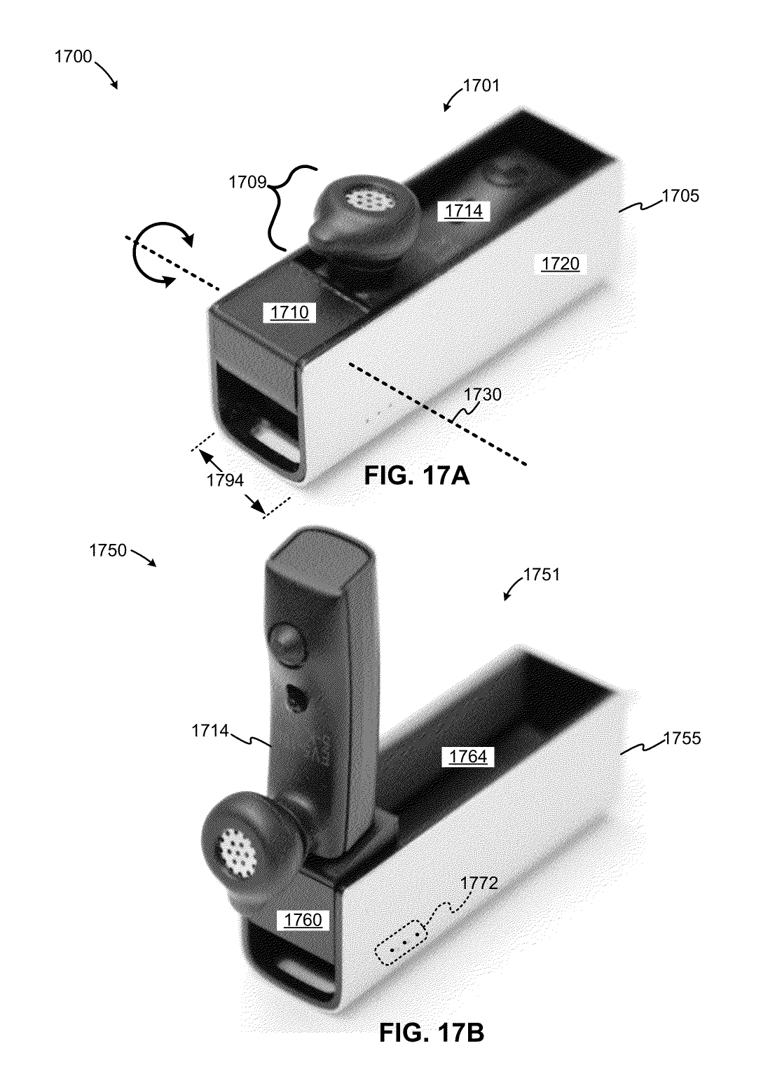

FIGS. 16A and 16B depict a wearable charger in different states, according to some embodiments. Diagram 1600 depicts a wearable charger 1601 in a closed state. In this state, translatable coupler 1610 is oriented to dispose connector 1612 toward or in protective cavity 1614, which is disposed in shell portion 1620. In this example, protective cavity 1614 is dimensioned to receive a housing of wearable communication device (not shown) when in a nested state, an example of which is depicted in FIG. 17A. Referring back to FIG. 16A, translatable coupler 1610 can be configured to rotate about axis 1630 to translate connector 1612 from the orientation shown in FIG. 16A to the orientation depicted in FIG. 16B. Diagram 1650 of FIG. 16B depicts a wearable charger 1651 in an open state. In this state, translatable coupler 1660 is oriented to dispose connector 1662 in a region external to protective cavity 1664 (protected by shell portion 1670), thereby making connector 1662 (and any wearable device connected thereto) accessible by a user upon, for example, application of a force that causes translation or rotation. While above diagrams depict translation being a rotation about an axis 1630, the various embodiments are not so limited. Translation can be other than rotation in some examples (e.g., linear translation, other motion paths, etc.). Further, rotations are not limited to axis 1630 but can relate to other axes that are not shown. In some examples, a longitudinal plane 1673 can separate a portion of a space 1674, which can include a component cavity, from a portion of space 1672 that can include protective cavity 1664. Note that the component cavity need not traverse the entire length of wearable charger 1651. In other examples, component cavity can be distributed or disposed adjacent the top side wall or adjacent any of the two side walls to reduce the height of wearable charger 1651. Other dimensions, such as the width or the length, may be adjusted to accommodate the displaced component cavity.

FIG. 16C is a top view depicting a wearable charger in an open state, according to some examples. Diagram 1680 depicts examples of various structures that constitute an example of protective cavity 1681. For example, protective cavity 1681 can have first sidewall 1686 and a second sidewall 1688 that have an elongated dimension 1692 which can originate substantially at one of the ends of wearable charger 1682. In some cases, wearable charger 1682 can include a bottom wall 1684 which can be disposed on a first side of a longitudinal plane (not shown), whereby the component cavity may be disposed on the other side of the longitudinal plane. In some examples, protective cavity 1681 can optionally implement a top wall or top sidewall 1687. Further, protective cavity 1681 can include a wall 1689 of translatable coupler 1610. Thus, sidewalls 1686 and 1688, bottom wall 1684, top sidewall 1687, and wall 1689 can provide protection for at least five of the six surfaces of a wearable communication device. However, wearable charger 1682 is not so limited and can be enclosed by more or fewer walls to protect more or fewer than five surfaces of wearable communication device. Also shown, wearable charger 1682 has a width 1694. In some embodiments, wearable charger 1682 includes an axis 1630 disposed adjacent at an end opposite to another end that includes top sidewall 1687. In some examples, the shaft or portions of the shaft, or any pivoting members, can be implemented as, or coextensive with, axis 1630. As such, translatable coupler 1610 can be implemented as a rotatable coupler 1610, according to some embodiments.

FIGS. 17A and 17B depict a wearable charger in different states, according to some embodiments. Diagram 1700 depicts a wearable charger 1705 in a nested state. In this state, translatable coupler 1710 is oriented to dispose a connector, which is coupled to wearable communication device 1714, toward or in a protective cavity, which is disposed in shell portion 1720. In the nested state, wearable communication device 1714 and wearable charger 1705 constitute system 1701. In this case, translatable coupler 1710 can be implemented as a rotatable coupler configured to rotate about axis 1730. In the example shown, at least two sidewalls of the protective cavity have a height being below a speaker channel housing portion 1709. The height of the sides permits an earbud (not shown) to be disposed upon speaker channel housing portion 1709 that has a width larger than the width 1794 or width 1694 of FIG. 16C. Returning to FIG. 17B, diagram 1750 depicts a wearable charger 1755 in an extended state. In this state, system 1751, which can include wearable communication device 1714 and wearable charger 1755, includes a wearable communication device that has been rotated in concert with the rotation of rotational coupler 1760. This causes wearable communication device 1714 two rotate from and out of protective cavity 1764. Further to diagram 1750, wearable charger 1755 can include one or more light emitting diodes configured to illuminate as a function of the total charge stored in the power reservoir or battery. Thus, the more charge stored in the battery, the more LEDs. In one example, when less than 5% of stored charge remains, one LED will blink.

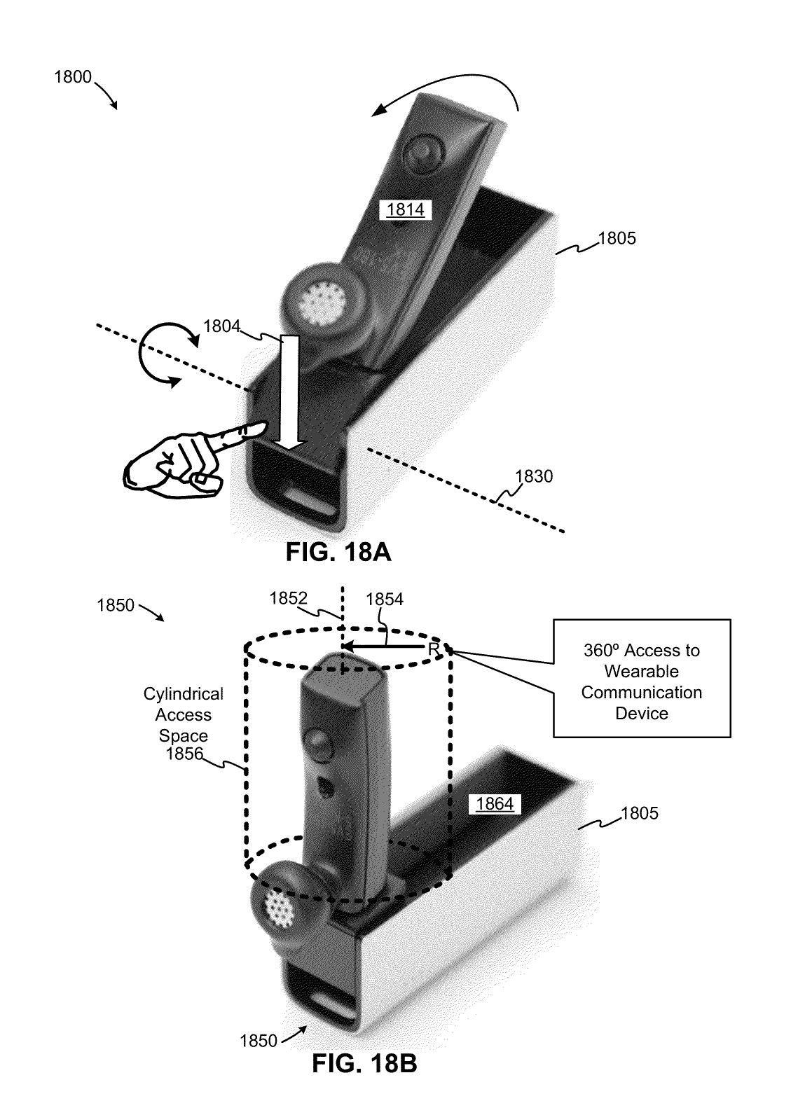

FIGS. 18A and 18B depict an example of an application of force to provide access to a wearable communication device from a nesting state, according to some embodiments. Diagram 1800 depicts an application of force 1804 to a translatable coupler to cause the translatable coupler to rotate about axis 1830. As translatable coupler is coupled to a wearable communication device 1814, wearable communication device 1814 rotates out from a nested state (e.g., out from being disposed in a protective cavity) at an equivalent rate about axis 1830 as does the translatable coupler. Note that force 1804 need not be applied directly to the translatable coupler, but can be applied to any portion of the combination of, for example, the translatable portion and wearable communication device 1814 to cause translation (e.g., rotation) from wearable charger 1805. In some embodiments, a user need not modify its grip or interaction with wearable charger 1805 through the extraction process. According to some examples, applied force 1804 is sufficient to cause a change between the nested state and the extended state.

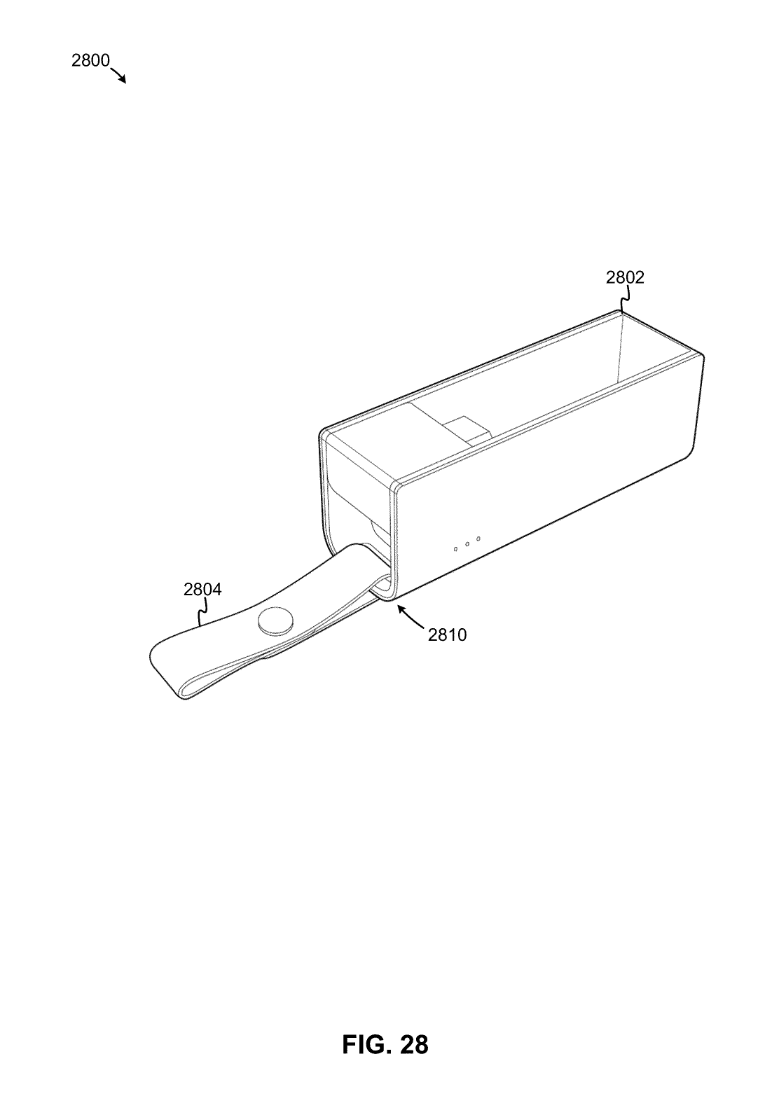

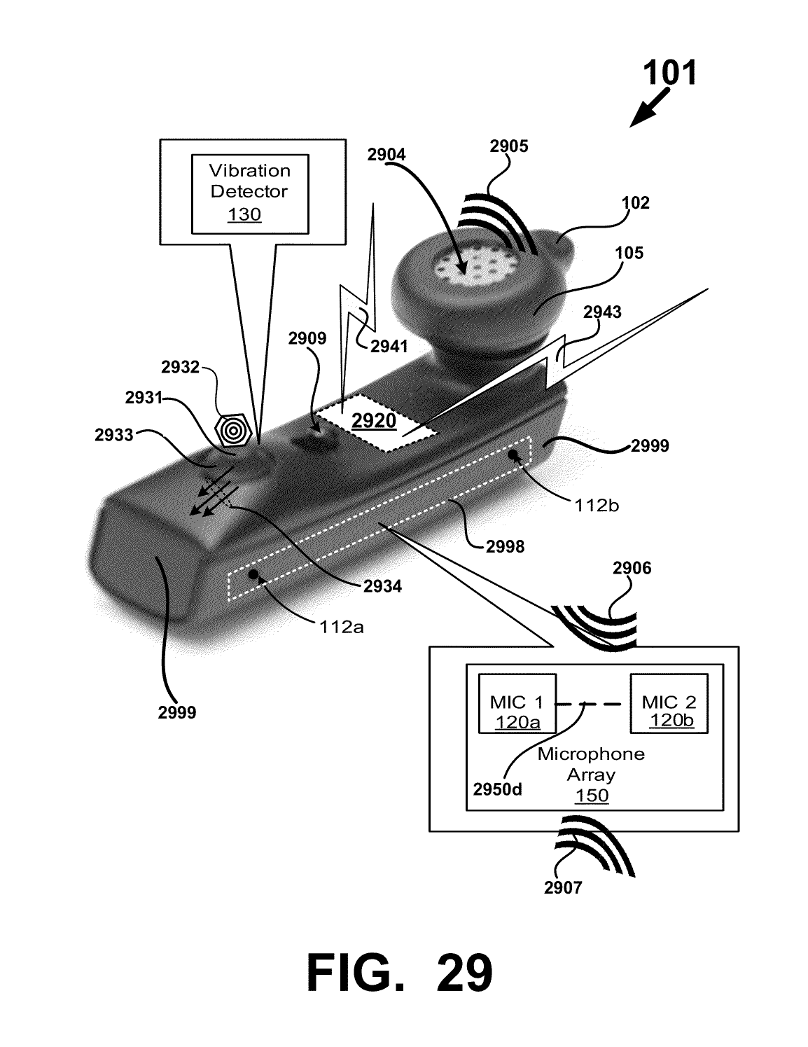

FIG. 18B is a diagram 1850 depicting at least a wearable communication device in an extended state. For example, in an extended state of either the wearable communication device or wearable charger 1805, or both, the wearable communication device is accessible in a region external to a protective cavity 1864. In some examples, the region is an access space from which either the connector (e.g., in an open state without coupling to a wearable communication device) or the wearable communication device (e.g., in an extended state), or both, are accessible from any radial direction (“R”) 1854 extending to a medial line 1852 that passes through the center of the wearable communication device (e.g., from the top surface to the bottom surface). In some examples, the access space can be depicted as a cylindrical access space in which the user may have access from any radial direction 1854 in 360°. In particular, a user's hand can come from any radial direction 1854 without obstruction by, for example, a portion of wearable charger 1805. In various examples, the access space may provide access from anywhere between 180° and 360°, or from 270° to 360°. Unobstructed access facilitates extraction with a user's ability to use tactile interactions to readily remove a wearable communication device from wearable charger 1805. Diagram 1850 also depicts an example of an attachment member 1850 configured to couple wearable device charger 1850 to a user. In the example shown, attachment member 1850 can include a portion of the shell in which a hole is formed to receive a strap, as shown in FIG. 28. Other attachment members or means for coupling (e.g., by clips, bands, watches, jewelry, pins, lanyards, etc.) wearable charger 1805 to a user or a user's clothes are within the scope of the various embodiments.

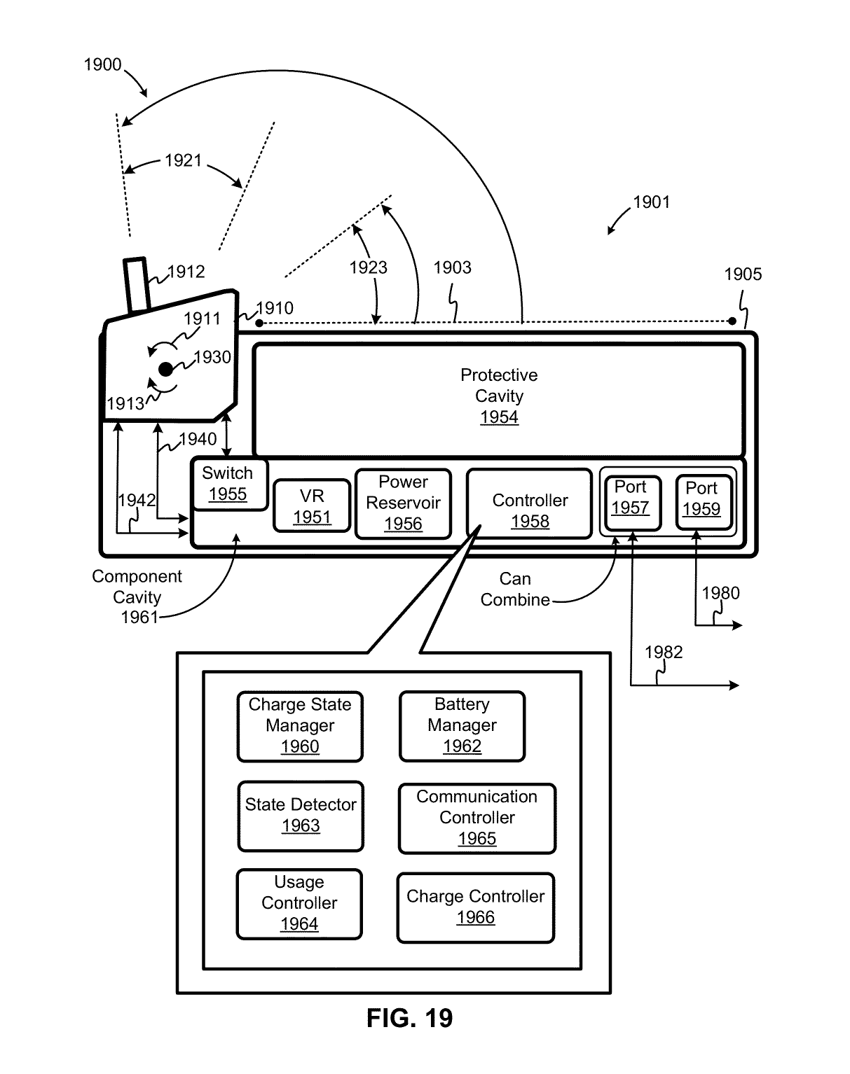

FIG. 19 depicts a wearable charger and examples of its components, according to some embodiments. Diagram 1900 shows a wearable charger 1901 having a shell 1905, and including a protective cavity 1954, a translatable coupler 1910, and the component cavity 1961. As shown, translatable coupler 1910 is configured to rotate about axis 1930, whereby a connector 1912 rotates correspondingly. In some examples, one of more resilient members (not shown) may be implemented in wearable charger 1901 and/or translatable coupler 1910. For example, a first resilient member (not shown) can be configured to apply a first spring force 1911, or the like, to cause translatable coupler 1910 to translate to an extended state when aligned in a first range of angles 1921 relative to an elongated dimension 1903. Further, a second resilient member (not shown) can be configured to apply a second spring force 1913 to cause translatable coupler 1910 to translate to the nested state when aligned in a second range of angles 1923 related to elongated dimension 1903. An example of the resilient member that can provide the above-identified spring forces is a spring, such as a torsion spring or a variant thereof, or any other type of material (e.g., an elastic material) capable of providing a returning rotational force to return connector 1912 to one of at least two orientations based on a closed or open state, for example. Examples of angle ranges for the first range of angles 1921 can include angles within a range of 45° to 90°, or more, or can include angles within an approximate range of about 60° to about 90°. Examples of angle ranges for the second range of angles 1923 can include angles within a range of 0° to 45°, or more, or can include angles within an approximate range of about 0° to about 30°.

Wearable charger 1905 can also include one or more buses to convey signals, such as power signals (e.g., voltage and/or current signals), communication signals, data signals, control signals, and the like. As shown, a power bus 1942 can be coupled among connector 1912, a power reservoir 1956 in component cavity 1961, and at least port 1957 to receive a power signal 1982 from an external power source. Similarly, a data bus 1940 can be coupled among connector 1912, a controller 1958 in component cavity 1961, and at least port 1959 to exchange data signals 1980 with and external data source. While not shown, power bus 1942 and data bus 1940 can be coupled to one or more components in component cavity 1961 or any other component within wearable charger 1905. Wearable charger 1905 also includes a switch 1955 disposed in component cavity 1961, translatable coupler 1910, or elsewhere within wearable charger 1905. Switch 1955 can be coupled to translatable coupler 1910 to detect the orientation of the translatable coupler (and changes of orientation thereto). Switch 1955 can be configured to generate a signal indicating the orientation of translatable coupler 1910 or connector 1912 to, for example, controller 1958.

In the example shown, component cavity 1961 may include switch 1955, a voltage regulator (“VR”) 1951 configured to regulate voltage from power reservoir 1956, controller 1958, and one or more ports, such as one of ports 1957 and 1959 (note that ports 1957 and 1959 can be implemented as one port). Controller 1958 is configured to include a charge state manager 1960, a battery manager 1962, a state detector 1963, a usage controller 1964, a communication controller 1965, and a charge controller 1966 is configured to control cooperative operation of the components of controller 1958. In some examples, state detector 1963 is configured to obtain orientation information of translatable coupler 1910 via switch 1955, and is further configured to determine the state of wearable charger 1905. For example, state detector 1963 can determine whether wearable charger 1905 is in a closed state (e.g., connector 1912 is disposed in protective cavity 1954 without being coupled to a wearable communication device), in an open state (e.g., connector 1912 is extended to a region external to protective cavity 1954), in a nested state (e.g., connector 1912 is disposed in protective cavity 1954 while being coupled to a wearable communication device), and an extended state (e.g., extended to a region external to protective cavity 1954 while being coupled to a wearable communication device or some other device, such as a mobile phone). In some examples, state detector 1963 can store data representing the number of times translatable coupler is switched between an open state and a closed state. Such data can be transmitted to an external data source for evaluation.

Based on various states as determined by state detector 1963, charge controller 1966 can perform different operations. For example, in a closed state charge controller 1966 can detect whether external power is coupled to one of ports 1957 and 1959. If so, charge controller 1966 can enable charging of power reservoir 1956, which can be a lithium ion battery. In other examples, in a closed state charge controller 1966 can determine or detect whether one of ports 1957 and 1959 of coupled to an external data source. If so, charge controller 1966 can initiate a data connection to communicate or exchange data via communication controller 1965. If an open state is detected, charge controller 1966 can sample connector 1912 periodically to determine whether it is coupled to a device. If no connection is detected, charge controller 1966 can operate as if connector 1912 is in a closed state.

If a nested state is detected, charge controller 1966 can be configured to enable charging of the battery within a wearable device (or some other device) coupled to connector 1912. Further, charge controller 1966 can be configured to draw charge from either a battery 1956 or an external power source depending on whether a connection to an external power source exists. So if charge controller 1966 does not detect that one of ports 1957 and 1959 of coupled to an external power source, charge is transferred from battery 1956 via connector 1912 to a device. Otherwise, if charge controller 1966 detects an external power source, charge is transferred from the external power source to charge the battery of a wearable device disposed in protective cavity 1954. If an extended state is detected, charge controller 1966 can determine whether to apply or enable data and/or power to be transmitted to connector 1912. The first example, or may be continually supply to connector 1912 in the event a firmware update is being provided to either wearable charger 1905 or a wearable computing device coupled to connector 1912. The continual supply power can facilitate proper firmware updating. In some cases, if charge controller 1966 detects that firmware is being applied to either wearable charger 1905 or the wearable communication device, charge controller 1966 can remove either data or power, or both, from connector 1912. In another example, charge controller 1966 can determine whether a device coupled to connector 1912 is authorized to receive either data or power, or both. In one instance, charge controller receives an identifier, such as a MAC ID, a Bluetooth ID, a predetermined ID, a proprietary ID, or the like, to determine whether that identifier is authorized to couple to connector 1912.

Usage controller 1964 configured to detect whether a device is coupled to connector 1912 and whether such a device can be identified as described above. Further, usage controller 1964 can track the number of charging hours, the number of devices connected to connector 1912, and other device-related data that can be extracted from a device coupled to connector 1912. In some cases, detection of an unauthorized device coupled to connector 1912 may cause usage controller 1964 to generate a notification for transmission to a remote source via one of ports 1957 and 1959.

Charge state manager 1960 is configured to manage the charging of the battery in a wearable communication device. For example, depending on the charge state (e.g., amount of charged presently detected in a battery, expressed optionally as a percentage), charge state manager 1960 can determine whether to initiate charging (i.e., apply charge), or whether to cease charging. For example, a fully-charged battery can be detected by charge state manager 1960, whereby charging of the battery is not initiated. Further, charge state manager 1960 can be configured to monitor or track the various charge states when a device is inserted into connector 1912 or when a device is extracted therefrom. For example, one group of users may typically insert the wearable communication device into wearable charger 1905 for charging with charge states 75% or more, whereas another group of users may insert the wearable communication device for charging charge states of 25% or less. Also, charge state manager 1960 can determine the number charging cycles, the rate at which wearable charger 1905 is used, an average or median charge state in which charging is initiated or terminated, etc. In turn, charge state manager 1960 can generate data reporting such information to an external data source via one of ports 1957 and 1959. In some embodiments, charge controller 1966 can prioritize charging of either the battery in the wearable communication device or the battery 1956 as a function, for example, the charge state of each. For instance, if a wearable device is fully-charged in a nested state, charge controller 1966 may initiate charging of battery 1956. In some cases, the charging of the battery of the wearable communication device takes precedent over battery 1956. Or, in some cases, charge controller 1966 can be configured to arbitrate between charging the battery of the wearable communication device and battery 1956 to charge them both over time so that they maintain a predetermined relationship between charge states.

Battery manager 1962 is configured to manage operation of battery 1956. For example, Barry manager 1962 can track or monitor the time or average time to become fully charged, amount of battery degradation over time, and other battery related information. Further, battery manager 1962 can generate a notification for transmission to an external data source upon detecting battery 1956 is unable to maintain a charge above a threshold amount. In some embodiments, battery manager 1962 also initiates control of one or more LEDs to visually depict the relative amounts of remaining charge in the power repository or battery.

Communications controller 1965 is configured to open a data connection to either a wearable communication device coupled via connection 1912, or wirelessly. Further, communications controller is also configured open a data connection to an external data source via for example a micro-USB protocol, or any wireless protocol, such as Bluetooth, NFC, etc.

In some examples, connector 1912 and one or more ports 1957 and 1959 can be implemented using a USB port, such as in micro-USB connector, each of which can be configured to convey either power or data, or both. Note while this example describes the use of micro-USB connectors, various other connectors and communication technologies (e.g., Firewire®, WiFi, Bluetooth, etc.) can be used to implement connectors 1912 and ports 1957 and 1959. Note, too, that ports 1957 and 1959 can be combined as one port.

In some embodiments, a wearable charger for a wearable communication device, such as a headset or equivalent, a mobile device (e.g., a mobile phone) or any networked computing device (not shown) in communication with one or more of the above-mentioned devices, can provide at least some of the structures and/or functions of any of the features described herein. As depicted in FIG. 19 and (or any other figure), the structures and/or functions of any of the above-described features can be implemented in software, hardware, firmware, circuitry, or any combination thereof. Note that the structures and constituent elements above, as well as their functionality, may be aggregated or combined with one or more other structures or elements. Alternatively, the elements and their functionality may be subdivided into constituent sub-elements, if any. As software, at least some of the above-described techniques may be implemented using various types of programming or formatting languages, frameworks, syntax, applications, protocols, objects, or techniques. For example, at least one of the elements depicted in FIG. 19 (or any figure) can represent one or more algorithms. Or, at least one of the elements can represent a portion of logic including a portion of hardware configured to provide constituent structures and/or functionalities.

For example, controller 1958 and/or any of its one or more components, such as charge state manager 1960, battery manager 1962, state detector 1963, usage controller 1964, communication controller 1965, and charge controller 1966 can be implemented in one or more communication devices or devices that can provide communication facilities, such as desktop audio system (e.g., a Jambox® or a variant thereof), a mobile computing device, such as a wearable device or mobile phone (whether worn or carried), that include one or more processors configured to execute one or more algorithms in memory. Thus, at least some of the elements in FIG. 19 (or any other figure) can represent one or more algorithms. These can be varied and are not limited to the examples or descriptions provided.

As hardware and/or firmware, the above-described structures and techniques can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit. For example, controller 1958 and/or any of its one or more components, such as charge state manager 1960, battery manager 1962, state detector 1963, usage controller 1964, communication controller 1965, and charge controller 1966 of FIG. 19 (or other figures) can be implemented in one or more computing devices that include one or more circuits. Thus, at least one of the elements in FIG. 19 (or any other figure) can represent one or more components of hardware. Or, at least one of the elements can represent a portion of logic including a portion of circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided. In some embodiments, one or more components of controller 1958 (or any components shown in FIG. 19) can be implemented in one or more elements depicted in computing platform 700 of FIG. 7.

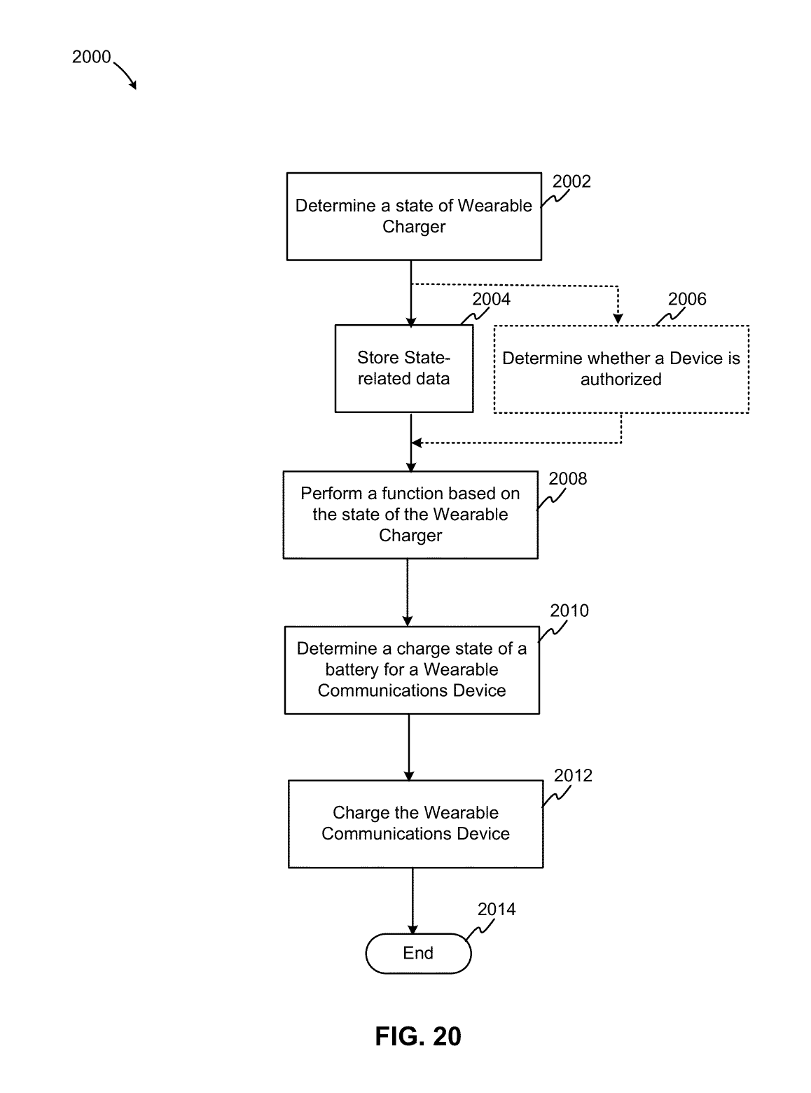

FIG. 20 is an example of a flow for a wearable charger, according to some embodiments. Flow diagram 2000 is initiated at 2002, at which a state of a wearable charger is determined (e.g., open state, nested state, etc.). State related data is stored at 2004. Optionally, at 2006, a determination is made whether a device is authorized. Upon determining valid authorization, a wearable charger can proceed with interacting with a device coupled to a translatable coupler. 2008, a function based on the state of a wearable charger can be performed, such as charging a wearable communication device. At 2010, a charge state is determined for a battery in a wearable communication device. At 2012 the wearable communication device undergoes the charging sequence. Flow 2000 terminates at 2014.

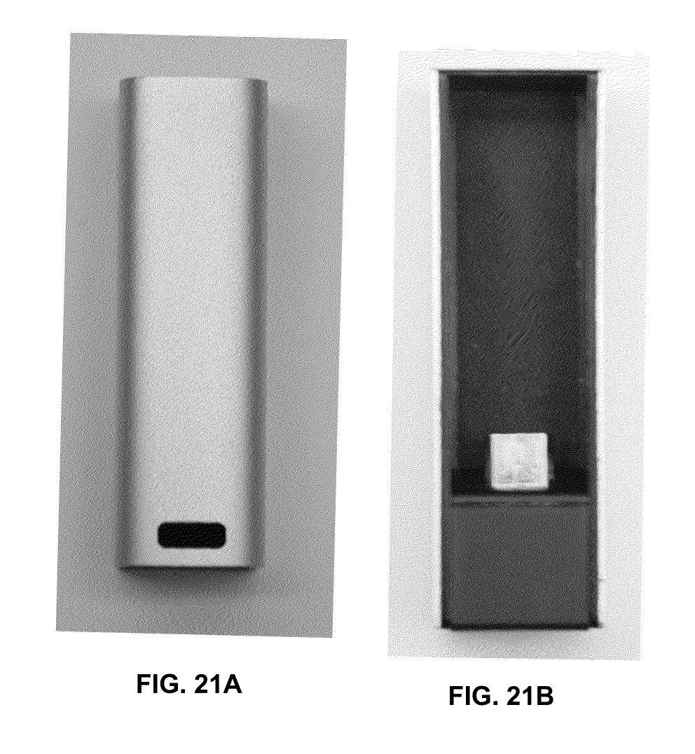

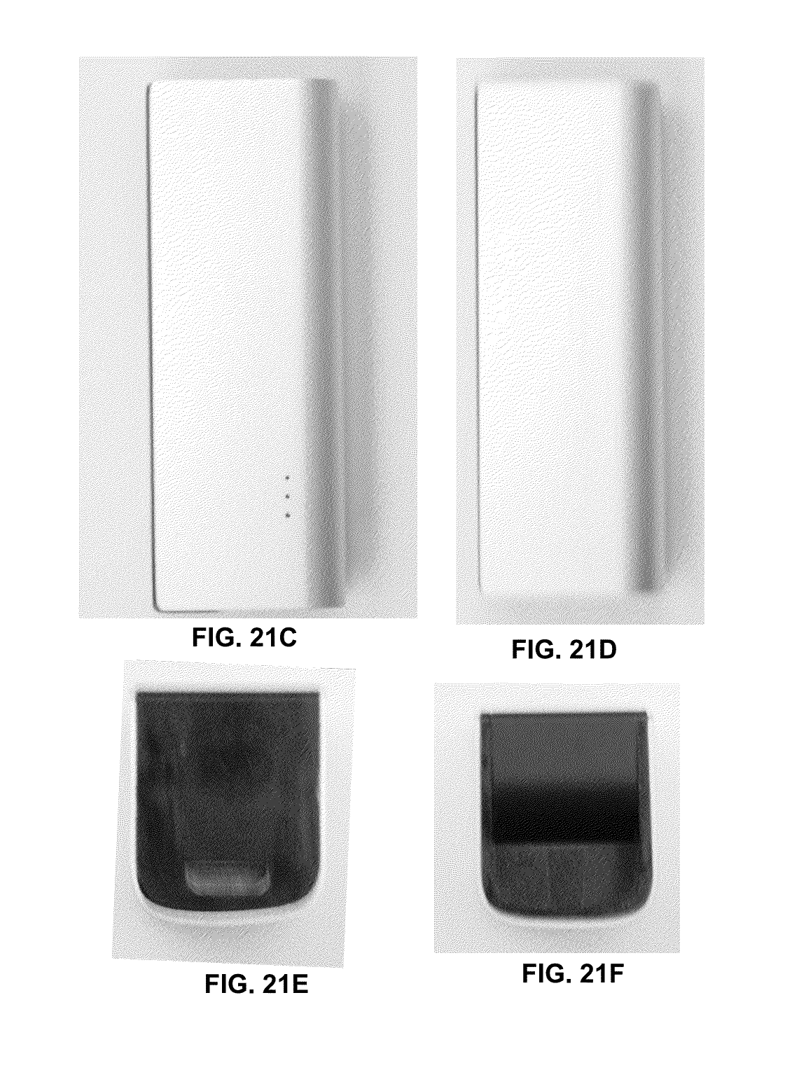

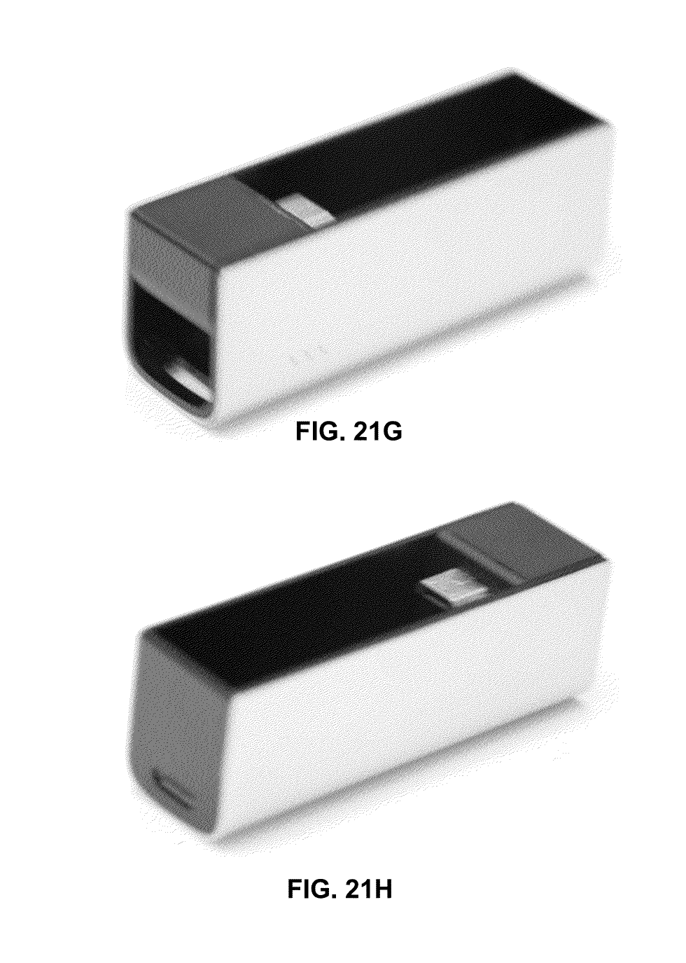

FIGS. 21A to 21H depict examples of a wearable charger in an closed state in a front view, a rear view, a first side view, a second side view, a top view, a bottom view, a first perspective view, and a second perspective view, respectively.

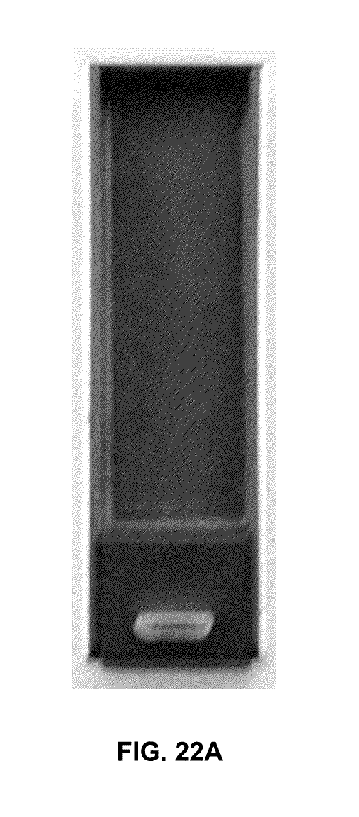

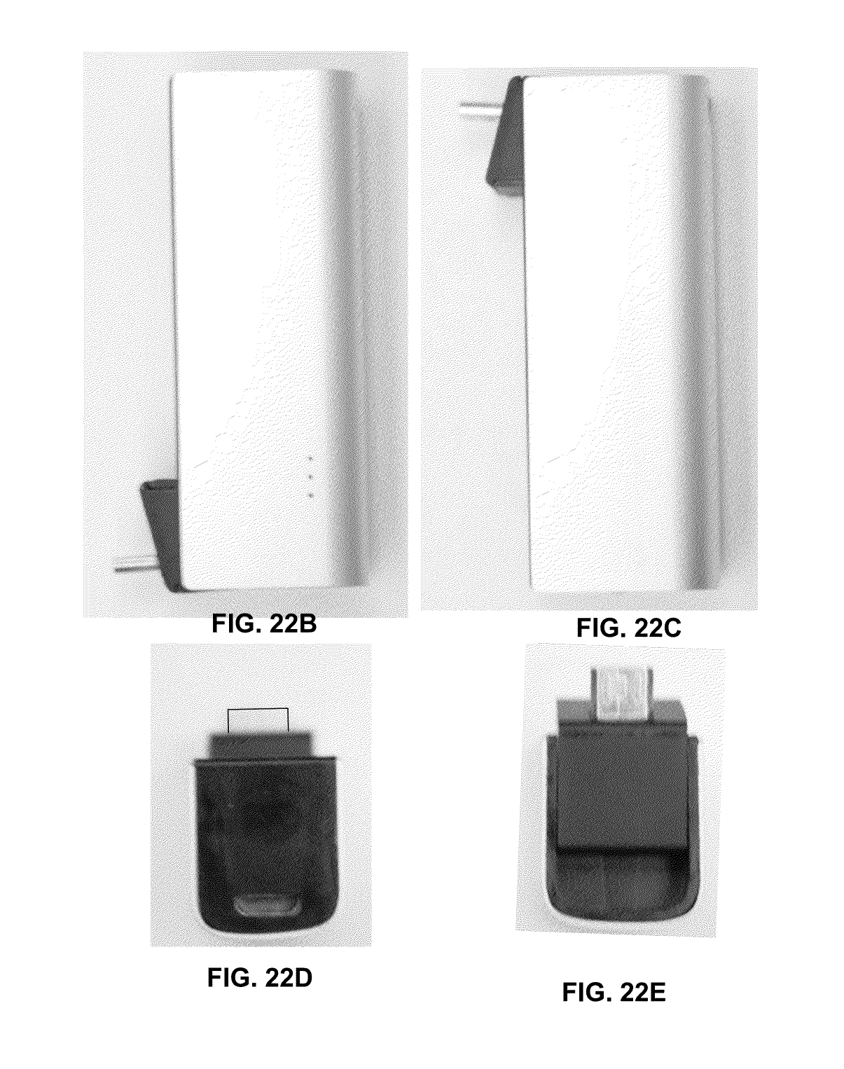

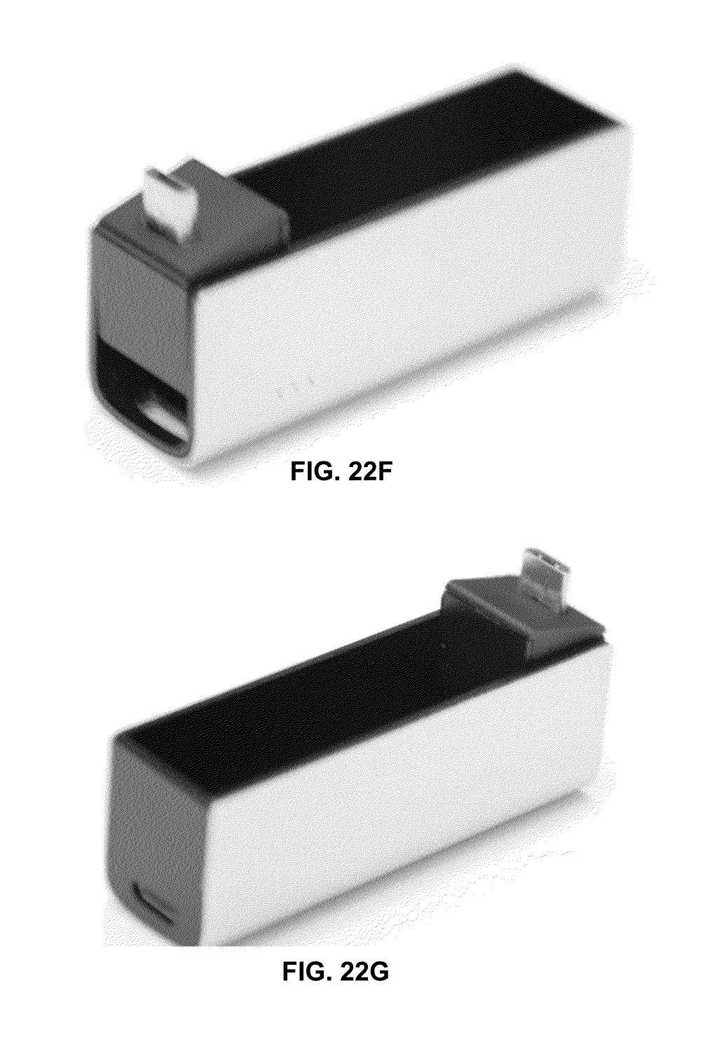

FIGS. 22A to 22G depict examples of a wearable charger in an open state in a rear view, a first side view, a second side view, a top view, a bottom view, a first perspective view, and a second perspective view, respectively.

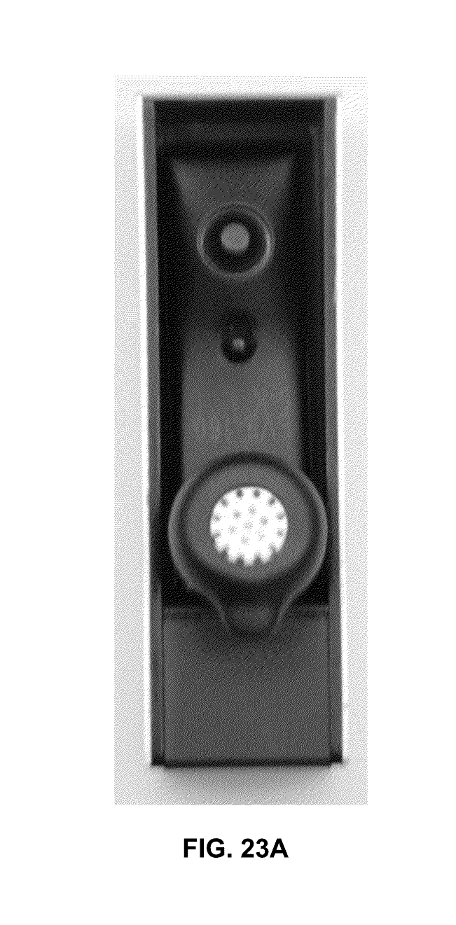

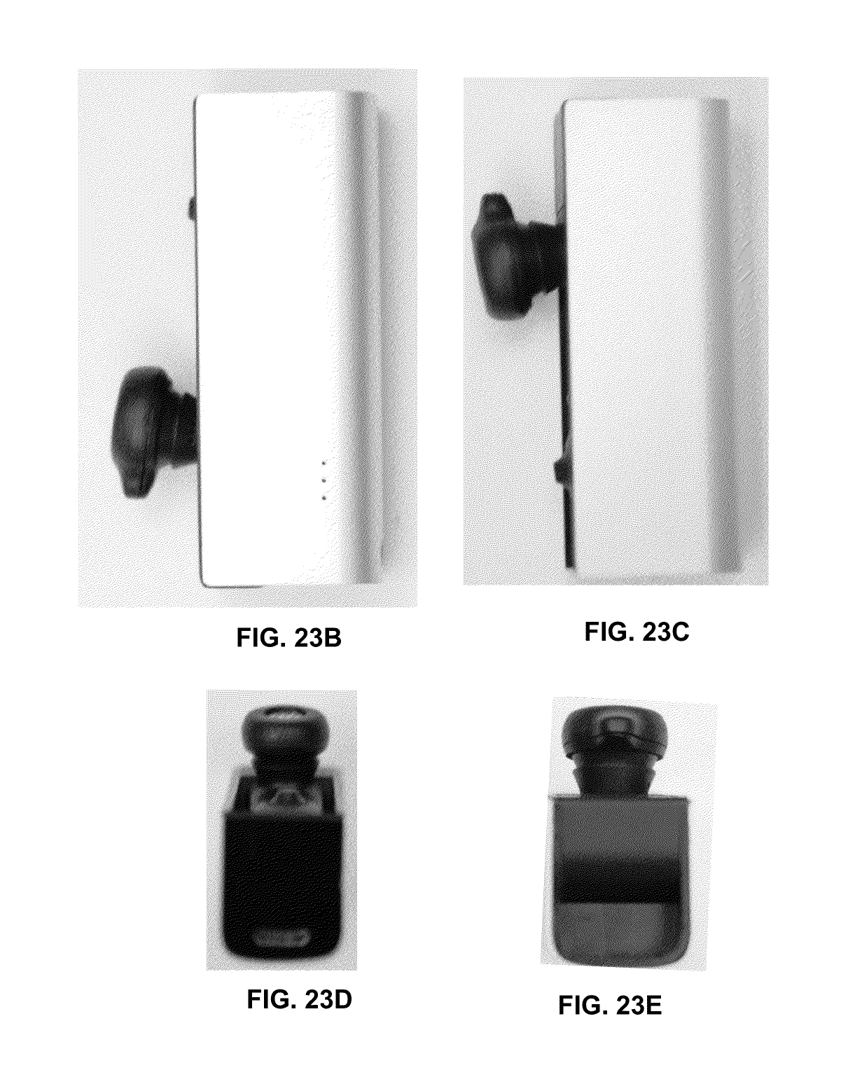

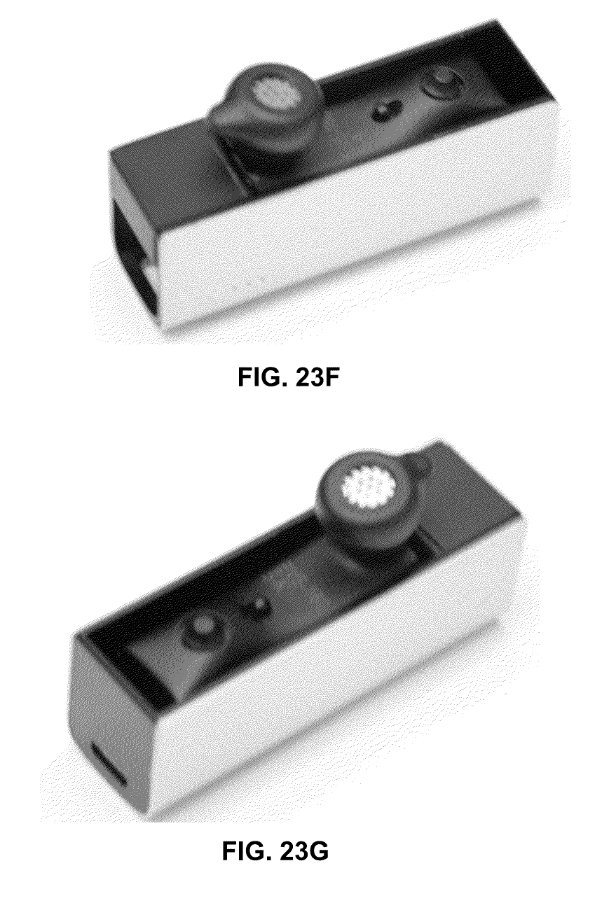

FIGS. 23A to 23G depict examples of a wearable charger in a nested state in a rear view, a first side view, a second side view, a top view, a bottom view, a first perspective view, and a second perspective view, respectively.

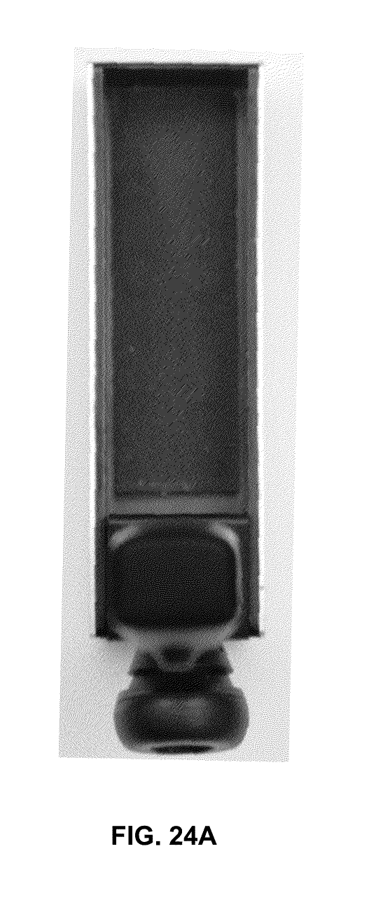

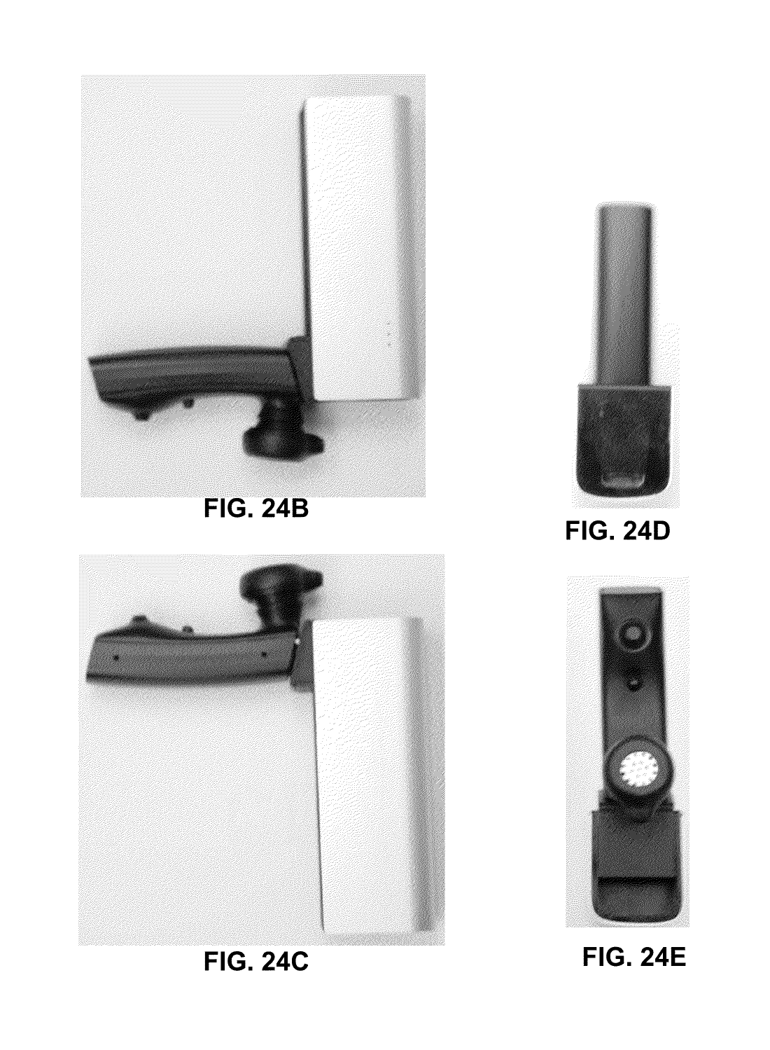

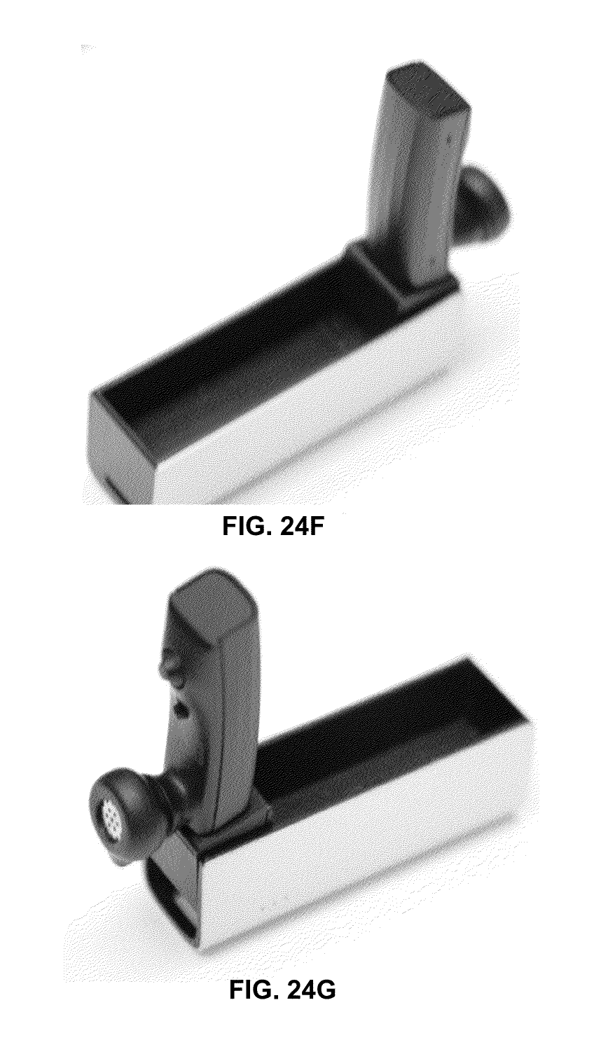

FIGS. 24A to 24G depict examples of a wearable charger in an extended state in a rear view, a first side view, a second side view, a top view, a bottom view, a first perspective view, and a second perspective view, respectively.

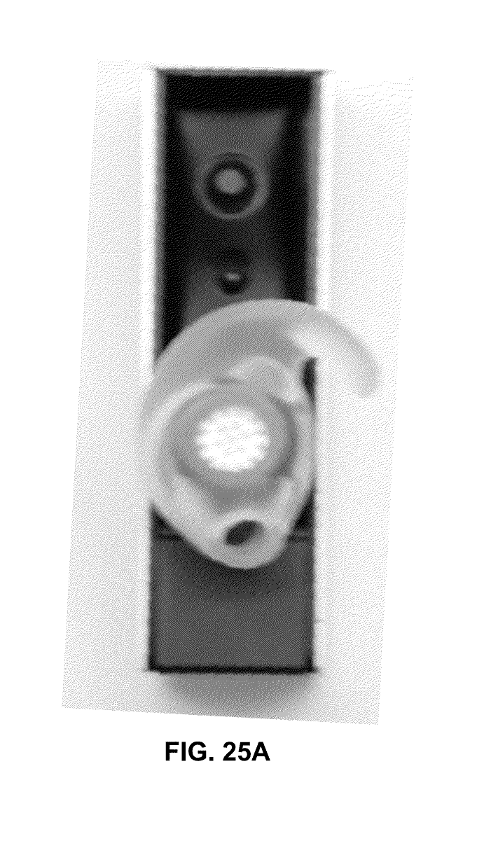

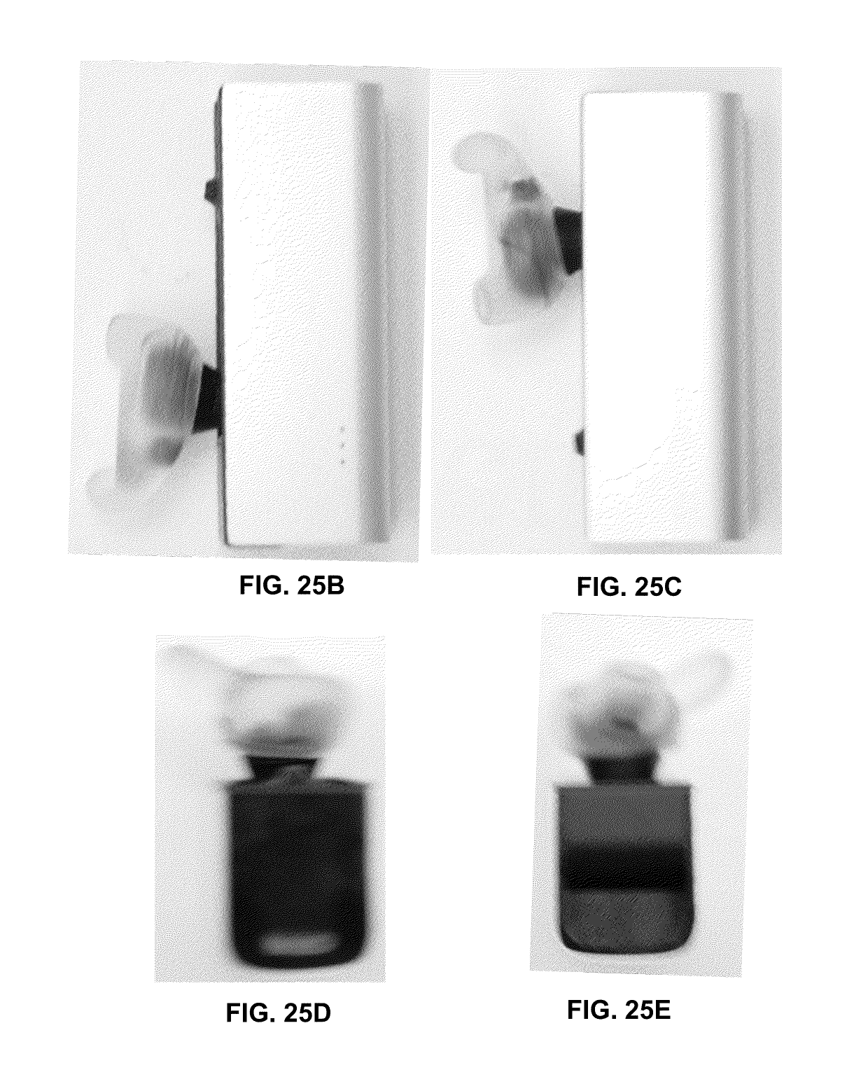

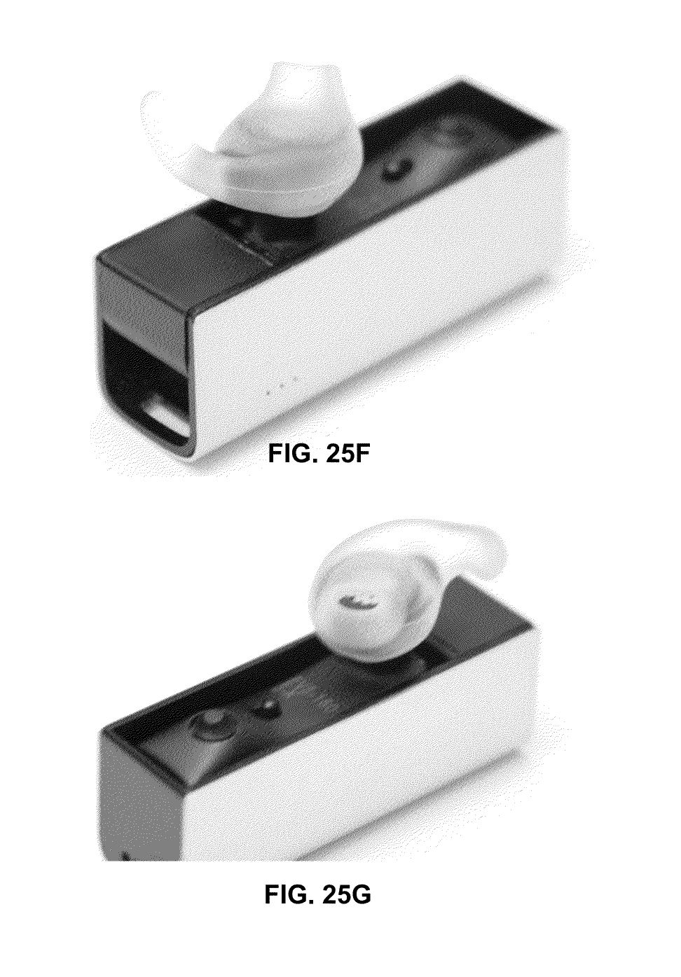

FIGS. 25A to 25G depict examples of a wearable charger in a nested state with an earbud in a rear view, a first side view, a second side view, a top view, a bottom view, a first perspective view, and a second perspective view, respectively.

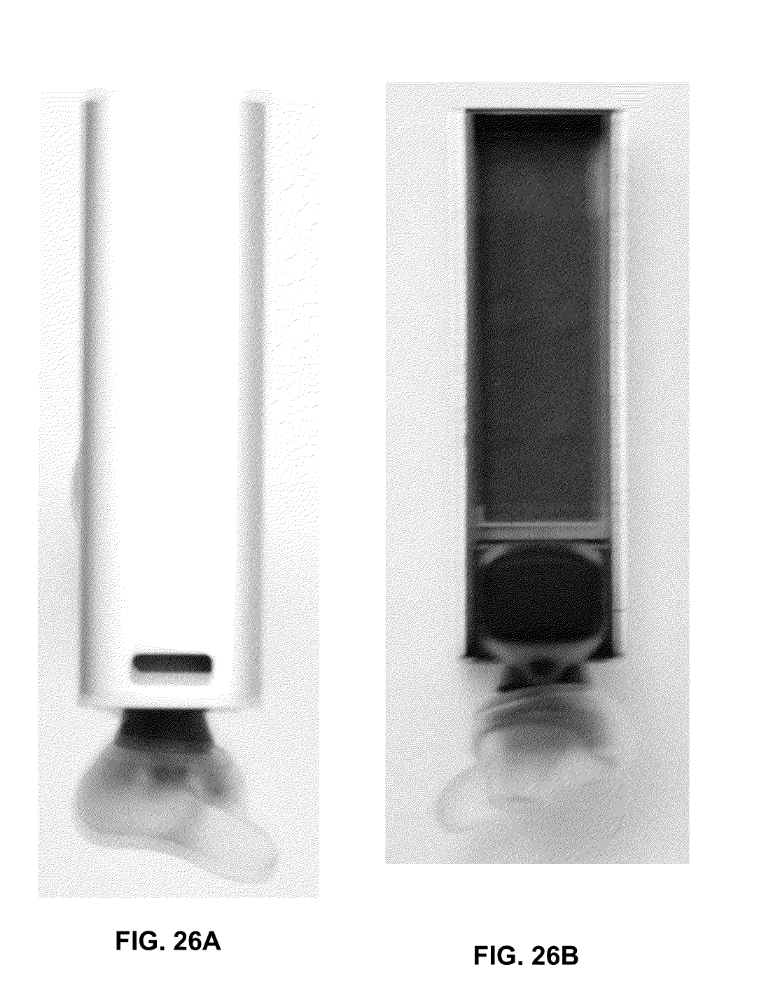

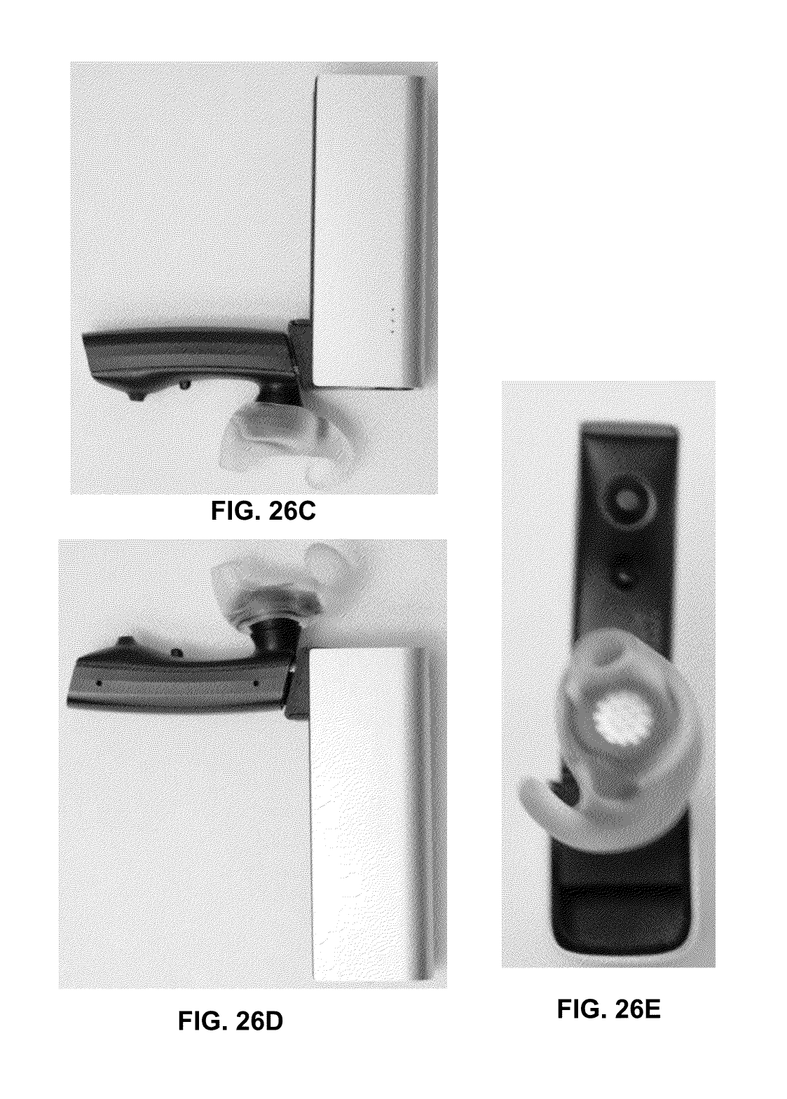

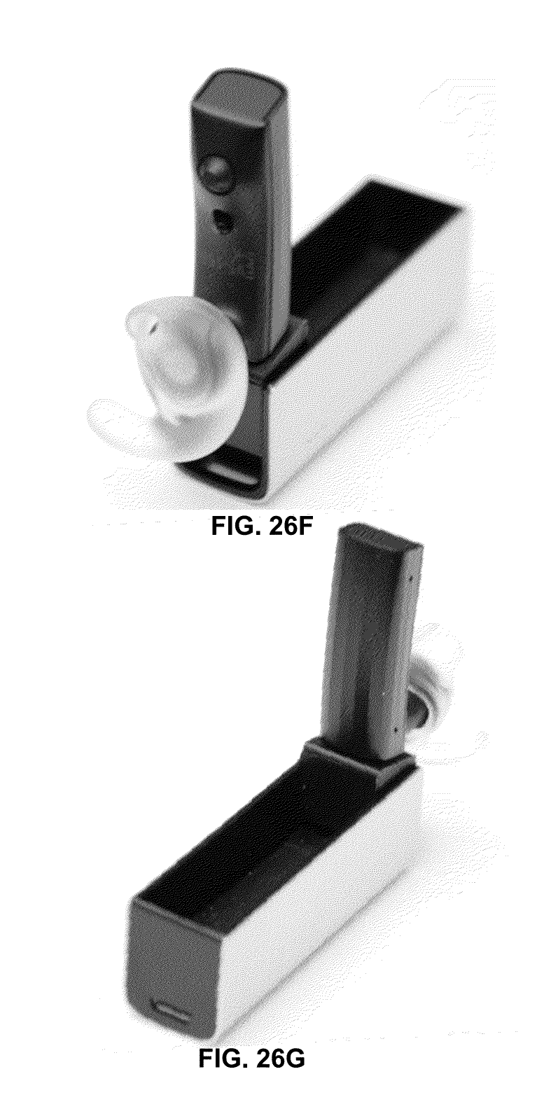

FIGS. 26A to 26G depict examples of a wearable charger in an extended state with an earbud in a front view, a rear view, a first side view, a second side view, a bottom view, a first perspective view, and a second perspective view, respectively.

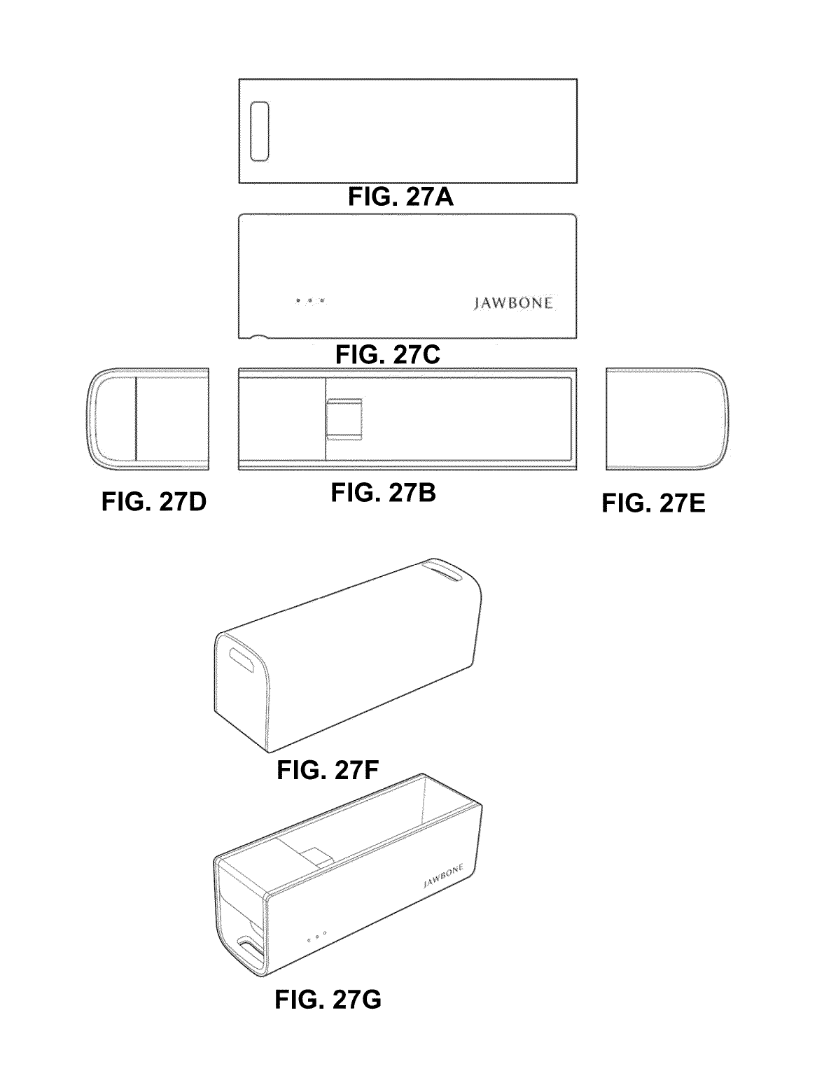

FIGS. 27A to 27G depict examples of a wearable charger in a closed state in a front view, a rear view, a side view, a bottom view, a top view, a first perspective view, and a second perspective view, respectively.

FIG. 28 depicts an example of an attachment member configured to attach a wearable charger to a user, according to some examples. Diagram 2800 shows an attachment member 2810 being configured to accept a strap 2804 or any other member through a hole to thereby couple wearable charger 2802 to a user. Attachment member 2810 can vary in structure and/or functionality in other implementations in accordance with other embodiments.

FIG. 29 depicts one example of the wearable communications device (e.g., a wireless media device hereinafter 101 having inputs and outputs. Examples of inputs include but are not limited to a plurality of microphones 120a and 120b that may be configured in a microphone array 150. The microphone array 150 may be mounted to a substrate 2998 (shown in dashed line) such as a printed circuit board or flexible printed circuit board, for example. Microphones 120a and 120b may be spaced apart from each other by a distance 2950d and may be positioned proximate apertures 112a and 112b respectively in a housing 2999 of the media device 101. Apertures 112a and 112b may provide an opening to an environment external to the housing 2999 so that sound produced in the environment may be received by microphones 120a and 120b. Media device may also include inputs generated by a vibration sensor 130 that generates a signal responsive to mechanical vibrations 2932 coupled with a receiving surface 2931 of the vibration sensor 130. Sensor 130 may further include a flexible cover 2933 (e.g., a flexible membrane) that may optionally be optically transparent to light 2934 generated by an indicator light such as a LED or the like positioned in an interior portion of housing 2999. Flexible cover 2933 may serve as an optical light guide or light pipe that optically channels light from the indicator light to the cover 2933 so that the light may be visually perceived by a user of the media device 101. Cover 2933 may further be configured to allow mechanical energy coupled with the receiving surface 2931 to be transmitted (e.g., via a mechanical coupling such as a rod) to a vibration sensing element positioned in the interior of housing 2999 (e.g., a MEMS microphone or MEMS sensor mounted to substrate 2998). A switch 2909 may also be an input and may be used to cycle power to the media device (e.g., turn it on or off). Switch 2909 or another switch or button (not shown) may be used to pair or otherwise wirelessly link the media device 101 with another wireless communication device, such as a smartphone or in-car navigation system, or the like. Vibration sensor 130 may be implemented as a skin surface microphone (SSM) that generates a signal indicative of mechanical vibrations 2932 coupled with receiving surface 2931 by skin born vibrations in the skin of user that are generated by speech of the user.

Media device 101 may further include a processor 2920 depicted in dashed line that is positioned in the interior of housing 2999 (e.g., mounted to substrate 2998). Processor 2920 may be a highly integrated processor (e.g., an IC) comprised of a plurality of electrical hardware systems implemented as a controller, a processor, a digital signal processor (DSP), a system on chip (SoC), a microprocessor (μP), a microcontroller (μC), an application specific integrated circuit (ASIC), a field programmable gate array (FPGA), just to name a few. The aforementioned IC's may include a single core or multiple cores (e.g., multi-core). For purposes of explanation, assume processor 2920 comprises a SoC that may include one or more radios (e.g., IEEE 802.11, Near Field Communication (NFC), Bluetooth (BT), or Bluetooth low energy (BTLE)). Here at least one of the radios may receive a RF signal 2941 from another wireless device (e.g., a smartphone) and that RF signal 2941 may be processed by the radio and outputted as an input signal to an amplifier circuit for a speaker 2904 that generates sound 2905. The sound 2905 may be the voice content of a phone call, turn-by-turn voice instructions from a GPS system, or streaming music, for example. An earpiece (102, 105) may be used to couple media device 101 with an ear of a user (not shown) so that sound 2905 generate by speaker 2904 is acoustically coupled into the user's ear canal. A user wearing the media device 101 may have a portion of the user's face in contact with the receiving surface 2931 of vibration detector 130 and mechanical energy (e.g., vibrations) from speech 2906 by the user may be converted to a signal that is an input to media device 101 and processed by circuitry, algorithms, or both for voice activation detection (VAD) or other purpose. Speech 2906 by user as well as other non-speech sound 2907 that are picked up by microphones 120a and 120b may be processed to reduce noise and improve audio fidelity of the user speech 2907 that is transmitted 2943 as an output from media device 101 as a RF signal from the one or more radios. Indicator light 2934 may also be an output from media device 101 and may serve multiple functions such as paring status, operational status, state of a rechargeable battery, charging status of the rechargeable battery, an incoming phone call or audio content, just to name a few.

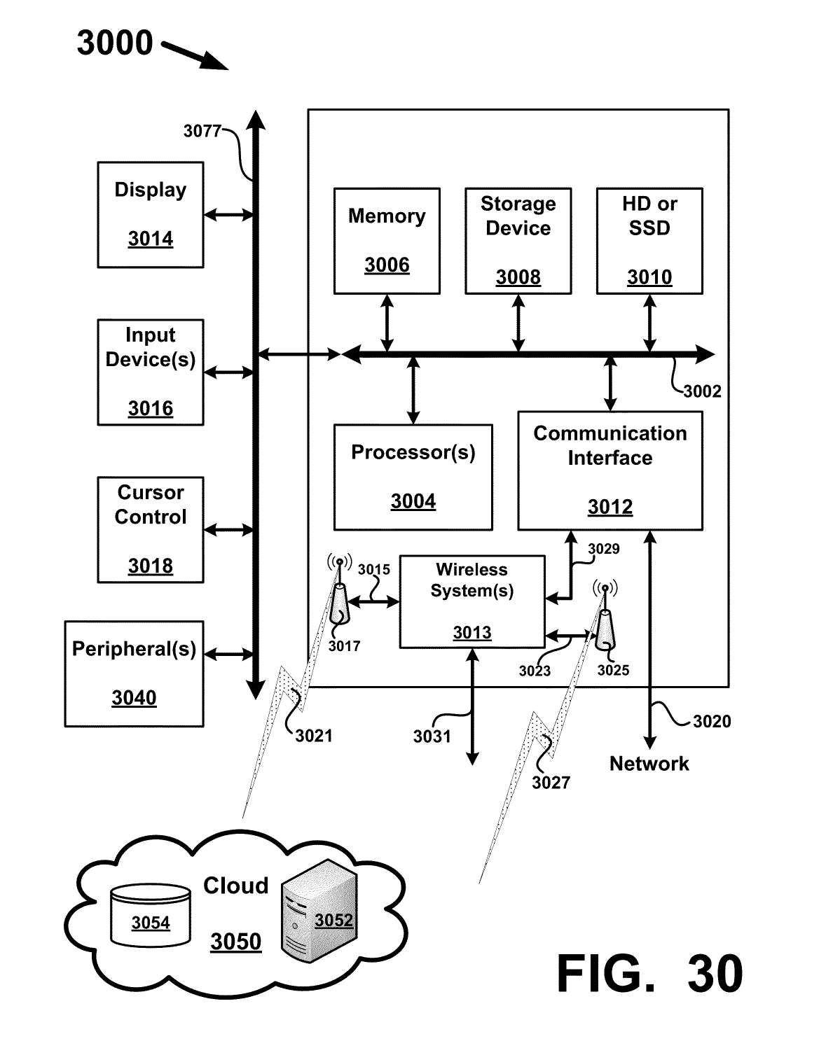

FIG. 30 depicts an exemplary computer system 3000 suitable for use in the systems, methods, and apparatus described herein. In some examples, computer system 3000 may be used to implement circuitry, computer programs, applications (e.g., APP's), configurations (e.g., CFG's), methods, processes, or other hardware and/or software to perform the above-described techniques. Computer system 3000 includes a bus 3002 or other communication mechanism for communicating information, which interconnects subsystems and devices, such as one or more processors 3004, system memory 3006 (e.g., RAM, SRAM, DRAM, Flash), storage device 3008 (e.g., Flash, ROM), disk drive 3010 (e.g., magnetic, optical, solid state), communication interface 3012 (e.g., modem, Ethernet, WiFi, Bluetooth, Ad Hoc WiFi, HackRF, USB-powered software-defined radio (SDR), etc.), display 3014 (e.g., CRT, LCD, touch screen), one or more input devices 3016 (e.g., keyboard, stylus, touch screen display), cursor control 3018 (e.g., mouse, trackball, stylus), one or more peripherals 3040. Some of the elements depicted in computer system 3000 may be optional, such as elements 3014-3018 and 3040, for example and computer system 3000 need not include all of the elements depicted. A bus 3077 may couple other systems as shown with bus 3002.

According to some examples, computer system 3000 performs specific operations by processor 3004 executing one or more sequences of one or more instructions stored in system memory 3006. Such instructions may be read into system memory 3006 from another non-transitory computer readable medium, such as storage device 3008 or disk drive 3010 (e.g., a HD or SSD). In some examples, circuitry may be used in place of or in combination with software instructions for implementation. The term “non-transitory computer readable medium” refers to any tangible medium that participates in providing instructions to processor 3004 for execution. Such a medium may take many forms, including but not limited to, non-volatile media and volatile media. Non-volatile media includes, for example, optical, magnetic, or solid state disks, such as disk drive 3010. Volatile media includes dynamic memory, such as system memory 3006. Common forms of non-transitory computer readable media includes, for example, floppy disk, flexible disk, hard disk, SSD, magnetic tape, any other magnetic medium, CD-ROM, DVD-ROM, Blu-Ray ROM, USB thumb drive, SD Card, any other optical medium, punch cards, paper tape, any other physical medium with patterns of holes, RAM, PROM, EPROM, FLASH-EPROM, any other memory chip or cartridge, or any other medium from which a computer may read.

Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 3002 for transmitting a computer data signal. In some examples, execution of the sequences of instructions may be performed by a single computer system 3000. According to some examples, two or more computer systems 3000 coupled by communication link 3020 (e.g., NFC, BTLE, LAN, Ethernet, PSTN, wireless network (e.g., WiFi, IEEE 802.11), Bluetooth (BT), or other wireless protocols) may perform the sequence of instructions in coordination with one another. Computer system 3000 may transmit and receive messages, data, and instructions, including programs, (i.e., application code), through communication link 3020 and communication interface 3012. Received program code may be executed by processor 3004 as it is received, and/or stored in a drive unit 3010 (e.g., a SSD or HD) or other non-volatile storage for later execution. Computer system 3000 may optionally include one or more wireless systems 3013 in communication 3029 with the communication interface 3012 and coupled (3015, 3023) with one or more antennas (3017, 3025) for receiving and/or transmitting RF signals (3021, 3027), such as from a WiFi network, Ad Hoc WiFi, HackRF, USB-powered software-defined radio (SDR), BT radio, device 101, or other wireless network and/or wireless devices, for example. Wireless systems 3013 may also be in communication 3031 with one or more external systems. Examples of wireless devices include but are not limited to: a data capable strap band, wristband, wristwatch, digital watch, or wireless activity monitoring and reporting device; a wireless headset, wireless headphones, a smartphone; cellular phone; tablet; tablet computer; pad device (e.g., an iPad); touch screen device; touch screen computer; laptop computer; personal computer; server; personal digital assistant (PDA); portable gaming device; a mobile electronic device; and a wireless media device, just to name a few. Computer system 3000 in part or whole may be used to implement one or more systems, devices, or methods that communicate with device 101 via RF signals or a hard wired connection (e.g., a USB port, TRS plug, TRRS plug, or the like). For example, a radio (e.g., a RF receiver) in wireless system(s) 3013 may receive transmitted RF signals (e.g., Tx 2943) from device 101 that include one or more signals or other data, such as a voice signal, for example. As another example, a transceiver (e.g., 3017, 3025) in wireless system 3013 may transmit a RF signal (e.g., a voice conversation from a phone call made from a smartphone) and that RF signal may be received by a radio in media device 101 as Rx 2941. Computer system 3000 in part or whole may be used to implement a remote server or other compute engine in communication with systems, devices, smartphone, tablet, pad, PDA, media devices, or method for use with the device 101 as described herein. Computer system 3000 in part or whole may be included in a portable device such as a wireless media device, wireless headset, smartphone, tablet, gaming device, or pad, just to name a few. Computer system 3000 may be in communication (3021, 3027, 3020) with an external resource such as Cloud 3050 (e.g., the Internet, website, web page, etc.) which may include data storage 3054 (e.g., RAID or NAS) and compute engine 3052 (e.g., a server) resources that may be accessed by computer system 3000.

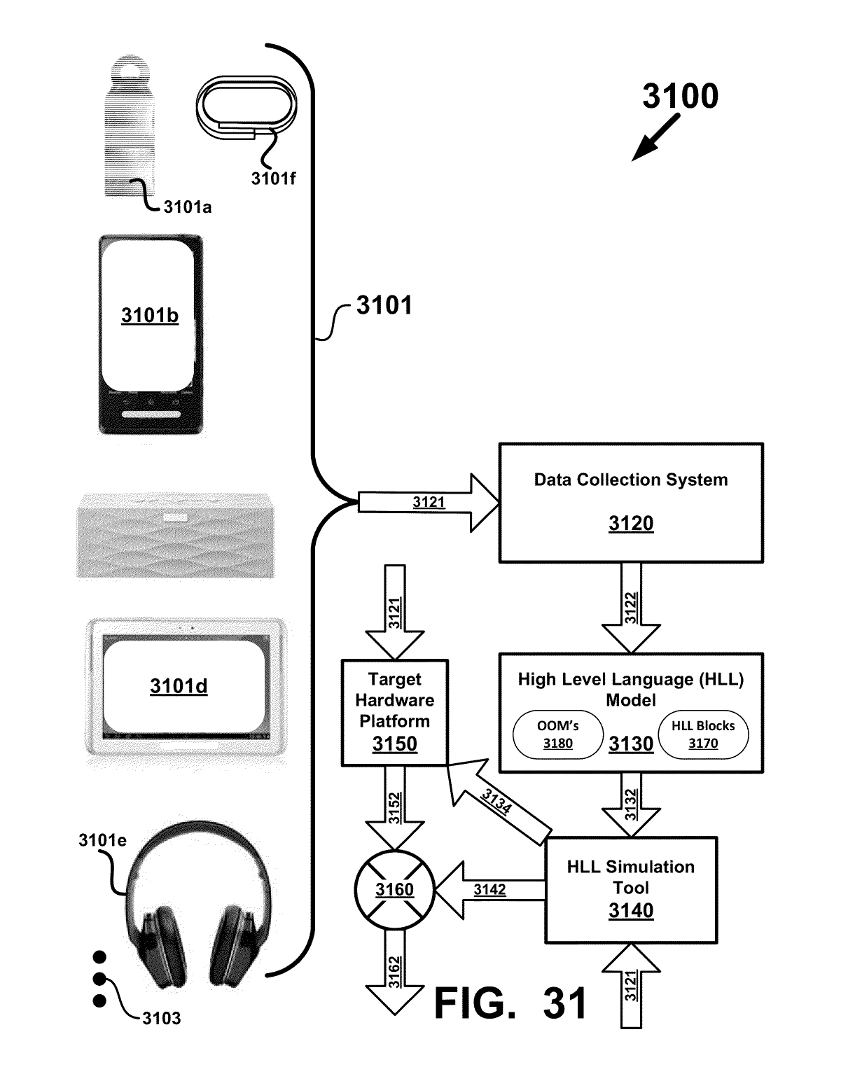

Moving on now to FIG. 31 where one example of a block diagram 3100 for capturing signals 3121 from a plurality of wireless devices 3101 into a data collection system 3120 for high level language modeling and simulation in a platform framework are depicted. The plurality of wireless devices 3101 may include but are not limited to a wireless headset 3101a, a smartphone 3101b, a wireless media device 3101c (e.g., a WiFi and/or Bluetooth wireless audio device), a tablet or pad 3101d, a wireless head phone 3101e, and a data capable strapband or smart watch 3101f. The plurality of wireless devices 3101 depicted are non-limiting examples that are depicted to show a broad range of wireless devices that may be designed, simulated, verified, etc. using the platform framework described herein. There may be more or fewer wireless devices 3101 than depicted, as denoted by 3103.

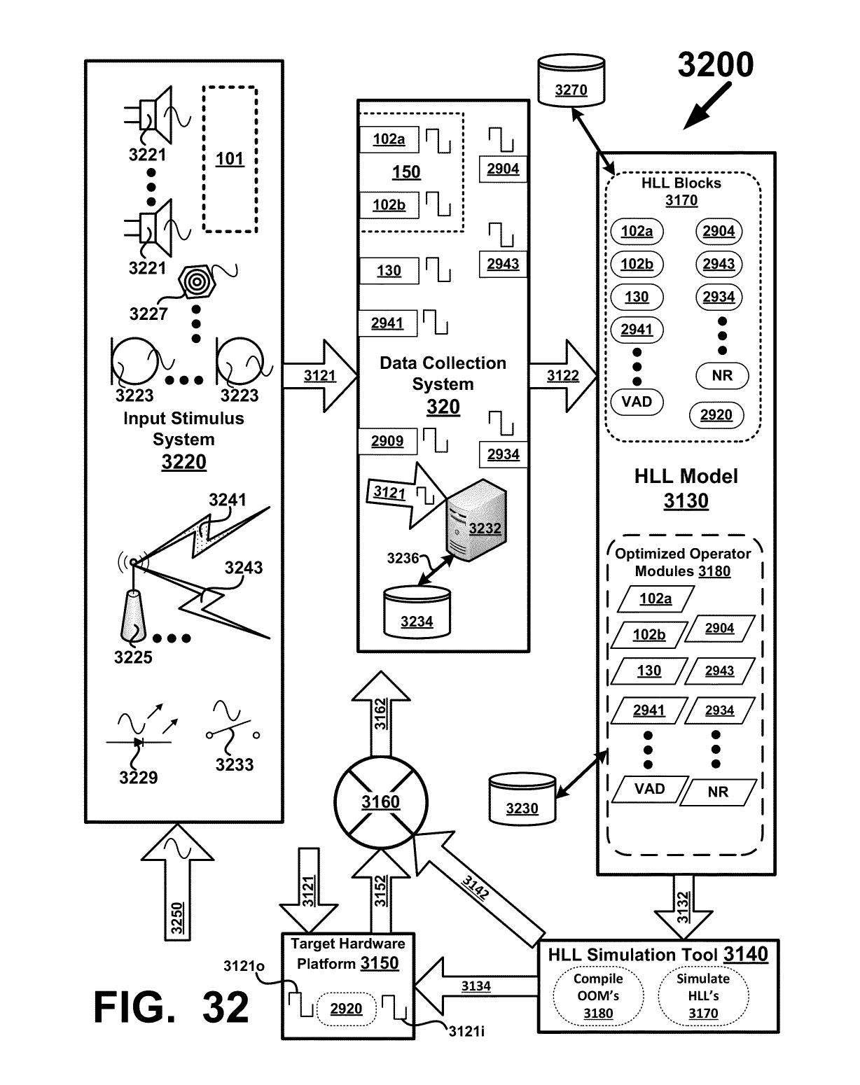

As will be depicted in greater detail in FIG. 32, input and/or output signals from a wireless device are captured 3121 and stored in a data collection system 3120. The capture may occur by applying the necessary stimulus signals such as sound, voice, RF signals, vibration, or others and then capturing the inputs and the outputs produced. For example, if one of the inputs comprises a RF signal carrying voice data from a phone conversation being communicated to media device 3101a, then the RF signal received comprises an input (e.g., 2941) and that input is processed to produce a voice on a speaker of media device 3101a. The signal (e.g., from an audio amplifier) that generates the sound is an output and the signal that caused the sound to be generated is an input, and both are captured and comprise 3121.

Data Collection system 3120 stores the captured signals 3121 for later use during simulation in a high-level language (HLL) simulation tool 3140. Data collection system may include hardware, software or both for processing, analyzing, storing, and accessing captured signals 3121. As one example, captured signals 3121 may comprises signals that are in the analog domain, digital domain, or both. Analog domain signals may be process by an analog-to-digital-converter (ADC) for storage as digital domain data in a digital format (e.g., in memory). Captured signals 3121 may comprise signals formatted as test vectors that are applied to a device under test (DUT) being simulated by HLL simulation tool 3140. Here, the DUT may comprise a HLL model 3130 of a wireless media device 3101 as described above. The HLL model 3130 may include a plurality of interconnected HLL blocks 3170 that implement different functions within the media device 3101 to be simulated and verified. Further, HLL model 3130 may include optimized operator modules (OOM's) 3180 that may comprise coded descriptions of corresponding HLL blocks 3170. The OOM's 3180 may be coded in a language determined by a target hardware platform 3150 (e.g., target language or firmware) and the coding may be at a lower level of granularity including but not limited to assembly language, machine language, or other, etc.

Output 3132 from the HLL model 3180 may include a net list or other data structure that describes the connections between inputs and output of the various HLL blocks 3170 and their corresponding OOM's 3180. HLL simulation tool 3140 may compile the HLL blocks 3170 into an executable simulation model that runs on the HLL simulation tool 3140 and generates simulated outputs 3142 which may represent a response of the simulated media device 3101 to its various captured 3121 inputs and outputs. Moreover, the OOM's 3180 may be compiled at the same time or a different time as the HLL blocks 3170. In some applications HLL simulation tool 3140 compiles the OOM's 3180 and outputs an executable object 3134 that may be read into memory of a target hardware platform 3150 (e.g., a DSP or SoC). In other examples, executable object 3134 may be read into memory of a software application that emulates the target hardware platform 3150. Captured signals 3121 are also applied to the various pin outs of the target hardware platform 3150 and the resulting outputs 3152 or other stimulus are compared 3160 with the simulated outputs 3142. Comparison 3160 may serve to determine whether or not the HLL model 3130 of the media device 3101 meets a design criteria for the media device 3101. The process may be revised, tweaked, adjusted, corrected or otherwise by editing or otherwise changing one or more of the HLL blocks 3170 and its corresponding OOM module 3180. As one example, if one of the HLL blocks 3170 implements a finite impulse response (FIR) filter and the simulated outputs 3142 show that the FIR filter performs as expected, but the resulting outputs 3152 from the target hardware platform 3150 show that the hardware (e.g., DSP or SoC) does not perform as expected. To that end, the OOM's 3180 associated with implementing the FIR filter in hardware may be revised (e.g., a change in filter coefficients); the OOM's 3180 recompiled and the results after the revision may once again be compared 3160. Similarly, if one or more blocks 3170 in the HLL blocks 3170 are not performing as expected, those blocks 3170 may be revised, and in some applications, the OOM's 3180 that correspond to the non-performing HLL blocks 3170 may also be revised. OOM's 3180 may be included in a library (e.g., see 3230 below) of modules that may include custom OOM's, generic OOM's, standard OOM's, etc. For example, the library may contain a standard OOM 3180 for the above mentioned FIR filter, a fast Fourier transform (FFT), an adaptive filter, infinite impulse response (IIR) filter, just to name a few.

Reference is now made to FIG. 32 where one example of a more detailed block diagram 3200 for capturing signals 3121 from a wireless device into a data collection system 3120 for high level language modeling and simulation in a platform framework are depicted. For purposes of explanation, the wireless media device 101, depicted in dashed line, will be used as an example wireless media device in conjunction with the description of FIG. 32 although the description of FIG. 32 is not limited to the wireless media device 101 and other types of wireless media devices such as device 3101 of FIG. 31 or others may be used. In FIG. 32 an input stimulus system 3220 receives a plurality of signals 3250 that may be used to stimulate the various inputs, outputs, and functionality of wireless media device 101. Input stimulus system 3220 may include any systems necessary to simulate, emulate, or operate as an equivalent system in media device 101. System in input stimulus system 3220 may include but are not limited one or more speakers 3221 which may be coupled with signals from an amplifier (not shown), one or more microphones 3223 (e.g., omni-directional or other pattern) which may be coupled with a pre-amplifier or other circuitry (not shown), one or more vibration sensors 3227 which may be coupled with a vibration force (not shown), one or more RF systems 3225 (e.g., radios, receivers, transmitters, transceivers, antennas, etc.), one or more opto-electronic devices 3229, and one or more switches 3233. Media device 101 may not be the actual media device 101 as depicted in FIG. 29, but rather may be a prototype or a bread boarded model or may be a mechanical jig or structure (e.g., housing 2999) sans some of the components (e.g., processor 2920) for example. Systems depicted in input stimulus system 3220 may be configured to mimic similar systems in the media device 101, such as microphones 3223 operative to mimic MIC 1 120a and MIC 2 120b of microphone array 150. Microphones 3223 may be spaced apart by distance 2950d and positioned in a structure similar to housing 2999 and having apertures like 112a and 112b. Vibration detector 130 may be mimicked by vibration sensor 3227. Switch 2909 may be mimicked by switch 3233 and indicator light 2934 (e.g., beneath cover 2933) may be mimicked by opto-electronic device 3229. Further, RF signals transmitted 2943 and received 2941 by media device 101 (e.g., via processor 2920) may be mimicked by RF system 3225 (e.g., by Tx 3241 and Rx 3243).

The following is just one example of how input stimulus system 3220 may operate to generate captures signals 3121 for the data collection system 3120. A plurality of stimulus signals 3250 may be coupled with the components of input stimulus system 3220. Those signals are depicted as sine waves only for purposes of explanation as non-limiting examples of the type of signal waveforms (e.g., analog, digital) that may be applied to the components depicted. Now, a input signal applied to one of the speakers 3221 may be used for the speaker 2904 to generate the sound 2905 that may be captured by one of the microphones 3223 and output as a signal on 3121. That input signal may represent the audio information received over Rx 2941 from a person on the other end of a telephone call or other communication with a user of media device 101. The received RF signal that comprises Rx 2941 may be another one of the input signals that is generated by RF 3225 as Tx 3241. For purposes of analyzing the effects of environmental noises such as wind, ambient noise (e.g., highway traffic, airplanes, etc.), and crowd noise, one or more of the speakers 3221 may be coupled with input signals of such environmental noises to test noise reduction systems or the like that will be incorporated into media device 101. Two of the microphones 3223 will pick up the environmental noises and their signals will be output as signals on 3121. Another speaker 3221 or some other type of transducer may receive a signal that drives the speaker/transducer to produce a mechanical vibration that is coupled with vibration sensor 3227 to simulate skin born mechanical vibrations from speech of the user of device 101 that are coupled with receiving surface 2931 of vibration detector 130 of FIG. 29 for use in a voice activity detection (VAD) algorithm, echo cancellation or reduction algorithm or other purpose. The same two microphones 3223 may be used to pick up the speech of the user as output by one of the speakers 3221 and signals from that speech are included in 3121 and may be used by one of the RF systems 3225 to transmit a RF signal that includes the speech. Signals indicative of the charging status, paring status, or other may be included in 3250 and applied to opto-electronic device 3229 and output as one of the signals on 3121. A signal indicative of switch 3233 being actuated (e.g., opened or closed) may include in 3250 and output on 3121. In some examples, the signals on 3250 may not be coupled with actual components in input stimulus system 3220.

Data collection system 3120 receives the captured signals 3121 which may comprise electronic representations of input signals, output signals, RF signals, or other. Here, for purposes of explanation, a square wave signal is used to depict captured signals in 3121 that correspond to various systems in media device 101; however, the actual signal waveforms will be application dependent and are not limited by the exampled depicted. Accordingly, data collection system 3120 receives captured signals 3121 for microphone array 150 (e.g., 102a and 120b), vibration detector 130, Rx 2941, switch 2909, speaker 2904, Tx 2943, and indicator light 2934. Captured signals 3121 may be processed, analyzed, conditioned or otherwise manipulated in data collection system 3120 using a processor 3232 (e.g., a PC or server) and may be stored in a data storage system 3234 (e.g., a HDD, SSD, NAS, Flash memory, etc.) that is in communication 3236 with processor 3232. Processor 3232 and/or data storage 3234 may be external to data collection system 3120 (e.g., in Cloud 3050).

High-Level Language Model (HLL) 3130 includes a plurality of HLL blocks 3170 having inputs and outputs that are interconnected in HLL model 3130 to implement a functionality of the wireless media device 101 at some level of abstraction, such as at the block level. The interconnection may be accomplished using a net list, schematic, wiring diagram, PC board diagram, hardware description language (HDL), or some other system that describes how inputs and outputs of the HLL blocks 3170 are connected with one another to implement the interconnection of components that comprise the wireless media device 101.

HLL blocks 3170 may comprise one or more blocks 3170 for one or more components of the media device 101. Example block 3170 assignments or associations may include but are not limited to HLL blocks 3170 for: microphones 102a and 102b; vibration detector 130; Rx 2941; speaker 2904; Tx 2943; indicator light 2934; and processor 2920. Additionally, algorithms and/or signal processing functions to be implemented on processor 2920 and/or other components of media device 101 may also be expressed as one or more HLL blocks 3170. Example functions/algorithms may include but are not limited to circuitry and/or algorithms for implementing a voice activity detector (VAD) (e.g., in conjunction with signals from a skin surface microphone (SSM)), a noise cancellation, suppression or removal algorithm (NR) (e.g., NoiseAssassin or the like), bass frequency boost function, equalization functions (e.g., of frequency), echo cancellation, and wind noise reduction, just to name a few. HLL blocks 3170 may be included in a library 3270. Library 3270 may include HLL blocks 3170 that may be specific to the target hardware platform 3150 or that may be generic and used for a variety of target hardware platforms 3150.

Optimized operator modules 3180 may be included in HLL model 3130 as separate entities or files that may have corresponding HLL blocks 3180. Examples of OOM's 3180 that may correspondence with HLL blocks 3170 includes but is not limited to OOM modules 3180 for: microphones 102a and 102b; vibration detector 130; Rx 2941; speaker 2904; Tx 2943; indicator light 2934; and processor 2920. Example functions/algorithms expressed in OOM's 3180 that correspond with HLL's 3170 may include but are not limited to circuitry and/or algorithms for implementing a voice activity detector (VAD), a noise cancellation algorithm (NA) (e.g., NoiseAssassin or the like), echo cancellation, and wind noise reduction, just to name a few. Each OOM 3180 may be expressed in a syntax that is specific to a target hardware platform. A compiler or other tool specific to the target hardware platform 3150 may be used to compile or otherwise process the OOM's 3180 into an executable code 3134 (e.g., machine language) that may be executed in the target hardware platform 3150. The executable code 3134 may be fixed in a non-transitory computer readable medium, such as embedded Flash memory (e.g., integrated with the circuitry of the processor 2920), Flash memory, or other form of memory (e.g., non-volatile memory). In other examples, HLL simulation tool 3140 may be used to compile or otherwise process the OOM's 3180 into executable code 3134 (e.g., machine language) that may be executed in the target hardware platform 3150. In that a plurality of target hardware platforms 3150 may be designated as a target for implementing media device 101, HLL simulation tool 3140 may have access to a library 3230 that includes OOM's 3180 for each of the plurality of target hardware platforms 3150 (e.g., from different manufacturers or different parts from the same manufacture, such as Cambridge Silicon Radio (CSR), Texas Instruments (TI), Intel, Motorola, Cirrus Logic, or other). HLL simulation tool 3140 may include a complier unique to each of the target hardware platforms 3150 to enable compilation of OOM's 3180 for the ported to target hardware platform 3150 in library 3230. Library 3230 may include OOM's 3180 modules that perform building block functions, function calls, macros, arithmetic operations, equalization functions, filtering functions, delay functions, adaptive filter functions, speech cleaning functions, cross-over frequency functions, or others that may be used to implement functionality in media device 101 and may have corresponding HLL blocks 3170.

HLL simulation tool 3140 may simulate operation of media device 101 by applying captured signals 3122 to inputs and output of an instantiation of the media device 101 (e.g., net list or schematic of HLL blocks 3170) in a memory of a compute engine such as a server, workstation, PC, laptop or other compute device. HLL simulation tool 3140 may compile OOM's 3180 into executable code 3134 that is loaded into a data storage system of the target hardware platform 3150 and executed. Captured signals 3121 may be applied inputs 3121i and outputs 31210 of the target hardware platform 3150 (e.g., to pins of its package), and the resulting hardware signals may be outputted 3152 and compared 3160 with the simulated outputs 3142 from HLL simulation tool 3140. The comparison 3160 may be used to determine how closely the HLL model 3130, the target hardware platform 3150 or both, meet a performance criterion for the wireless media device 101. The HLL blocks 3170 associated with the HLL model 3130, the OOM modules 3180 associated with the target hardware platform 3150 or both may be revised 3162 and the simulation on HLL simulation tool repeated until the performance criteria are achieved.

The revising 3162 of the OOM modules 3180 may be localized to only those modules 3180 that are suspect as being the cause of the performance criteria not being met. The suspect OOM module(s) 3180 may be edited, tweaked, replaced or otherwise corrected to achieve the performance goals. The entire body of OOM modules 3180 for the target hardware platform 3150 need not be revised and re-compilation by the HLL simulator tool 3140 or other may be simplified by not having to recompile the entire body of OOM modules 3180, because only the affected OOM's 3180 may need re-compiling (e.g., linking, loading, etc.). Suspect HLL blocks 3170 may also be revised, edited, tweaked, replaced or otherwise corrected to achieve the performance goals. Revision 3162 of suspect HLL block(s) 3170 may require revision of its corresponding OOM module 3180.

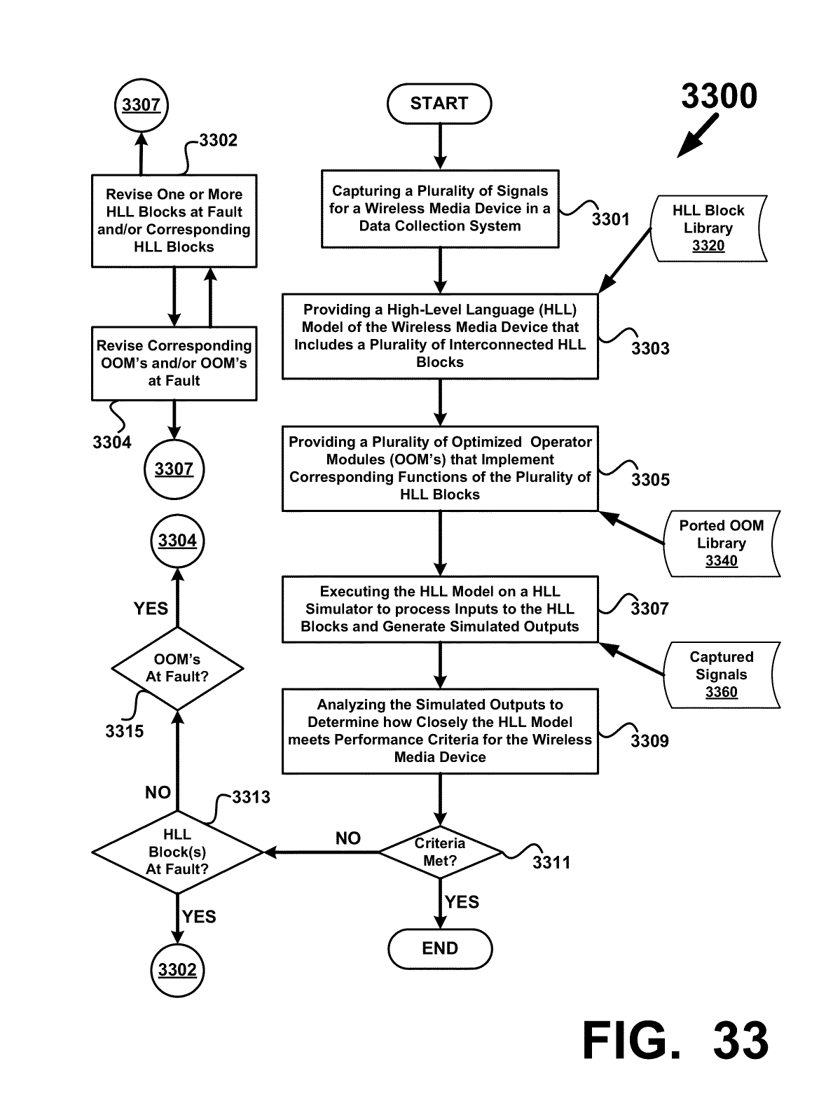

Attention is now directed to FIG. 33 where one example of a flow diagram 3300 for a platform framework is depicted. Flow 3300 may be implemented using a combination of hardware and/or software. Stages in flow 3300 may be executed in an order different than depicted and flow 3300 may be processed in series, parallel or both on the same or different hardware and/or software platforms.

At a stage 3301a plurality of signals (e.g., 3121) for a wireless media device (e.g., 101) are captured in a data collection system (e.g., 3120) as described above, for example. At a stage 3303 a HLL model (e.g., 3130) of the wireless media device (e.g., 101) including a plurality of HLL blocks (e.g., 3170) is provided as described above, for example. A HLL block library 3320 (e.g., from a data store) may be the source for the HLL model and/or HLL blocks (e.g., 3130, 3170). The HLL model may include the plurality of HLL blocks interconnected to execute a functionality of the wireless media device 101.

At a stage 3305 a plurality of optimized operator modules (OOM's) (e.g., OOM's 3180) may be provided. Each OOM may implement a function that corresponds with a function implemented by one or more of the HLL blocks. A ported OOM library 3340 (e.g., from a data store) may be the source for the plurality of OOM modules (e.g., 3180). Ported OOM library 3340 may include a plurality of unique OOM modules for different target hardware platforms (e.g., from different manufactures or different parts from the same manufacture).

At a stage 3307 the HLL model (e.g., 3130) is executed on a HLL simulator (e.g., 3140) to process inputs to the plurality of HLL blocks (e.g., 3170) and to generate simulated outputs (e.g., 3142). Stage 3307 may further include compiling, either on the HLL simulator or other compiler system, the plurality of OOM's (e.g., 3180) and outputting an executable code (e.g., 3134) configured for execution in a processor (e.g., 2920) of the target hardware system (e.g., 3150). The stage 3307 may use captured signals 3360 (e.g., 3132 from data collection system 3120) as the processed inputs.

At a stage 3309 the simulated outputs (e.g., 3142) are analyzed (e.g., 3160) to determine how closely the HLL model (e.g., 3130) meets performance criteria for the wireless media device 101. Performance criteria broadly covers any metric by which the performance of the HLL model may be determined to meet or not meet performance criteria established for the wireless media device 101, including but not limited to power consumption, battery life (e.g., for a rechargeable battery), audio fidelity, speaker loudness, noise suppression, voice activity detection, echo cancellations, wind noise suppression, quality and/or fidelity of transmitted audio, quality and/or fidelity of received audio, RF system performance, wireless range, emitted RF power, processing speed, microphone sensitivity, speaker loudness, response to voice commands, amplifier power, paring speed and/or operation, just to name a few.

At a stage 3311a determination may be made as to whether or not the HLL model (e.g., 3130) has met the criteria. If a YES branch is taken, then flow 3300 may terminate. On the other hand, if a NO branch is taken, then the flow 3300 may transition to a stage 3313 where a determination may be made as to whether or not one or more of the HLL blocks (e.g., 3170) may be at fault for not meeting the criteria. If a YES branch is taken, then flow 3300 may transition to a stage 3302 to be described below. If a NO branch is taken from the stage 3313, then the flow 3300 may transition to a stage 3315 where a determination may be made as to whether or not one or more of the OOM's (e.g., 3180) may be at fault for not meeting the criteria. If a YES branch is taken, then the flow 3300 may transition to a stage 3304 to be described below.

At the stage 3302 one or more of the HLL blocks suspected as being a cause of the criteria not being met (e.g., from the stage 3313) may be revised (e.g., 3162) as described above in reference to FIG. 32. At the stage 3304, OOM's suspected as being a cause of the criteria not being met (e.g., from the stage 3315) may be revised (e.g., 3162) as described above in reference to FIG. 32. Moreover, as described above in reference to FIG. 32, revision of HLL blocks may result and/or require revision of one or more corresponding OOM's at the stage 3304. In some examples a revision of one or more suspect OOM's at the stage 3304 may require revision of one or more corresponding HLL blocks at the stage 3302 as depicted by the double set of flow arrows between stages 3302 and 3304. Suspect OOM's that are revised may be re-compiled as described above. Revised OOM's and/or HLL blocks may be saved back to their respective libraries 3340 and 3320 (e.g., the libraries may be updated). Updating the libraries may occur only after the revision process yields success at the stage 3311 (e.g., wireless media device performance criteria have been met) where selecting the YES branch may transition flow 3300 to a terminus point (e.g., END). Flow 3300 may transition to another stage after execution of the stages 3302 and/or 3304, such as the stage 3307 to re-simulate the HLL model (e.g., 3130) after revisions (e.g., 3162) have been made to the HLL blocks and/or OOM modules.

HLL blocks 3170, OOM's 3180 or both may be objects that are manipulated and processed by an object-oriented programming language. Inputs to HLL blocks 3170, OOM's 3180 or both may be implemented as function calls and results returned by execution of a function may comprise outputs generated by the HLL blocks 3170, OOM's 3180 or both. HLL blocks 3170, OOM's 3180 or both may be instantiated as one or more blocks in a block diagram (e.g., on a CAD tool of the HLL simulation tool 3140). The block diagram may include a schematic diagram or other interconnection scheme that describes and implements connections of inputs and outputs among the various blocks in the block diagram. Blocks in the block diagram may be hierarchical, that is a block may be comprised of one or more subsets of other blocks that are interconnected such that a HLL block 3170 in the block diagram may be comprised of other HLL blocks 3170. Similarly, OOM's 3180 may also be hierarchical. At some level of abstraction (e.g., at compile time and/or HLL simulation time), the block diagram may be flattened or otherwise reduced to an interconnection of its constituent elements (e.g., discrete OOM's 3180 and/or HLL blocks 3170). Inputs to OOM's 3180 and/or HLL blocks 3170 may comprise more that scalar inputs (e.g., signal inputs) and may also include one or more functions to be executed on by the OOM's 3180 and/or HLL blocks 3170. Therefore, an actual number of inputs may be the number of scalar inputs times the number of functions to be executed. For example, if there are two scalar inputs and two functions, then the total number of inputs may be four (e.g., 2×2=4). Outputs from an OOM 3180 and/or HLL block 3170 may be coupled with inputs or one or more other OOM's 3180 and/or HLL blocks 3170. A collision may occur (e.g., a compile time error or a syntax error) if more than one input to an OOM 3180 and/or HLL block 3170 is connected with two or more outputs from other OOM's 3180 and/or HLL blocks 3170.

The HLL simulation tool 3140 and/or HLL simulator of the stage 3307 of flow 3300 may be a custom designed software tool or may be a commercially available high-level language, programming, and numerical computation tool such as MATLAB®, Mathematics®, IDL®, Silvaco®, and Maple®, just to name a few, for example. Target hardware platform 3150 may be an ASIC or may be a commercially available single or multi-core DSP or SoC from a variety of manufactures such as CSR (e.g., BlueCore family), Cirrus Logic, TI, Intel, Motorola, Samsung, ARM, just to name a few, for example.

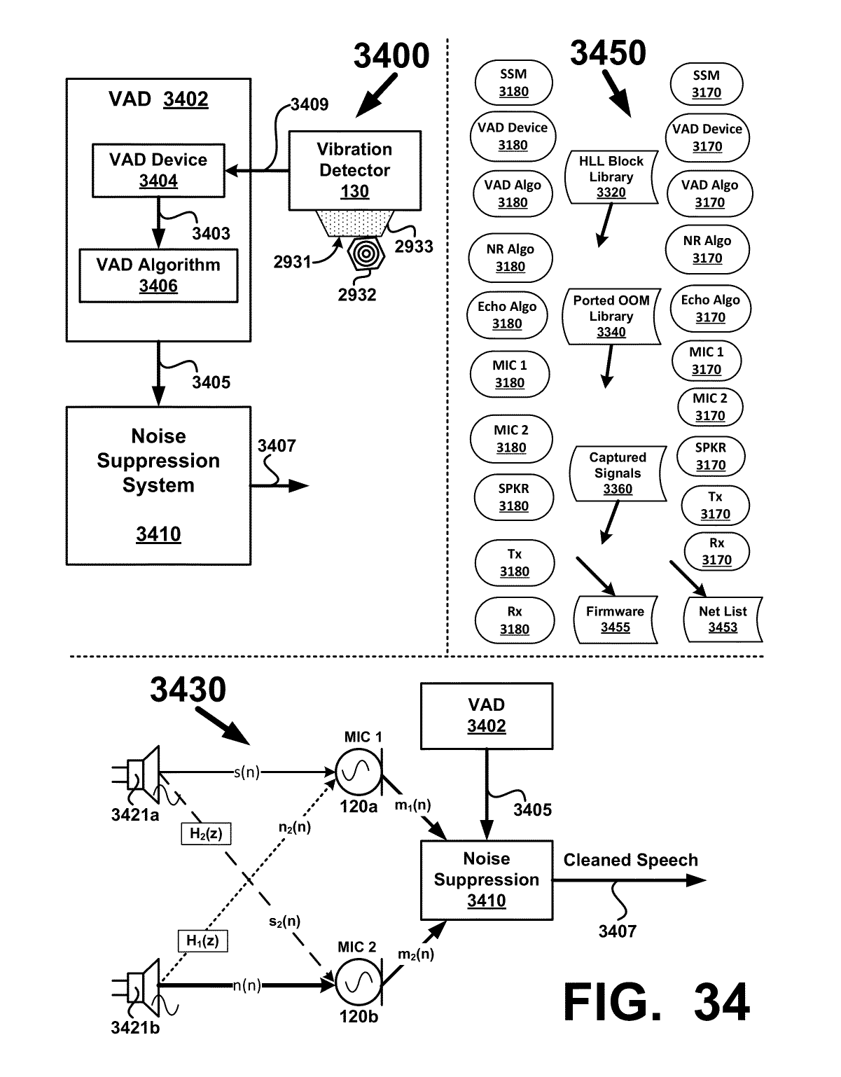

FIG. 34 depicts one example of different levels of design abstraction 3400-3450 that may be used as basis for high-level language modeling and simulation in a platform framework such as described above in reference to FIGS. 31-33. Referring back to FIG. 2, the noise suppression system 206 in audio processor 202 may be modeled at a lower level of granularity and may operate on more of fewer inputs and outputs than depicted. As was described above in reference to U.S. Pat. No. 8,340,309, a high level block diagram 3400 of a media device that may include a noise suppression system 3410 may include a voice activity detector 3402 that receives as an input 3409 one or more signals from vibration detector 130 (e.g., a SSM or the like) in response to skin born mechanical vibrations 2932 that are coupled (2931, 2933) into vibration detector 130. VAD 3402 may include sub-blocks including but not limited to VAD device 3403 coupled 3403 with a VAD algorithm 3406. Therefore, VAD 3402 may include blocks of hardware, software, or both. An output from VAD 3402 may be coupled 3405 with an input of the noise suppression system 3410 which may process one or more inputs and generate an output 3407, such as a de-noised signal or cleaned speech signal, for example.

Diagram 3430 depicts a lower level abstraction of how the noise suppression system 3410 may be implemented and additional elements that are needed in a system that instantiates the noise suppression system 3410, such as the microphones 120a and 120b that generate signals as inputs to the noise suppression system 3410. The attributes of the noise suppression system 3410 will be application dependent and there are many different types of noise suppression systems that may be implemented using the systems available in media device 101, such as its various microphones, vibration detector 130, processor 2920, housing 2999, and speaker 2904, just to name a few. Therefore, building blocks for VAD 3402 and microphones (120a, 120b) may be needed as inputs and may also be needed as HLL blocks 3170 and OOM modules 3180.

Diagram 3450 depicts an even lower level of abstraction where instead of a schematic or other interconnection scheme, the base building blocks 3170 and modules 3180 that may be necessary to design, simulate, and implement the noise suppression system 3410 as part of the firmware 3455 that may be downloaded into the data storage system of the target hardware platform 3150 as described above. At a high-level language representation, blocks other than those depicted in diagrams 3400 and/or 3430 may be required to implement the noise suppression system 3410. For examples, there may be HLL blocks 3170 for SSM, VAD device, VAD algorithm, a noise reduction (NR) algorithm, an echo cancellation algorithm, MIC 1, MIC 2, speaker, Tx, and Rx, for example. NR algorithm may process signals from hardware elements such as the SSM, MIC 1, and MIC 2 to implement some or all of the portions of the noise suppression system 3410. Interconnection of the HLL blocks (e.g., lanes, wires, or other structures) will be application dependent and is represented as a net list 3453 that may be in a syntax, language or other used by HLL simulation tool 3140 as described above.

As described above, there may be a corresponding OOM module 3180 for each HLL block 3170. In diagram 3450, a plurality of OOM modules 3180 are depicted for each corresponding HLL block 3170 as a non-limiting example only and there may or may not be corresponding OOM modules 3180 for each HLL block 3170. HLL block library 3320 and/or ported OOM library 3340 may be used as sources for the HLL blocks 3170 and OOM modules 3180 depicted. In some examples, a portion of the HLL blocks 3170 and OOM modules 3180 depicted may be invoked as functions calls by an instantiated module 3180 or block 3170. For example, VAD device 3170 may make a function call to the library 3320 for a specific VAD algorithm 3170. Diagram 3450 may include captured signals 3360 as signal stimulus for simulating and verifying the noise suppression system 3410 as a sub-system or sub-component of media device 101. Therefore the media device 101 may be designed, simulated, and verified in part or in whole using the high-level language modeling and simulation in a platform framework such as described above in reference to FIGS. 31-34.

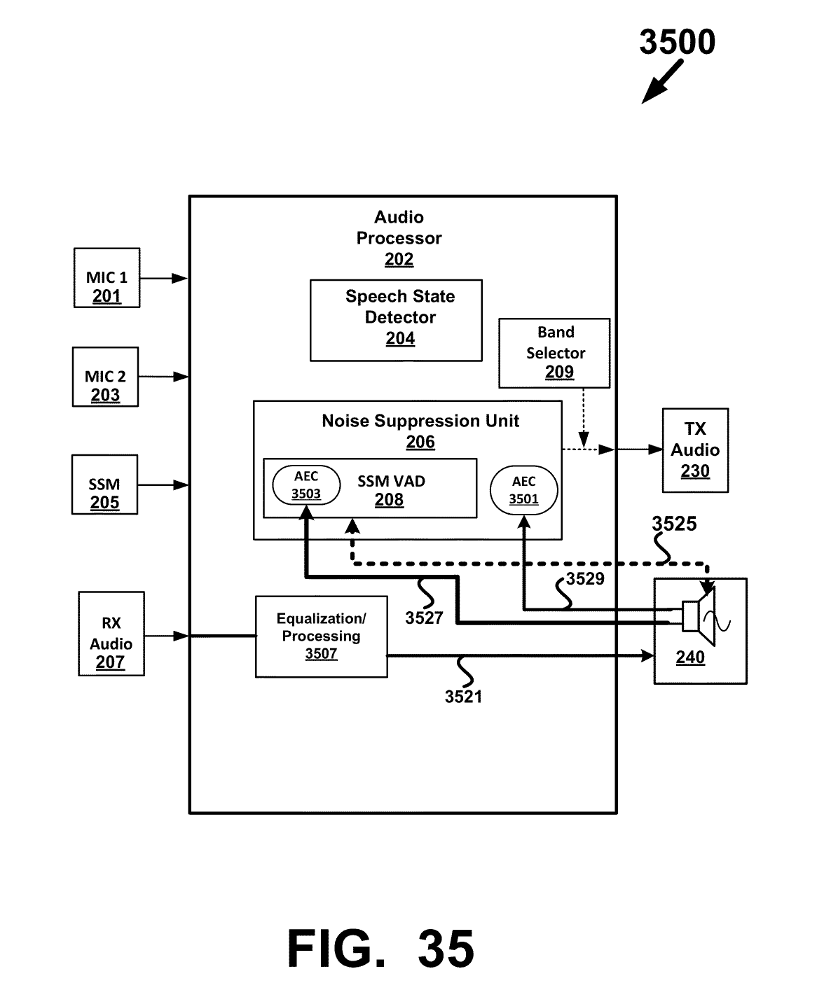

As one example of how the simulation and design process may utilize different HLL blocks 3170 and OOM modules 3180, the audio processor 202 of FIG. 2 may be modified as depicted in FIG. 35, where an alternative implementation of noise suppression unit 206 and SSM VAD 208 is depicted. Here, inputs to speaker 240 by RX audio 207 may generate structure born vibrations 3525 that travel through housing 2999 of FIG. 29 (not shown) and couple with SSM VAD 208 (e.g., vibration sensor 130) and those vibrations may interfere with an ability of SSM VAD 208 to distinguish between voice originated mechanical vibration through the skin and the structure born vibration 3525 that may couple with the housing 2999, the skin of the user or both and lead to inaccurate operation of SSM VAD 208 and/or noise suppression unit 206. Audio processor 202 may include automatic echo cancellation (AEC) algorithms and/or circuitry 3501 and 3503 to counteract the effects of feedback of speaker 240 vibrations to SSM VAD 208 and/or noise suppression unit 206. Signals 3529 and 3527 may be coupled with AEC 3501 and 3503 respectively to cancel the feedback effects caused by the structure born vibration 3525 that otherwise may be included in the signal on Tx audio 230 or elsewhere in media device 101. RX audio 207 may be coupled with an equalization/processing block 3507 that modifies frequency characteristics (e.g., bass response, etc.) of an audio signal received prior to be amplified and driven to speaker 240. The AEC 3501, AEC 3503, and Eq/Proc. 3507 may be implemented as HLL blocks 3170, function calls, macros or the like and may have corresponding OOM modules 3180 as described above in FIGS. 31-34.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed is:

1. A method of simulation and design verification of a wireless device, comprising:
capturing a plurality of signals in a data collection system, the plurality of signals including input signals for a wireless media device;
providing a high-level language (HLL) model, the HLL model including inputs and outputs that match the plurality of signals, the HLL model comprised of a plurality of blocks having inputs and outputs that are interconnected in the HLL model to implement a block level functionality of the wireless media device, each block implements a function of the wireless media device;
providing a plurality of optimized operator modules coded in a format for a target hardware platform, each optimized operator module is coded to implement the function of a corresponding block in the plurality of blocks and receives data inputs and generates data outputs corresponding to the inputs and outputs of its corresponding block;
executing the HLL model on a HLL simulation tool configured to apply the input signals from the plurality of signals to the inputs of the HLL model, to process the input signals according the function implemented by each block, and to generate simulated output signals on the outputs of the HLL model; and
analyzing the simulated output signals to determine how closely the HLL model meets a performance criteria for the wireless media device.

2. The method of claim 1, wherein the data collection system includes data storage for storing the plurality of signals that are captured.

3. The method of claim 1, wherein the target hardware platform comprises an integrated circuit (IC) selected from the group consisting of a controller, a multi-core controller, a processor, a multi-core processor, a digital signal processor (DSP), a multi-core DSP, a system on chip (SoC), a multi-core SoC, and an application specific IC (ASIC).

4. The method of claim 1, wherein providing the plurality of optimized operator modules comprises selecting a ported library module from a target hardware library that includes a plurality of ported library modules, with each ported library module including a unique plurality of optimized operator modules coded in a format for a unique target hardware platform.

5. The method of claim 1, wherein the format for the target hardware platform comprises an assembly language.

6. The method of claim 1 and further comprising:
compiling the plurality of optimized operator modules into an executable code configured to execute on one or more processors in the target hardware platform, the executable code embodied in a non-transitory computer readable medium that is electrically accessed by the one or more processors.

7. The method of claim 6 and further comprising:
executing the executable code on the one or more processors while applying the input signals from the plurality of signals to input ports of the target hardware platform; and
analyzing hardware output signals from output ports of the target hardware platform to determine how closely the plurality of optimized operator modules meets the performance criteria for the wireless media device.

8. The method of claim 7, wherein the analyzing hardware output signals comprises comparing the hardware output signals with the simulated output signals.

9. The method of claim 8 and further comprising:
revising one or more blocks in the plurality of blocks, one or more optimized operator modules in the plurality of optimized operator modules or both, when the comparing indicates the HLL model, the executable code or both do not meet the performance criteria.

10. The method of claim 9, wherein the revising occurs in the HLL simulation tool.

11. The method of claim 6, wherein the compiling occurs in the HLL simulation tool.

12. The method of claim 1, wherein the plurality of signals includes one or more output signals.

13. The method of claim 12, wherein the analyzing comprises comparing the simulated output signals with the one or more output signals from the plurality of signals.

14. The method of claim 13, wherein the one or more output signals comprise signals selected from the group consisting of a transmit channel (Tx) signal, a speaker signal, a simulated echo signal, and an indicator signal.

15. The method of claim 1, wherein the input signals from the plurality of signals comprise one or more signals selected from the group consisting of a microphone signal, a vibration sensor signal, a vibration detector signal, an accelerometer signal, a skin surface microphone (SSM) signal, a switch signal, and a receive channel (Rx) signal.

16. A computer program product embodied in a computer executable non-transitory computer readable medium configured for simulation and design verification of a wireless device, comprising steps of:
capturing a plurality of signals in a data collection system, the plurality of signals including input signals for a wireless media device;
providing a high-level language (HLL) model, the HLL model including inputs and outputs that match the plurality of signals, the HLL model comprised of a plurality of blocks having inputs and outputs that are interconnected in the HLL model to implement a block level functionality of the wireless media device, each block implements a function of the wireless media device;
providing a plurality of optimized operator modules coded in a format for a target hardware platform, each optimized operator module is coded to implement the function of a corresponding block in the plurality of blocks and receives data inputs and generates data outputs corresponding to the inputs and outputs of its corresponding block;
executing the HLL model on a HLL simulation tool configured to apply the input signals from the plurality of signals to the inputs of the HLL model, to process the input signals according the function implemented by each block, and to generate simulated output signals on the outputs of the HLL model;
analyzing the simulated output signals to determine how closely the HLL model meets a performance criteria for the wireless media device; and
compiling, after the performance criteria are met, the plurality of optimized operator modules into executable firmware in a target language for a target hardware platform that executes the firmware on one or more hardware processors to implement functions of the wireless media device, the firmware embodied in a non-transitory computer medium.
